(19) United States
(12) Patent Application Publication
(10) Pub. No.: US 2026/0205173 A1
(43) Pub. Date: Jul. 16, 2026

(54) UNIFIED TRANSMISSION SEQUENCE FOR COORDINATED BEAMFORMING AND COORDINATED SPATIAL REUSE

(71) Applicant: QUALCOMM Incorporated, San Diego, CA (US)

(72) Inventors: Sherief HELWA, San Diego, CA (US); George CHERIAN, San Diego, CA (US); Abhishek Pramod PATIL, San Diego, CA (US); Ahmed Ragab ELSHERIF, San Jose, CA (US); Alfred ASTERJADHI, San Diego, CA (US); Gaurang NAIK, San Diego, CA (US); Sanket Sanjay KALAMKAR, San Diego, CA (US); Giovanni CHISCI, San Diego, CA (US); Sai Yiu Duncan HO, San Diego, CA (US)

(21) Appl. No.: 19/088,822

(22) Filed: Mar. 24, 2025

Related U.S. Application Data
(63) Continuation-in-part of application No. 19/045,268, filed on Feb. 4, 2025.
(60) Provisional application No. 63/744,161, filed on Jan. 10, 2025.

(51) Int. Cl. H04B 7/06; H04L 25/02; H04W 72/044

(52) U.S. Cl. CPC H04B 7/0617; H04L 25/0224; H04W 72/046

(57) ABSTRACT

This disclosure provides methods, devices, and systems for a unified frame transmission sequence for coordinated beamforming and coordinated spatial reuse. Some aspects more specifically relate to a first access point (AP) that transmits an invite frame within a shared transmission opportunity of the first AP. The invite frame may indicate initiation of a frame transmission sequence associated with a coordinated AP scheme of a plurality of coordinated AP schemes. The first AP and the second AP may communicate one or more frames within the shared transmission opportunity in accordance with the frame transmission sequence. The one or more frames may include information that coordinates downlink physical layer protocol data unit (PPDU) transmissions between the first AP and one or more second APs. In response to communicating the one or more frames, the first AP, a second AP, or both may transmit a coordinated downlink PPDU transmission.

### CROSS REFERENCE

The present Application for Patent is a continuation-in-part of U.S. patent application Ser. No. 19/045,268 by HELWA et al., entitles “UNIFIED TRANSMISSION SEQUENCE FOR COORDINATED BEAMFORMING AND COORDINATED SPATIAL REUSE”, filed Feb. 4, 2025, which claims the benefit of U.S. Provisional Patent Application No. 63/744,161 by HELWA et al., entitled “UNIFIED TRANSMISSION SEQUENCE FOR COORDINATED BEAMFORMING AND COORDINATED SPATIAL REUSE”, filed Jan. 10, 2025, which is assigned to the assignee hereof, and each of which is expressly incorporated by reference herein.

### TECHNICAL FIELD

This disclosure relates generally to wireless communication and, more specifically, to unified transmission sequence for coordinated beamforming and coordinated spatial reuse.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communication by a first access point (AP). The method may include transmitting, within a shared transmission opportunity of the first AP, an invite frame that indicates initiation of a joint frame transmission sequence associated with a coordinated AP scheme of a set of multiple coordinated AP schemes, communicating, within the shared transmission opportunity of the first AP, a set of multiple frames in accordance with the frame transmission sequence, the set of multiple frames including information that coordinates downlink physical layer protocol data unit (PPDU) transmissions by the first AP and one or more second APs, and transmitting, within the shared transmission opportunity of the first AP and responsive to communication of the set of multiple frames, a coordinated downlink PPDU transmission.

Another innovative aspect of the subject matter described in this disclosure can be implemented in a first AP for wireless communication. The first AP may include a processing system that includes processor circuitry and memory circuitry that stores code. The processing system may be configured to cause the first AP to transmit, within a shared transmission opportunity of the first AP, an invite frame that indicates initiation of a joint frame transmission sequence associated with a coordinated AP scheme of a set of multiple coordinated AP schemes, communicate, within the shared transmission opportunity of the first AP, a set of multiple frames in accordance with the frame transmission sequence, the set of multiple frames including information that coordinates downlink physical layer protocol data unit (PPDU) transmissions by the first AP and one or more second APs, and transmit, within the shared transmission opportunity of the first AP and responsive to communication of the set of multiple frames, a coordinated downlink PPDU transmission.

Another innovative aspect of the subject matter described in this disclosure can be implemented in a first AP for wireless communication. The first AP may include means for transmitting, within a shared transmission opportunity of the first AP, an invite frame that indicates initiation of a joint frame transmission sequence associated with a coordinated AP scheme of a set of multiple coordinated AP schemes, means for communicating, within the shared transmission opportunity of the first AP, a set of multiple frames in accordance with the frame transmission sequence, the set of multiple frames including information that coordinates downlink PPDU transmissions by the first AP and one or more second APs, and means for transmitting, within the shared transmission opportunity of the first AP and responsive to communication of the set of multiple frames, a coordinated downlink PPDU transmission.

Another innovative aspect of the subject matter described in this disclosure can be implemented in a non-transitory computer-readable medium storing code for wireless communication. The code may include instructions executable by one or more processors to transmit, within a shared transmission opportunity of the first AP, an invite frame that indicates initiation of a joint frame transmission sequence associated with a coordinated AP scheme of a set of multiple coordinated AP schemes, communicate, within the shared transmission opportunity of the first AP, a set of multiple frames in accordance with the frame transmission sequence, the set of multiple frames including information that coordinates downlink PPDU transmissions by the first AP and one or more second APs, and transmit, within the shared transmission opportunity of the first AP and responsive to communication of the set of multiple frames, a coordinated downlink PPDU transmission.

In some examples of the method, first APs, and non-transitory computer-readable medium described herein, the set of multiple frames includes one or more initial control response frames, a response frame, a trigger frame, or any combination thereof.

In some examples of the method, first APs, and non-transitory computer-readable medium described herein, the invite frame includes an invitation to perform a CoBF operation between the first AP and a second AP of the one or more second APs.

In some examples of the method, first APs, and non-transitory computer-readable medium described herein, a first coordinated AP scheme of the set of multiple coordinated AP schemes includes a CoBF scheme and the invite frame includes an invitation to perform a CoBF operation between the first AP and a second AP of the one or more second APs, an indication of one or more wireless stations (STAs) associated with the first AP, or both.

In some examples of the method, first APs, and non-transitory computer-readable medium described herein, the invite frame includes a poll message of the CoBF scheme and requests a wireless station to perform frame exchange associated with the CoBF scheme.

In some examples of the method, first APs, and non-transitory computer-readable medium described herein, communicating the set of multiple frames in accordance with the joint frame transmission sequence may include operations, features, means, or instructions for transmitting an initial control frame including a poll message and a request to perform a frame exchange associated with the CoBF scheme.

In some examples of the method, first APs, and non-transitory computer-readable medium described herein, communicating the set of multiple frames in accordance with the frame transmission sequence may include operations, features, means, or instructions for receiving, from the wireless station and based on the poll message, a first initial control response frame that indicates availability of the wireless station to participate in frame exchange associated with the CoBF scheme.

In some examples of the method, first APs, and non-transitory computer-readable medium described herein, communicating the set of multiple frames in accordance with the joint frame transmission sequence may include operations, features, means, or instructions for receiving, from the second AP and based on the invitation, a second initial control response frame, a response frame, or both, where the second initial control response frame or the response frame indicate availability of the second AP to participate in frame exchange associated with the CoBF scheme.

In some examples of the method, first APs, and non-transitory computer-readable medium described herein, communicating the set of multiple frames in accordance with the joint frame transmission sequence may include operations, features, means, or instructions for receiving, from the second AP and based at least in part on the invitation, a response frame, wherein the response frame indicates availability of the second AP and an indication of an acceptance or rejection of the second AP to participate in a frame exchange associated with the CoBF scheme, indicates one or more wireless stations associated with the second AP, or both.

Some examples of the method, first APs, and non-transitory computer-readable medium described herein may further include operations, features, means, or instructions for preparing, based on the first initial control response frame, to participate in the frame exchange with the wireless station.

In some examples of the method, first APs, and non-transitory computer-readable medium described herein, communicating the set of multiple frames in accordance with the frame transmission sequence may include operations, features, means, or instructions for receiving, from the second AP and based on the invitation, a second initial control response frame, a response frame, or both, where the second initial control response frame and the response frame indicate availability of the second AP to participate in frame exchange associated with the CoBF scheme.

Some examples of the method, first APs, and non-transitory computer-readable medium described herein may further include operations, features, means, or instructions for preparing, based on the second initial control response frame, to participate in the frame exchange with the second AP.

In some examples of the method, first APs, and non-transitory computer-readable medium described herein, communicating the set of multiple frames in accordance with the frame transmission sequence may include operations, features, means, or instructions for transmitting, to the second AP, a trigger frame, where the trigger frame may be a frequency and time synchronization reference frame, and where the coordinated downlink PPDU transmission may be communicated in accordance with the frequency and time synchronization reference frame.

In some examples of the method, first APs, and non-transitory computer-readable medium described herein, the invite frame includes an invitation to perform a coordinated spatial reuse (CSR) operation between the first AP and a second AP of the one or more second APs and the invite frame includes an invitation to perform a CSR operation between the first AP and a second AP of the one or more second APs.

In some examples of the method, first APs, and non-transitory computer-readable medium described herein, a second coordinated AP scheme of the set of multiple coordinated AP schemes includes a CSR scheme.

In some examples of the method, first APs, and non-transitory computer-readable medium described herein, the invite frame includes a poll message of the CSR scheme and requests a wireless station to perform frame exchange associated with the CSR scheme and to transmit an initial coordinated response frame.

In some examples of the method, first APs, and non-transitory computer-readable medium described herein, and the method, apparatuses, and non-transitory computer-readable medium may include further operations, features, means, or instructions for transmitting an initial control frame including a poll message of the CSR scheme, and a request for a wireless STA to perform a frame exchange associated with the CSR scheme and to transmit an initial coordinated response frame.

In some examples of the method, first APs, and non-transitory computer-readable medium described herein, communicating the set of multiple frames in accordance with the frame transmission sequence may include operations, features, means, or instructions for receiving, from the wireless station and based on the poll message, a first initial control response frame that indicates availability of the wireless station to participate in frame exchange associated with the CSR scheme.

In some examples of the method, first APs, and non-transitory computer-readable medium described herein, communicating the set of multiple frames in accordance with the joint frame transmission sequence may include operations, features, means, or instructions for receiving, from the wireless STA and based on the poll message, an initial control response frame that indicates availability of the wireless STA to participate in the frame exchange associated with the CSR scheme.

Some examples of the method, first APs, and non-transitory computer-readable medium described herein may further include operations, features, means, or instructions for measuring, based on the first initial control response frame, a received signal power associated with the wireless station.

In some examples of the method, first APs, and non-transitory computer-readable medium described herein, communicating the set of multiple frames in accordance with the frame transmission sequence may include operations, features, means, or instructions for transmitting, to the second AP, a trigger frame that includes an indication of one or more of: a received signal power associated with a wireless station, a transmit power associated with transmission of the coordinated downlink PPDU transmission, a signal to interference ratio (SIR) threshold, a start time associated with transmission of the coordinated downlink PPDU transmission, an end time associated with transmission of the coordinated downlink PPDU transmission, or any combination thereof.

In some examples of the method, first APs, and non-transitory computer-readable medium described herein, communicating the set of multiple frames in accordance with the frame transmission sequence may include operations, features, means, or instructions for receiving, from the second AP and based on the invitation, a response frame that indicates availability of the second AP to participate in frame exchange associated with the CSR scheme.

Another innovative aspect of the subject matter described in this disclosure can be implemented in a method for wireless communication by a second AP. The method may include receiving, within a shared transmission opportunity of a first AP, an invite frame that indicates initiation of a joint frame transmission sequence associated with a coordinated AP scheme of a set of multiple coordinated AP schemes, communicating, within the shared transmission opportunity, a set of multiple frames in accordance with the frame transmission sequence, the set of multiple frames including information that coordinates downlink PPDU transmissions by the first AP and the second AP, and transmitting, within the shared transmission opportunity and responsive to communication of the set of multiple frames, a coordinated downlink PPDU transmission.

Another innovative aspect of the subject matter described in this disclosure can be implemented in a second AP for wireless communication. The second AP may include a processing system that includes processor circuitry and memory circuitry that stores code. The processing system may be configured to cause the second AP to receive, within a shared transmission opportunity of a first AP, an invite frame that indicates initiation of a joint frame transmission sequence associated with a coordinated AP scheme of a set of multiple coordinated AP schemes, communicate, within the shared transmission opportunity, a set of multiple frames in accordance with the frame transmission sequence, the set of multiple frames including information that coordinates downlink PPDU transmissions by the first AP and the second AP, and transmit, within the shared transmission opportunity and responsive to communication of the set of multiple frames, a coordinated downlink PPDU transmission.

Another innovative aspect of the subject matter described in this disclosure can be implemented in another second AP for wireless communication. The second AP may include means for receiving, within a shared transmission opportunity of a first AP, an invite frame that indicates initiation of a joint frame transmission sequence associated with a coordinated AP scheme of a set of multiple coordinated AP schemes, means for communicating, within the shared transmission opportunity, a set of multiple frames in accordance with the frame transmission sequence, the set of multiple frames including information that coordinates downlink PPDU transmissions by the first AP and the second AP, and means for transmitting, within the shared transmission opportunity and responsive to communication of the set of multiple frames, a coordinated downlink PPDU transmission.

Another innovative aspect of the subject matter described in this disclosure can be implemented in a non-transitory computer-readable medium storing code for wireless communication. The code may include instructions executable by one or more processors to receive, within a shared transmission opportunity of a first AP, an invite frame that indicates initiation of a joint frame transmission sequence associated with a coordinated AP scheme of a set of multiple coordinated AP schemes, communicate, within the shared transmission opportunity, a set of multiple frames in accordance with the frame transmission sequence, the set of multiple frames including information that coordinates downlink PPDU transmissions by the first AP and the second AP, and transmit, within the shared transmission opportunity and responsive to communication of the set of multiple frames, a coordinated downlink PPDU transmission.

In some examples of the method, second APs, and non-transitory computer-readable medium described herein, the set of multiple frames includes an initial control response frame, a response frame, a trigger frame, or any combination thereof.

In some examples of the method, second APs, and non-transitory computer-readable medium described herein, the invite frame includes an invitation to perform a CoBF operation between the first AP and the second AP.

In some examples of the method, second APs, and non-transitory computer-readable medium described herein, a first coordinated AP scheme of the set of multiple coordinated AP schemes includes a CoBF scheme and the invite frame includes an invitation to perform a CoBF operation between the first AP and the second AP.

In some examples of the method, second APs, and non-transitory computer-readable medium described herein, communicating the set of multiple frames in accordance with the frame transmission sequence may include operations, features, means, or instructions for transmitting, to the first AP and based on the invitation, a first initial control response frame, a response frame, or both, where the first initial control response frame and the response frame indicate availability of the second AP to participate in frame exchange associated with the CoBF scheme.

In some examples of the method, second APs, and non-transitory computer-readable medium described herein, communicating the set of multiple frames in accordance with the joint frame transmission sequence may include operations, features, means, or instructions for transmitting an initial control frame including a poll message and requesting a wireless STA to perform a frame exchange associated with the CoBF scheme.

In some examples of the method, second APs, and non-transitory computer-readable medium described herein, communicating the set of multiple frames in accordance with the joint frame transmission sequence may include operations, features, means, or instructions for receiving, from a wireless STA and based on the initial control frame, an initial control response frame that indicates availability of the wireless STA to participate in the frame exchange associated with the CoBF scheme.

In some examples of the method, second APs, and non-transitory computer-readable medium described herein, communicating the set of multiple frames in accordance with the frame transmission sequence may include operations, features, means, or instructions for receiving, from a wireless station and based on the invitation, a second initial control response frame that indicates availability of the wireless station to participate in frame exchange associated with the CoBF scheme.

Some examples of the method, second APs, and non-transitory computer-readable medium described herein may further include operations, features, means, or instructions for preparing, based on the second initial control response frame, to participate in the frame exchange with the wireless station.

In some examples of the method, second APs, and non-transitory computer-readable medium described herein, communicating the set of multiple frames in accordance with the frame transmission sequence may include operations, features, means, or instructions for receiving, from the first AP, a trigger frame, where the trigger frame may be a frequency and time synchronization reference frame, and where the coordinated downlink PPDU transmission may be communicated in accordance with the frequency and time synchronization reference frame.

In some examples of the method, second APs, and non-transitory computer-readable medium described herein, the invite frame includes an invitation to perform a CSR operation between the first AP and the second AP.

In some examples of the method, second APs, and non-transitory computer-readable medium described herein, a second coordinated AP scheme of the set of multiple coordinated AP schemes includes a CSR scheme and the invite frame includes an invitation to perform a CSR operation between the first AP and the second AP.

In some examples of the method, second APs, and non-transitory computer-readable medium described herein, communicating the set of multiple frames in accordance with the frame transmission sequence may include operations, features, means, or instructions for transmitting, to the first AP and based on the invitation, a response frame that indicates availability of the second AP to participate in frame exchange associated with the CSR scheme.

In some examples of the method, second APs, and non-transitory computer-readable medium described herein, communicating the set of multiple frames in accordance with the joint frame transmission sequence may include operations, features, means, or instructions for transmitting an initial control frame including a poll message and requesting first a wireless STA associated with the second AP to perform a frame exchange associated with the CSR scheme.

Some examples of the method, second APs, and non-transitory computer-readable medium described herein may further include operations, features, means, or instructions for monitoring for an initial control response frame transmitted by a second wireless STA associated with the first AP, receiving, from the second wireless STA and based on the poll message, the initial control response frame that indicates availability of the wireless STA to participate in a frame exchange associated with the CSR scheme, and measuring, based on the initial control response frame, a received signal power associated with the second wireless STA.

Some examples of the method, second APs, and non-transitory computer-readable medium described herein may further include operations, features, means, or instructions for monitoring for an initial control response frame transmitted by a wireless station associated with the first AP and measuring, based on the initial control response frame, a received signal power associated with the wireless station.

In some examples of the method, second APs, and non-transitory computer-readable medium described herein, communicating the set of multiple frames in accordance with the frame transmission sequence may include operations, features, means, or instructions for receiving, from the first AP, a trigger frame that includes an indication of one or more of: a received signal power associated with a wireless station, a transmit power associated with transmission of the coordinated downlink PPDU transmission, an SIR threshold, a start time associated with transmission of the coordinated downlink PPDU transmission, an end time associated with transmission of the coordinated downlink PPDU transmission, or any combination thereof.

In some examples of the method, second APs, and non-transitory computer-readable medium described herein, adjusting, based on the trigger frame, a transmit power, where the coordinated downlink PPDU transmission may be transmitted based on the adjusted transmit power.

Another innovative aspect of the subject matter described in this disclosure can be implemented in a method for wireless communications by a wireless station. The method may include receiving, within a shared transmission opportunity of an AP, an invite frame that indicates initiation of a joint frame transmission sequence associated with a coordinated AP scheme of a set of multiple coordinated AP schemes, where the invite frame includes a poll message that requests the wireless station to perform frame exchange associated with the coordinated AP scheme, transmitting, within the shared transmission opportunity and based on the poll message, an initial control response frame, and receiving, within the shared transmission opportunity and based on transmission of the initial control response frame, a coordinated downlink PPDU transmission.

Another innovative aspect of the subject matter described in this disclosure can be implemented in a wireless station for wireless communications. The wireless station may include a processing system that includes processor circuitry and memory circuitry that stores code. The processing system may be configured to cause the wireless station to receive, within a shared transmission opportunity of an AP, an invite frame that indicates initiation of a joint frame transmission sequence associated with a coordinated AP scheme of a set of multiple coordinated AP schemes, where the invite frame includes a poll message that requests the wireless station to perform frame exchange associated with the coordinated AP scheme, transmit, within the shared transmission opportunity and based on the poll message, an initial control response frame, and receive, within the shared transmission opportunity and based on transmission of the initial control response frame, a coordinated downlink PPDU transmission.

Another innovative aspect of the subject matter described in this disclosure can be implemented in another wireless station for wireless communications. The wireless station may include means for receiving, within a shared transmission opportunity of an AP, an invite frame that indicates initiation of a joint frame transmission sequence associated with a coordinated AP scheme of a set of multiple coordinated AP schemes, where the invite frame includes a poll message that requests the wireless station to perform frame exchange associated with the coordinated AP scheme, means for transmitting, within the shared transmission opportunity and based on the poll message, an initial control response frame, and means for receiving, within the shared transmission opportunity and based on transmission of the initial control response frame, a coordinated downlink PPDU transmission.

Another innovative aspect of the subject matter described in this disclosure can be implemented in a non-transitory computer-readable medium storing code for wireless communications. The code may include instructions executable by one or more processors to receive, within a shared transmission opportunity of an AP, an invite frame that indicates initiation of a joint frame transmission sequence associated with a coordinated AP scheme of a set of multiple coordinated AP schemes, where the invite frame includes a poll message that requests the wireless station to perform frame exchange associated with the coordinated AP scheme, transmit, within the shared transmission opportunity and based on the poll message, an initial control response frame, and receive, within the shared transmission opportunity and based on transmission of the initial control response frame, a coordinated downlink PPDU transmission.

Another innovative aspect of the subject matter described in this disclosure can be implemented in a method for wireless communications by a first AP. The method may include communicating, with a second AP during a CoBF agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with CoBF transmission by the first AP and the second AP to the first set of stations of the first AP and the second set of stations of the second AP, communicating, during the channel sounding phase, one or more sounding messages in accordance with the one or more first parameters for the channel sounding phase, the one or more first parameters indicating a sounding sequence variant from a set of multiple different sounding sequence variants to apply for communication of the one or more sounding messages during the channel sounding phase, and transmitting, during the transmission phase, a CoBF transmission in accordance with the one or more second parameters for the transmission phase and based on the one or more sounding messages.

Another innovative aspect of the subject matter described in this disclosure can be implemented in a first AP for wireless communications. The first AP may include a processing system that includes processor circuitry and memory circuitry that stores code. The processing system may be configured to cause the first AP to communicate, with a second AP during a CoBF agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with CoBF transmission by the first AP and the second AP to the first set of stations of the first AP and the second set of stations of the second AP, communicate, during the channel sounding phase, one or more sounding messages in accordance with the one or more first parameters for the channel sounding phase, the one or more first parameters indicating a sounding sequence variant from a set of multiple different sounding sequence variants to apply for communication of the one or more sounding messages during the channel sounding phase, and transmit, during the transmission phase, a CoBF transmission in accordance with the one or more second parameters for the transmission phase and based on the one or more sounding messages.

Another innovative aspect of the subject matter described in this disclosure can be implemented in a first AP for wireless communications. The first AP may include means for communicating, with a second AP during a CoBF agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with CoBF transmission by the first AP and the second AP to the first set of stations of the first AP and the second set of stations of the second AP, means for communicating, during the channel sounding phase, one or more sounding messages in accordance with the one or more first parameters for the channel sounding phase, the one or more first parameters indicating a sounding sequence variant from a set of multiple different sounding sequence variants to apply for communication of the one or more sounding messages during the channel sounding phase, and means for transmitting, during the transmission phase, a CoBF transmission in accordance with the one or more second parameters for the transmission phase and based on the one or more sounding messages.

Another innovative aspect of the subject matter described in this disclosure can be implemented in a non-transitory computer-readable medium storing code for wireless communications. The code may include instructions executable by one or more processors to communicate, with a second AP during a CoBF agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with CoBF transmission by the first AP and the second AP to the first set of stations of the first AP and the second set of stations of the second AP, communicate, during the channel sounding phase, one or more sounding messages in accordance with the one or more first parameters for the channel sounding phase, the one or more first parameters indicating a sounding sequence variant from a set of multiple different sounding sequence variants to apply for communication of the one or more sounding messages during the channel sounding phase, and transmit, during the transmission phase, a CoBF transmission in accordance with the one or more second parameters for the transmission phase and based on the one or more sounding messages.

In some examples of the method, first APs, and non-transitory computer-readable medium described herein, communicating the one or more messages may include operations, features, means, or instructions for communicating, during the CoBF agreement establishment phase, the one or more messages indicating one or more capabilities associated with the first AP, the second AP, or both, where transmission of the CoBF transmission may be in accordance with the one or more capabilities.

In some examples of the method, first APs, and non-transitory computer-readable medium described herein, the one or more capabilities include a quantity of transmission antennas, a quantity of supported spatial dimensions, or both.

In some examples of the method, first APs, and non-transitory computer-readable medium described herein, communicating the one or more messages may include operations, features, means, or instructions for communicating, during the CoBF agreement establishment phase, the one or more messages indicating a preferred sounding interval or a supported sounding interval for execution of a sounding sequence associated with the channel sounding phase, where communication of the one or more sounding messages during the channel sounding phase may be in accordance with the preferred sounding interval or the supported sounding interval.

In some examples of the method, first APs, and non-transitory computer-readable medium described herein, the preferred rate or the supported rate of the sounding interval may be a minimum sounding interval or a maximum sounding interval.

In some examples of the method, first APs, and non-transitory computer-readable medium described herein, communicating the one or more messages may include operations, features, means, or instructions for communicating, during the CoBF agreement establishment phase, the one or more messages indicating a first quantity of stations requested by the first AP to include for the channel sounding phase and a second quantity of stations the second AP may be permitted to include for the channel sounding phase, where communication of the one or more sounding messages during the channel sounding phase may be based on the first quantity of stations, the second quantity of stations, or both.

In some examples of the method, first APs, and non-transitory computer-readable medium described herein, communicating the one or more messages may include operations, features, means, or instructions for communicating, during the CoBF agreement establishment phase, the one or more messages negotiating the quantity of the first set of stations served by the first AP and the second set of stations served by the second AP that may be candidates for CoBF transmission by the first AP and the second AP, where communication of the one or more sounding messages during the channel sounding phase may be based on the first set of stations, the second set of stations, or both.

In some examples of the method, first APs, and non-transitory computer-readable medium described herein, a duration associated with the channel sounding phase may be based on a quantity of stations included in the first set of stations, a quantity of stations included in the second set of stations, or both.

In some examples of the method, first APs, and non-transitory computer-readable medium described herein, communicating the one or more messages may include operations, features, means, or instructions for communicating, during the CoBF agreement establishment phase, the one or more messages indicating which one of the first AP or the second AP may be a frequency synchronization reference AP and a different one of the first AP or the second AP may be a frequency synchronization follower AP, where communication of the one or more sounding messages during the channel sounding phase, communication of the coordinated beamformed transmission of the transmission phase, or both may be based on a frequency synchronization reference signal output by the frequency synchronization reference AP.

In some examples of the method, first APs, and non-transitory computer-readable medium described herein, communicating the one or more messages may include operations, features, means, or instructions for communicating, during the CoBF agreement establishment phase, the one or more messages indicating one or more wireless communication schemes, operation modes, or both of a set of multiple different wireless communication schemes, operation modes, or both, the one or more messages indicating whether the one or more wireless communication schemes, operation modes, or both may be allowed or disallowed for communications between the second AP and the second set of stations during the transmission phase.

In some examples of the method, first APs, and non-transitory computer-readable medium described herein, communicating the one or more messages may include operations, features, means, or instructions for communicating, during the CoBF agreement establishment phase, the one or more messages indicating a supported sounding sequence variant or a preferred sounding sequence variant of the set of multiple different sounding sequence variants, where communication of the one or more sounding messages may be in accordance with the supported sounding sequence variant or the preferred sounding sequence variant.

In some examples of the method, first APs, and non-transitory computer-readable medium described herein, communicating the one or more messages may include operations, features, means, or instructions for communicating, during the CoBF agreement establishment phase, the one or more messages indicating a supported acknowledgement information polling scheme or a preferred acknowledgement information polling scheme, the method further including and transmitting an acknowledgement information polling message in accordance with the supported acknowledgement information polling scheme or the preferred acknowledgement information polling scheme.

In some examples of the method, first APs, and non-transitory computer-readable medium described herein, communicating the one or more messages may include operations, features, means, or instructions for communicating, during the CoBF agreement establishment phase, the one or more messages indicating a padding duration, the method further including and communicating one or more frames associated with the CoBF transmission in accordance with the padding duration, the padding duration being included for each of the one or more frames.

In some examples of the method, first APs, and non-transitory computer-readable medium described herein, communicating the one or more messages may include operations, features, means, or instructions for communicating, during the CoBF agreement establishment phase, the one or more messages including an indication of whether to perform in basic service set (In-BSS) sounding during the channel sounding phase, where communication of the one or more sounding messages may be in accordance with the indication.

In some examples of the method, first APs, and non-transitory computer-readable medium described herein, communicating the one or more messages may include operations, features, means, or instructions for communicating, during the CoBF agreement establishment phase, the one or more messages comprising an indication of one or more timeout durations, the one or more timeout durations corresponding to a silent period between frames of the sounding phase, the transmission phase, or both, wherein the one or more timeout durations are in accordance with an initial control frame duration, a block acknowledgement (BA) request rate, a BA polling scheme, or any combination thereof

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a wireless environment that supports techniques for a unified frame transmission sequence for coordinated beamforming (CoBF) and coordinated spatial reuse (CSR).

FIG. 3 shows an example of a frame transmission sequence associated with a CoBF scheme.

FIG. 4 shows an example of a frame transmission sequence associated with a CSR scheme.

FIG. 5 shows an example of a frame transmission sequence associated with an CSR scheme.

FIG. 6 shows an example of a unified frame transmission sequence that supports a unified frame transmission sequence for coordinated beamforming and coordinated spatial reuse.

FIG. 7 shows an example of a unified frame transmission sequence that supports a unified frame transmission sequence for coordinated beamforming and coordinated spatial reuse.

FIG. 8 shows an example of a sounding sequence scheme that supports a unified frame transmission sequence for coordinated beamforming and coordinated spatial reuse.

FIG. 9 shows an example of a frame transmission sequence that supports a unified frame transmission sequence for coordinated beamforming and coordinated spatial reuse.

FIG. 10 shows an example of a frame transmission sequence that supports a unified frame transmission sequence for coordinated beamforming and coordinated spatial reuse.

FIG. 11 shows an example of a frame transmission sequence that supports a unified frame transmission sequence for coordinated beamforming and coordinated spatial reuse.

FIG. 12 shows an example of a sounding sequence scheme that supports a unified frame transmission sequence for coordinated beamforming and coordinated spatial reuse.

FIG. 13 shows an example of a sounding sequence scheme that supports a unified frame transmission sequence for coordinated beamforming and coordinated spatial reuse.

FIG. 14 shows an example of a sounding sequence scheme that supports a unified frame transmission sequence for coordinated beamforming and coordinated spatial reuse.

FIG. 15 shows an example of a sounding sequence scheme that supports a unified frame transmission sequence for coordinated beamforming and coordinated spatial reuse.

FIG. 16 shows a block diagram of an example wireless communication device that supports techniques for a unified frame transmission sequence for coordinated beamforming and coordinated spatial reuse.

FIG. 17 shows a block diagram of an example wireless communication device that supports techniques for a unified frame transmission sequence for coordinated beamforming and coordinated spatial reuse.

FIG. 18 shows a flowchart illustrating an example process performable by or at a first access point (AP) that supports techniques for a unified frame transmission sequence for coordinated beamforming and coordinated spatial reuse.

FIG. 19 shows a flowchart illustrating an example process performable by or at a second AP that supports techniques for a unified frame transmission sequence for coordinated beamforming and coordinated spatial reuse.

FIG. 20 shows a flowchart illustrating an example process performable by or at a wireless station that supports techniques for a unified frame transmission sequence for coordinated beamforming and coordinated spatial reuse.

FIG. 21 shows a flowchart illustrating an example process performable by or at a first AP that supports techniques for a unified frame transmission sequence for coordinated beamforming and coordinated spatial reuse.

FIG. 22 shows a flowchart illustrating an example process performable by or at a first AP that supports techniques for a unified frame transmission sequence for coordinated beamforming and coordinated spatial reuse.

FIG. 23 shows a flowchart illustrating an example process performable by or at a first AP that supports techniques for a unified frame transmission sequence for coordinated beamforming and coordinated spatial reuse.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some wireless communication networks may support coordinated transmission messaging sequences in which two or more access points (APs) simultaneously use the medium (such as a wireless channel) in two or more basic service sets (BSSs) to transmit downlink communications to one or more wireless stations (STA) during a shared transmission opportunity. In some examples, the coordinated transmission messaging sequences may be associated with a particular coordinated AP scheme supported by the two or more APs. One example of a coordinated AP scheme may be a coordinated beamforming (CoBF) scheme. In this case, when the two or more APs operate in accordance with the CoBF scheme, a coordinated transmission messaging sequence may be associated with a CoBF operation. The CoBF operation may include a channel sounding phase, during which channel state information (CSI) is made available at each AP and a transmission phase, during which the APs coordinate to determine which stations (STAs) will be served and to synchronize transmissions in order to minimize interference. Another example of a coordinated AP scheme may be a coordinated spatial reuse (CSR) scheme. In this case, when the two or more APs operate in accordance with the CSR scheme, a coordinated transmission messaging sequence may be associated with a CSR operation. The CSR operation may involve a dynamic process in which the APs make real-time adjustments to transmit power, beamforming directions, or channel allocation to optimize spectrum reuse while minimizing interference. The APs may utilize the CoBF scheme or the CSR scheme to improve spectral efficiency, as well as capacity and performance at the network.

In some examples, to perform the coordinated transmission messaging sequences, the APs and one or more corresponding wireless STAs served by the APs may exchange one or more frames, such as one or more invite frames, initial control frames (ICFs), initial control responses (ICRs) frames, response frames, trigger or synchronization frames, acknowledgement frames, or any combination thereof to prepare the one or more STAs to receive data. In some examples, however, the sequence of the frame transmission may differ depending on which coordinated AP scheme the APs operate in accordance with.

Various aspects relate generally to techniques for providing a generic or unified frame transmission sequence that may be utilized to support different coordinated AP schemes, such as the CoBF scheme and the CSR scheme. In this way, a single unified frame transmission sequence may be provided to replace multiple distinct frame transmission sequences conventionally used to support different coordinated AP schemes. Some aspects more specifically relate to the particular sequence of transmission of the frames within the frame transmission sequence and the content of such frames in the example of the different coordinated AP schemes. Although aspects herein may describe the concepts and techniques in the context of CoBF and CSR schemes, it should be understood that these concepts and techniques may apply to any type of coordinated AP scheme, and are not limited to CoBF and CSR schemes.

In some examples, a first AP, such as a sharing AP, may identify an opportunity during which the first AP and one or more second APs, such as a shared AP, may simultaneously transmit downlink communications to the respective wireless STAs using different spatial resources. The first AP may announce the shared transmission opportunity by transmitting an invite frame during the shared transmission opportunity. The invite frame may indicate the initiation of a frame transmission sequence associated with a coordinated AP scheme of a plurality of coordinated AP schemes. The plurality of coordinated AP schemes may include at least a first coordinated AP scheme and a second coordinated AP scheme. For instance, the invite frame may include an invitation to perform a CoBF operation or a CSR operation between the first AP and the second AP. In some examples, the invite frame may include a poll message that requests a wireless STA to perform frame exchange associated with the first coordinated AP scheme or the second coordinated AP scheme. In response to the invitation, the first AP and the second AP may communicate, during the shared transmission opportunity, a plurality of frames in accordance with the frame transmission sequence. The plurality of frames may include information that coordinates downlink physical layer protocol data unit (PPDU) transmissions by the first AP and a second AP. In some examples, based on the poll message included in the invite frame, the wireless STA may transmit an ICR frame that indicates availability of the wireless STA to participate in frame exchange in accordance with a coordinated AP scheme indicated by the invite frame. The first AP and the second AP may thereafter transmit to their respective wireless STAs, during the shared transmission opportunity, one or more coordinated downlink PPDU transmissions.

Conventionally, APs do not exchange adequate information in advance of performing coordinated transmission, resulting in a capability mismatch between APs and increased interference to stations of the APs, thereby degrading data throughput and limiting the benefits of coordinated beamformed transmission.

To address these issues and other issues, APs may exchange information to negotiate one or more communication parameters in order to perform coordinated transmission messaging sequences. In such examples, a first AP may perform an agreement establishment phase to determine whether a second AP is a suitable candidate for performing coordinated beamformed transmission. To do so, the APs may exchange information to determine whether the APs are capable of simultaneously sharing a wireless communication channel in a way that increases data throughput. In some examples, the first AP and the second AP may perform the agreement establishment phase (such as a CoBF agreement establishment phase), which may establish the CoBF operation and may provide the APs included in the agreement with one or more parameters associated with the CoBF operation. Accordingly, the APs may exchange one or more messages including the parameters (such as operating parameters), and the APs may utilize the parameters to perform a sounding phase (such as a measurement phase), a transmission phase (such as the coordinated transmission messaging sequences, or a CoBF data transmission phase). For example, the parameters may include one or more supported sounding sequence schemes, one or more hardware capabilities of one AP, the other AP, or both, or one or more sounding intervals (such as supported sounding intervals) associated with the sounding phase, among other examples.

Particular aspects of the subject matter described in this disclosure may be implemented to realize one or more of the following potential benefits. In some examples, the described techniques may simplify and reduce a quantity of distinct frame transmission sequences necessary to support multiple coordinated AP schemes used to for coordinated transmissions during a shared transmission opportunity between two or more APs. For instance, the described techniques may replace multiple distinct frame transmission sequences conventionally used to support different coordinated AP schemes, with a single unified frame transmission sequence. A single unified frame transmission sequence may reduce complexity in hardware implementation at one or more APs and one or more wireless stations, by eliminating the requirement to support multiple coordinated AP schemes. Accordingly, by a first AP inviting one or more second APs to participate in a frame exchange using the unified frame transmission sequence that is associated with multiple coordinated AP schemes, and by communicating in accordance with the unified frame transmission sequence, improvements in communication between devices at a network may be realized, which may result in an improvement to performance at the network.

In some examples, by performing the agreement establishment phase, the first AP and the second AP may exchange messages indicating the one or more parameters that have been negotiated for the CoBF operation, which may enable the APs to perform the channel sounding phase, the transmission phase, or both, in such a manner that increases data throughput via a wireless communication channel while managing interference caused to respective stations of the first and second APs. Moreover, the APs may exchange information to enhance sounding techniques whereby a rate at which a sounding interval is performed is selected to satisfy a coherence time of channel state information for one or both of the APs. Moreover, the APs may negotiate which AP is to operate as a frequency source the channel sounding phase, the transmission phase, or both, to improve frequency alignment of transmissions by the APs.

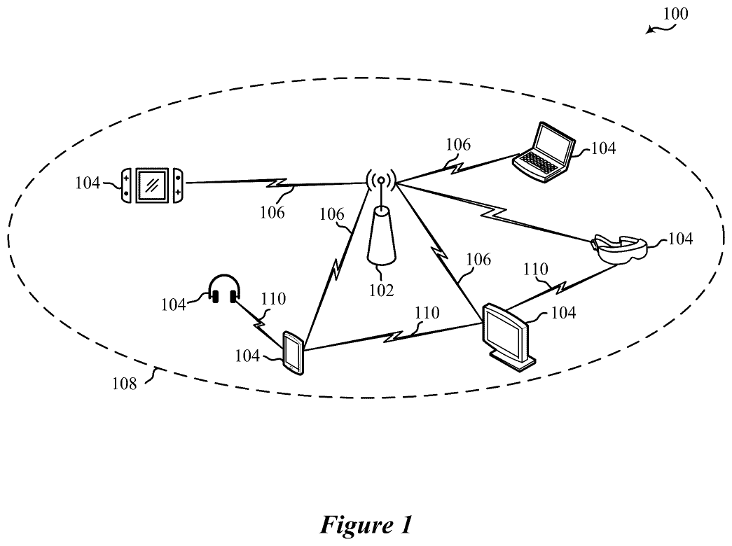

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (such as in an extended service set (ESS) deployment, enterprise network or AP mesh network), or may not include any AP at all (such as in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PPDUs.

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a transmission opportunity on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

Puncturing is a wireless communication technique that enables a wireless communication device (such as either an AP 102 or a STA 104) to transmit and receive wireless communications over a portion of a wireless channel exclusive of one or more particular subchannels (hereinafter also referred to as “punctured subchannels”). Puncturing specifically may be used to exclude one or more subchannels from the transmission of a PPDU, including the signaling of the preamble, to avoid interference from a static source, such as an incumbent system, or to avoid interference of a more dynamic nature such as that associated with transmissions by other wireless communication devices in OBSSs. The transmitting device (such as an AP 102 or a STA 104) may puncture the subchannels on which there is interference and in essence spread the data of the PPDU to cover the remaining portion of the bandwidth of the channel. For example, if a transmitting device determines (such as detects, identifies, ascertains, or calculates), in association with a contention operation, that one or more 20 MHz subchannels of a wider bandwidth wireless channel are busy or otherwise not available, the transmitting device implement puncturing to avoid communicating over the unavailable subchannels while still utilizing the remaining portions of the bandwidth. Accordingly, puncturing enables a transmitting device to improve or maximize throughput, and in some instances reduce latency, by utilizing as much of the available spectrum as possible. Static puncturing in particular makes it possible to consistently use wideband channels in environments or deployments where there may be insufficient contiguous spectrum available, such as in the 5 GHz and 6 GHz bands.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and UHR operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some wireless communication systems, wireless communication devices (such as an AP 102 and STAs 104 described with reference to FIG. 1) may operate via one or more wireless communication links in a frequency band higher than a sub-7 GHz (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (such as a frequency band between 30 GHz and 300 GHz, such as a 60 GHz frequency band). A wireless communication system supporting such mmWave communications (such as AP 102 and STAs 104 in wireless communications network 100) may use integrated mmWave (IMMW) techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QoS) parameters. For example, existing technology (such as IEEE 802.11ax standard amendment protocols) supports the use of up to 1024-quadrature amplitude modulation (QAM), where a modulated symbol carries 10 bits. To further improve peak data rate, each of the AP 102 or the STA 104 may employ use of 4096-QAM (also referred to as “4 k QAM”), which enables a modulated symbol to carry 12 bits. 4 k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 μs per OFDM symbol). The AP 102 or the STA 104 using 4096-QAM may enable a 20% increase in data rate compared to 1024-QAM given the same coding rate, thereby allowing users to obtain higher transmission efficiency.

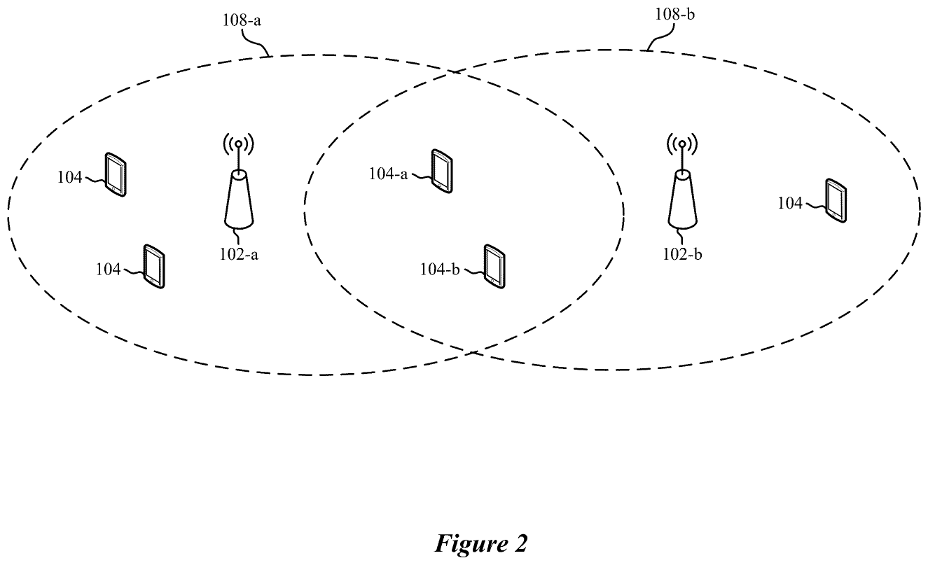

FIG. 2 shows an example of a wireless environment 200 that supports techniques for a unified frame transmission sequence for CoBF and CSR. In some examples, the wireless environment 200 may implement or be implemented by aspects of the wireless communication network 100. For example, the wireless environment 200 may include a first AP 102-a, a second AP 102-b, a first wireless STA 104-a, a second wireless STA 104-b, and one or more other wireless STAs 104, which may be examples of corresponding devices described herein with reference to FIG. 1. Additionally, or alternatively, the APs 102 and the wireless STAs 104 may each be examples of other types of wireless devices, such as a BS, a UE, or another type of transmitter or receiver. Thus, although aspects of the present disclosure are described with reference to APs 102 and wireless STAs 104, it is understood that the described techniques may be performed by a wireless device different from an AP 102 and a wireless STA 104. As described herein, operations performed by the APs 102 and the wireless STAs 104 may be respectively performed by an AP 102, a wireless STA 104, or another wireless device, and the examples shown should not be construed as limiting. Additionally, or alternatively, while two APs 102 and five wireless STAs 104 are shown in the wireless environment 200, more devices or fewer devices may be possible and the examples shown should not be construed as limiting.

Each of the first AP 102-a and the second AP 102-b may be associated with a respective BSS (such as a first BSS and a second BSS, respectively), where each BSS includes one or more wireless STAs 104. For example, the first BSS may include one or more devices within a first coverage area 108-a (such as the AP 102-a, the wireless STA 104-a, the wireless STA 104-b, and one or more other wireless STAs 104). Similarly, the second BSS may include one or more devices within a second coverage area 108-b (such as the AP 102-b, the wireless STA 104-a, the wireless STA 104-b, and one or more other wireless STAs 104). The wireless STAs 104 may be connected to the first AP 102-a, the second AP 102-b, or both via a communication link 106. In some examples, the first BSS and the second BSS may be overlapping to form an OBSS. For example, the wireless STA 104-a and the wireless STA 104-b may be included in both the first BSS and the second BSS, and may therefore be part of an OBSS associated with the first AP 102-a and the second AP 102-b. In some examples, the first AP 102-a may be a sharing AP and the second AP 102-b may be a shared AP, as discussed with reference to FIG. 1.

In some examples, devices in the wireless environment 200 may support one or more coordinated AP schemes, such as a CSR scheme and a CoBF scheme. The CSR scheme may support one or more CSR operations and the CoBF scheme may support one or more CoBF operations. Both the CSR and the CoBF operations may aim to simultaneously use a medium (such as a wireless channel) in two or more BSSs to maximize the system throughput. The CSR operations may involve a dynamic process in which the APs 102 may make real-time adjustments to transmit power, beamforming directions, channel allocation, or any combination thereof. The CoBF operations may involve a channel sounding phase, during which CSI is made available at each of the AP 102 and a transmission phase, during which the APs 102 coordinate to determine which wireless STAs 104 will be served and to synchronize transmissions in order to minimize interference. The CSR operations may involve a pre-transmission phase for interference estimation and transmit power calculation to manage, reduce, or limit the interference imposed by an AP onto an OBSS STA.

In some examples, the CoBF operation may exploit one or more hardware capabilities of the AP 102-a and the AP 102-b (such as larger antenna arrays) to actively null signals at one or more clients of the OBSS using transmission beamforming. For example, the first AP 102-a may create a null at the second wireless STA 104-b associated with the second AP 102-b and the second BSS, and the second AP 102-b may create a null at the first wireless STA 104-a associated with the first AP 102-a and the first BSS. In this way, OBSS interference may be limited and successful reception may be achieved. However, to perform such a CoBF operation, transmitting devices (such as the first AP 102-a and the second AP 102-b) may have CSI knowledge (such as may know CSI information). For example, the AP 102-a may perform the CoBF operation based on knowing the channel estimate between the AP 102-a and an associated client (such as wireless STA 104) as well as between the AP 102-a and the OBSS client (such as the wireless STA 104-a). The AP 102-a may be unable to perform the CoBF operation without such channel estimates.

A CoBF operation may be divided into three main phases: a CoBF agreement establishment phase (such as an initial CoBF operation establishment phase), a channel sounding phase (such as CSI estimate collection) and a transmission phase (such as initial negotiation and initial handshaking between the first AP 102-a and the second AP 102-b in addition to data transmission). The objective of the COBF agreement establishment phase may be to create pairwise CoBF agreements between APs 102 and to share all the static and semi-static information needed for CoBF operation from both APs 102. For example, the first AP 102-a and the second AP 102-b may exchange one or more parameters associated with the channel sounding phase, the transmission phase, or both during the respective CoBF operation. The objective of the channel sounding phase may be to make the CSI available at the OBSS APs 102 so that the OBSS AP 102 may actively null a signal at the OBSS client. For example, as a result of the channel sounding phase, the first AP 102-a may null an associated signal at the wireless STA 104-b and the second AP 102-b may null an associated signal at the wireless STA 104-a to reduce interference. During the transmission phase of the CoBF operation, the first AP 102-a and the second AP 102-b (and any other APs 102 that may contribute to the OBSS) may agree on which clients (such as wireless STAs 104) will be served by which AP 102, synchronize with each device, and proceed with simultaneous data transmission. During the simultaneous data transmission, the first AP 102-a and the second AP 102-b may use the CSI collected during the channel sounding phase in order to create the nulls in each respective signal.

The CoBF agreement establishment phase of the CoBF operation may be a collaborative process between two or more APs 102 (such as the first AP 102-a and the second AP 102-b), where the two or more APs 102 agree to operate in the CoBF operation. In some examples, the two or more APs 102 may agree on multiple configuration/operation parameters for the next two phases of CoBF operation (such as CoBF sounding and CoBF transmission phases). For a successful CoBF operation, each AP 102 may commit to satisfy its peer APs 102 operation parameters (such as a list of candidate parameters/information to be shared and agreed upon during this phase).

In some examples, during the CoBF agreement establishment phase, the first AP 102-a and the second AP 102-b may exchange signaling indicating one or more capabilities (such as hardware capabilities) of the APs 102. For example, the hardware capabilities of the APs 102 may affect an ability of reliable transmission precoding to create nulls at the other AP 102 clients (such as one or more STAs 104). For example, the hardware capabilities of the APs 102 may include a quantity of transmission antennas (such as a number of Tx antennas), a quantity of supported spatial dimensions (such as a quantity of spatial dimensions supported for CoBF operations by the APs 102), or the like.

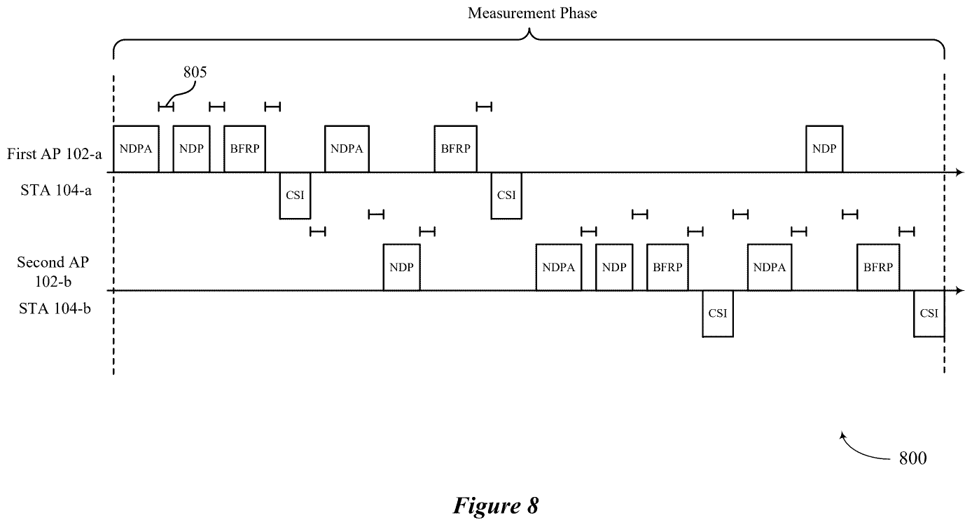

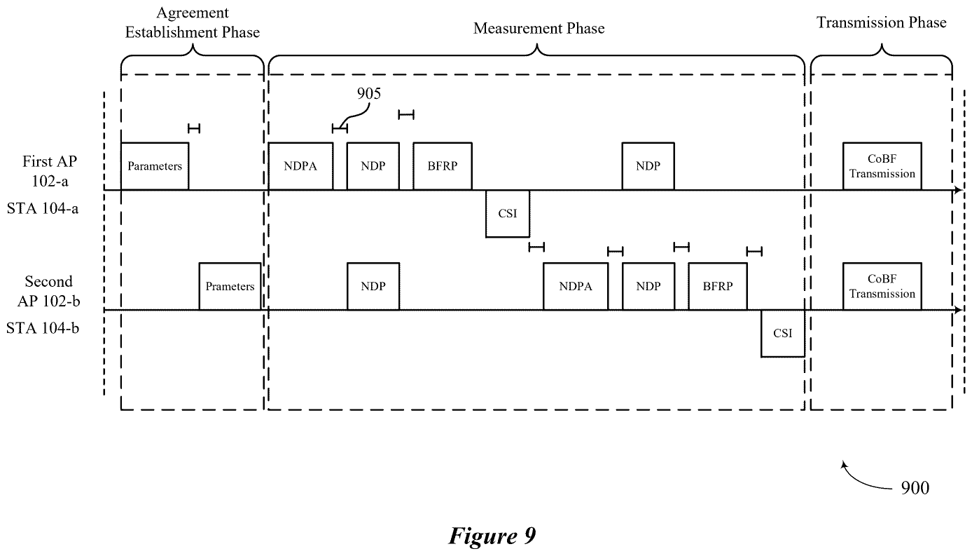

The CoBF agreement establishment phase may include sharing a sounding interval (e.g., a preferred sounding interval, a supported sounding interval) associated with the channel sounding phase (such as a maximum/minimum or supported sounding interval). For example, the APs 102 may exchange signaling indicating a sounding interval (such as a minimum sounding interval) value to indicate a highest frequency (such as a duration between sounding sessions) at which the APs 102 may perform the sounding sequence. The sounding interval may indicate a rate at which the sounding phase is performed (such as between the first AP 102-a and the second AP 102-b). For example, the sounding interval may indicate a frequency with which to initiate a new sounding session or to perform (such as how often to perform) a sounding sequence scheme such as one or more of the sounding sequence schemes described herein with reference to FIG. 8 and FIG. 9. In some examples, the first AP 102-a and the second AP 102-b may initiate (such as perform) one or more of the sounding sequence schemes described herein with reference to FIG. 8 and FIG. 9 at a rate according to the sounding interval.

A sounding interval having a greater sounding frequency than the indicated sounding interval may incur increased overhead for one or more of the APs 102. In some examples, the APs 102 may exchange signaling indicating a sounding interval (such as a maximum sounding interval) value to indicate a lowest frequency below which the collected CSI information will expire due to mobility in the BSS, which may correspond to a CSI coherence time which may be reported. For example, the APs 102 may be unable to maintain accurate CSI information associated with a BSS mobility based on a corresponding sounding interval being relatively low (such as relatively infrequent CSI polling).

In some examples, the APs 102 may, as part of the CoBF agreement establishment phase, exchange signaling indicating a quantity of clients (such as a quantity of STAs 104) an AP 102 may support in the channel sounding phase (such as a CBF client set size). For example, each AP 102 (such as the first AP 102-a and the second AP 102-b) may share a limit on the number of clients that may be expected to be candidates for CBF operation (such as candidate clients to be included in the CoBF channel sounding and transmission phases). In some examples, a relatively larger CBF client set may incur an increased overhead (such as compared to smaller CBF client set sizes) due to increased time utilized for collecting CSI information during the sounding phase by the APs 102. This may incur further overhead in scenarios where one AP 102 has established CBF agreements with multiple other APs 102. Accordingly, one or both APs 102 may cap a CBF set size that the AP 102 may support for other APs 102 (such as other CBF pair APs 102). Each AP 102 may report a quantity of CBF clients that is smaller than or equal to the quantity of CBF clients the AP 102 may request (such as request to support during the transmission phase) from the other APs 102.

In addition to the sounding overhead, each AP may store the CSI information collected from other OBSSs during the channel sounding phase, which may incur memory and/or processing challenges if a large quantity of clients are to be included in the sounding sequence. For each CBF AP 102 pair, the APs 102 may perform the CoBF sounding and transmission phases according to a lower quantity of clients out of two values (such as CBF client set size values) reported by each of the two APs 102.

Additionally, or alternatively, the number of CBF candidate clients in each BSS may indicate a length/duration of the channel sounding phase for that BSS. In some examples, other APs 102 participating in the channel sounding procedures may utilize the indication of the duration of the channel sounding phase to determine when the other APs may initiate the sounding procedures in its BSS by sending an NDPA frame or other initial control frames (such as frames associated with other functions). For example, a duration of the sounding phase described herein with reference to FIG. 8, a duration of the sounding phase described herein with reference to FIG. 9, or both may be based on the number of CBF candidate clients included in the respective sounding phases, among other examples. Additionally, or alternatively, a timing (such as a start time, or a start interval) of each sounding phase such as the sounding phases described herein with reference to FIG. 8 and FIG. 9 may be based on the sounding interval, the duration of the respective sounding phase (such as indicated by the number of CBF candidate clients), or both.

In some examples, each AP 102 may indicate the quantity of clients the other AP 102 may include in the sounding sequence and the quantity of associated clients requested for inclusion in the sounding sequence. The quantity of clients the other AP 102 may include in the sounding sequence may be a maximum quantity that the first AP 102 (such as the first AP 102-a as a sounding sequence initiator) may support in terms of memory and processing resources. The number of clients an AP 102 may include in the sounding is reported so that the other AP 102 may replan memory and processing resources when that quantity of clients is less than the maximum that the other AP 102 may support. In some cases, if the number of clients an AP 102 requests to include in the sounding is greater than the quantity (e.g., maximum quantity) that the other AP 102 may support, then the other AP may accept the request and limit the total number of additional APs 102 to establish CoBF agreements with such that the total amount of CSI information to be processed and stored may satisfy a threshold quantity of CSI information (such as is kept within the limit).

As part of the CoBF agreement establishment phase, the APs 102 may perform a synchronization-reference/synchronization-follower AP negotiation (such as assigning AP 102 frequency synchronization roles for carrier frequency offset (CFO) alignment). For example, the first AP 102-a and the second AP 102-b may exchange signaling indicating which one of the first AP 102-a or the second AP 102-b may operate as (such as be defined as) a synchronization-reference AP 102 and which one of the first AP 102-a or the second AP 102-b may operate as (such as be defined as) a synchronization-follower AP 102. The APs 102 may negotiate (such as via the signaling during the CoBF agreement establishment phase) which of the APs 102 may act as the synchronization-reference AP and provide a reference frequency for frequency alignment (such as a signaling frequency alignment) and which of the APs 102 may act as the synchronization-follower AP and may utilize the reference frequency of the synchronization-reference AP for frequency alignment. Alternatively, the APs 102 establishing the CoBF agreement may indicate a preference of deciding on the frequency synchronization roles at the beginning or within the channel sounding phase (such as the sounding sequence initiator AP acts as the synchronization-reference while the responder AP acts as the synchronization-follower).

In some examples, the synchronization-reference AP may output a synchronization signal (such as a synchronization message) indicating the reference frequency for the frequency alignment. For example, the synchronization-reference AP may output the synchronization signal, and the synchronization-follower AP may receive the synchronization signal and perform the frequency alignment such that the synchronization-reference AP and the synchronization-follower AP may communicate according to a common frequency (such as a same frequency based on the reference frequency). The synchronization-reference AP may output the synchronization signal periodically (such as at one or more times according to a time interval) or as one of the frames transmitted by the synchronization-reference AP during the channel sounding phase or the data transmission phase.

The CoBF agreement establishment phase may include an indication of one or more supported wireless communication schemes for joint operation during the CoBF operation (such as joint operation with other schemes/operation modes). For example, the wireless communication schemes allowed/disallowed may include: enhanced multi-link single radio (eMLSR), dynamic unavailability operation (DUO), periodic unavailability operation (PUO), dynamic power saving (DPS), dynamic subchannel operation (DSO), non-primary channel access (NPCA), dynamic bandwidth expansion (DBE), or other modes of operation. For example, each AP 102 of the APs 102 may indicate one or more subsets of wireless communication schemes that are allowed/disallowed for joint operation with CoBF. For example, the first AP 102-a, the second AP 102-b, or both may indicate one or more ICF common parameters for ICF/ICR-exchanges (such as for one or more STAs 104/operation modes including ICF/ICR exchanges) including: a common transmitter address (TA) for ICF exchange, a common BSS color for ICF exchange, a RU allocation for each BSS (such as a RU allocation agreement when one or more ICFs may be sent in an OFDMA mode), a duration of the extended timeout period that is indicated in the ICF and used by eMLSR STAs, DPS STAs, or STAs in any other similar operation mode, or other parameters.

Additionally, or alternatively, in some examples, the first AP 102-a and the second AP 102-b may exchange, during the CoBF agreement establishment phase, signaling indicating one or more parameters (such as configuration parameters) associated with the supported/allowed wireless communication schemes. For example, during the CoBF agreement establishment phase, the first AP 102-a and the second AP 102-b may negotiate the one or more parameters (such as operating parameters) corresponding to one or more allowed/supported wireless communication schemes such that the first AP 102-a and the second AP 102-b may operate according to the allowed wireless communication schemes (such as may perform a CoBF operation according to the allowed wireless communication schemes).

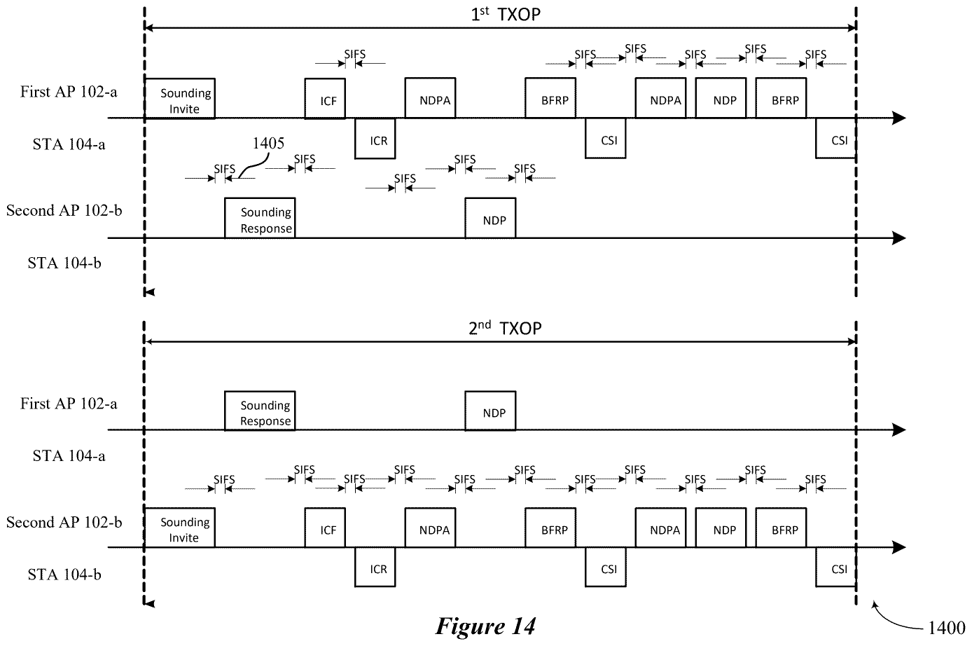

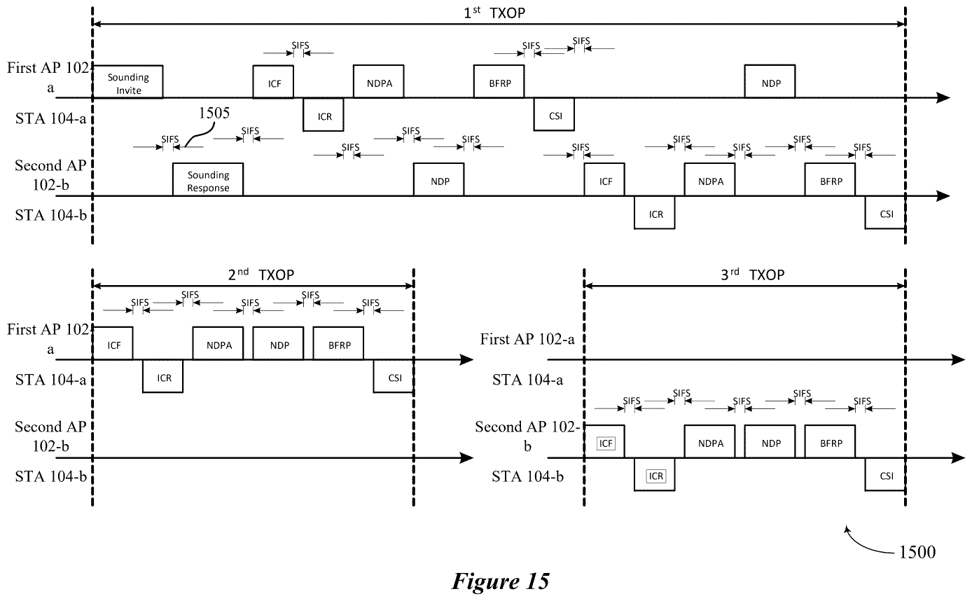

The first AP 102 second AP 102-b may exchange, as part of the CoBF agreement establishment phase, signaling indicating one or more sounding sequence schemes (such as sounding sequence variants) to be utilized during the channel sounding phase. For example, the first AP 102-a and the second AP 102-b may indicate support for sequential or joint sounding phases, which are further described herein with reference to FIG. 8 and FIG. 9, respectively. Additionally, or alternatively, the first AP 102-a and the second AP 102-b may indicate support for single TXOP sounding or multi-TXOP sounding. For example, the first AP 102-a and the second AP 102-b may indicate support for single TXOP sounding, single TXOP as a first scheme followed by using a multi-TXOP sounding as a second scheme (such as a backup scheme), or support for multi-TXOP sounding. Multi-TXOP sounding schemes may include: 2-TXOP, 3-TXOP, or 4-TXOP sounding sequences further defined herein with reference to FIG. 14 and FIG. 15.

The CoBF agreement establishment phase may include an indication of one or more acknowledgment information polling schemes to be performed (such as during the transmission scheme). For example, sequential (such as staggered) acknowledgment information polling may include triggering for acknowledgment transmission embedded within a DL PPDU (such as implicit triggering for the first AP 102-a). In such examples, the second AP 102-b may send an explicit block acknowledgment request (BAR) frame to poll the acknowledgment info in a block acknowledgment (BA) or a multi-STA block acknowledgment (M-BA) frame. Additionally, or alternatively, the first AP 102-a and the second AP 102-b may perform sequential (staggered) polling with explicit BAR frames to poll acknowledgment info in M-BA frames. Additionally, or alternatively, the first AP 102-a and the second AP 102-b may communicate coordinated uplink (C-UL) OFDMA M-BA frames sent in trigger-based (TB) PPDUs across different RUs in the two BSSs

In some examples, the APs 102 second AP 102-b may exchange signaling indicating whether to perform in-BSS sounding (such as whether an AP 102 will obtain CSI information for a BSS associated with the respective AP 102). For example, each of the APs 102 may indicate whether in-BSS CSI sounding is to be performed during the channel sounding phase as essential sounding. In some examples, one or both of the two APs 102 participating in the CoBF operation may initiate a CoBF transmission sequence after essential sounding is performed. Essential sounding may include cross-BSS CSI collection, or may include the cross-BSS CSI collection and the in-BSS CSI. Additionally, each AP 102 may indicate whether it may perform cross-BSS sounding first or In-BSS sounding when both are included in the same TXOP.

In some examples, as part of the CoBF agreement establishment phase, the first AP 102-a and the second AP 102-b may exchange signaling indicating a timeout duration (such as switch back criterion). The timeout duration may indicate a duration of time for the sharing AP's 102-a and the shared AP's 102-b STAs to wait after the ICR transmission and not switch back to listen mode or low capability mode (LCM) until the data PPDUs are transmitted during the data transmission phase or upon performing the sounding phase. The STAs 104 associated with the first AP 102-a and the second AP 102-b may operate in a prepared state associated with the CoBF operation (such as a state in which the first AP 102-a and the STAs 104 are prepared to perform the CoBF operation). Accordingly, during the timeout duration, the STAs 104 of the first AP 102-a, the STAs 104 of the second AP 102-b, or both may refrain from exiting the prepared state and may remain prepared to perform the CoBF operation (such as despite no frames being communicated during the silent period).

The timeout duration may be based on one or more parameters, and the first AP 102-a and the second AP 102-b may exchange signaling indicating the one or more parameters. For example, the first AP 102-a and the second AP 102-b may indicate a duration of the ICF frames (such as a maximum ICF duration), a multi-user BAR (MU-BAR) or BA polling rate (such as used rates), or one or more BA polling schemes. For example, the BA polling schemes may include sequential/parallel C-UL OFDMA BA frames, sequential MU-BAR frames embedded within DL PPDUs, BAR frames, or BA frames, or other polling schemes.

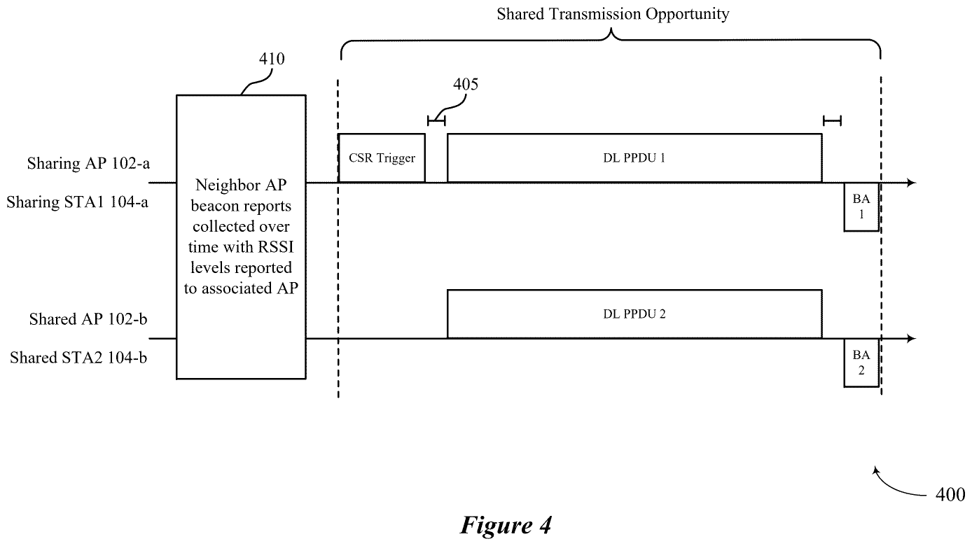

The channel sounding phase of the CoBF operation may be a collaborative process performed by two or more APs 102 to collect CSI between each AP 102 and the OBSS clients (such as wireless STAs 104). The general procedures of CoBF channel sounding may follow the same concept of legacy in-BSS CoBF channel sounding using the NDPA-NDP-BFRP-CSI frame sequence, as illustrated by at least FIG. 4.

CoBF channel sounding may be sequential or joint. In sequential channel sounding, sounding is first performed for an associated AP 102 (such as the first AP 102-a) by transmitting a null data packet (NDP) and receiving CSI in response to a beamforming report (BFRP) frame. Second sounding is performed for an OBSS AP 102 (such as the second AP 102-b). For example, the associated AP (such as the first AP 102-a) may transmit a null data packet announcement (NDPA) on behalf of the OBSS AP (such as second AP 102-b). The OBSS AP (such as the second AP 102-b) may transmit an NDP followed by a BFRP frame sent by the associated AP (such as the first AP 102-a) on behalf of the OBSS AP (such as the second AP 102-b). Finally, the client (such as the AP 102) may report back associated CSI. The sequential sounding process may be repeated for all APs 102 participating in the channel sounding process.

Joint channel sounding, in contrast, may aim to perform the sounding process in a more efficient way by performing CSI estimation to the associated AP (such as the first AP 102-a) as well as the OBSS AP (such as the second AP 102-b) simultaneously. A similar sounding sequence to that of sequential sounding may be used, but with the following differences. In joint channel sounding, one or more NDP frames may be sent jointly by both APs 102 at the same time. In such cases, CSI estimation to the two APs 102 can be done using a separate set of LTFs. Joint channel sounding may save up to three frame exchanges per AP 102 compared to sequential channel sounding, which may reduce the overhead of the sounding sequence.

During the transmission phase of the CoBF operation, the two or more APs 102 may agree on which clients (such as wireless STAs 104) will be served by each AP 102 during a shared transmission opportunity and whether or not each AP 102 can null an associated transmission signal at the one or more clients of the other AP 102. Such an agreement may be achieved by means of the following three-way handshaking sequence. First, the first AP 102-a (such as the sharing AP) may share common preamble information in addition to which client (such as the first wireless STA 104-a) or clients the first AP 102-a may serve via a CoBF invite frame (such as the CoBF invite frame may be associated with triggering one or more wireless STAs 104 to transition from a first operating state to a second operating state). The sharing AP may own the shared transmission opportunity. For example, in order to generate a common portion of later downlink PPDUs (such as CoBF messaging) at the first AP 102-a and the second AP 102-b with at least a portion of the file headers in common, the APs 102 may agree on one or more parameters. Second, the second AP 102-b (such as the shared AP) may acknowledge that the second AP 102-b can null an associated signal at the first AP 102-a client (such as the first wireless STA 104-a) and may declare which client the second AP 102-b will serve (such as the second wireless STA 104-b) via a CoBF response frame (such as based on the CoBF invite frame). The shared AP may use the shared transmission opportunity. Third, the first AP 102-a may acknowledge that the second AP 102-b can null an associated signal at the second AP 102-b client (such as the second wireless STA 104-b) via an ACK/Sync frame. The ACK/Sync frame may be used for synchronizing data transmissions, sharing information for creating a common preamble for downlink PPDUs, or both.

In some examples, one or more of the wireless STAs 104 may be an eMLSR wireless STA, may be in a CoEx mode, may be in a DPS mode, or any combination thereof. In such examples, the one or more wireless STAs 104 may exchange one or more ICFs and one or more ICR frames with an in-BSS AP 102 to prepare for a coordinated transmission messaging sequence, such as a channel sounding sequence, a transmission sequence, or both of a CoBF operation. For example, the channel sounding phase of the CoBF operation (which may be a sequential sounding operation or a joint sounding operation) may include two or more channel sounding sequences. During each channel sounding sequence of the channel sounding phase of the CoBF operation, an AP 102 may transmit one or more ICFs to one or more wireless STAs 104 requesting the one or more wireless STAs 104 to prepare to receive one or more frames as part of the channel sounding sequence. The one or more wireless STAs 104 may respond to the one or more ICFs with one or more ICRs acknowledging the ICF, indicating unavailability information, indicating that the one or more wireless STAs 104 are prepared to receive the one or more frames as part of the channel sounding sequence, or a combination thereof. As a result of the channel sounding phase, each AP 102 in the OBSS may have CSI associated with each of the one or more wireless STAs 104, which may be used to determine which clients will be served by which AP 102. During the transmission phase of the CoBF operation, an ICF/ICR exchange may take place between each AP 102 and one or more associated wireless STAs 104 to prepare the one or more associated wireless STAs 104 for reception of a downlink PPDU.

In some examples, however, the sequence of the frame transmission may differ depending on which coordinated AP scheme the APs 102 operate in accordance with. In accordance with aspects described herein, to simplify and reduce a quantity of frame sequences used to support different coordinated AP schemes, a single generic or unified frame transmission sequence may be utilized. The frame transmission sequence may be a generic or unified frame transmission sequence that supports different coordinated AP schemes, such as the CoBF scheme and the CSR scheme.

For instance, the first AP 102-a may be a sharing AP that identifies an opportunity during which the first AP 102-a and the second AP 102-b (such as a shared AP) may simultaneously transmit downlink communications to the respective wireless STAs 104 using different spatial resources. The first AP 102-a may announce the shared transmission opportunity by transmitting an invite frame during the shared transmission opportunity. The invite frame may indicate the initiation of a frame transmission sequence associated with a coordinated AP scheme of a plurality of coordinated AP schemes. The plurality of coordinated AP schemes may include at least a first coordinated AP scheme (such as a CoBF scheme) and a second coordinated AP scheme (such as a CSR scheme). For instance, the invite frame may include an invitation to perform a CoBF or a CSR operation between the first AP 102-a and the second AP 102-b. In some examples, the invite frame may include a poll message that requests a wireless STA 104 to perform frame exchange associated with the first coordinated AP scheme or the second coordinated AP scheme. In response to the invitation, the first AP 102-a and the second AP 102-b may communicate, during the shared transmission opportunity, a plurality of frames in accordance with the frame transmission sequence. The plurality of frames may include information that coordinates downlink PPDU transmissions by the first AP 102-a and the second AP 102-b. In some examples, based on the poll message included in the invite frame, the wireless STA 104 may transmit an ICR frame that indicates availability of the wireless STA 104 to participate in frame exchange in accordance with the coordinated AP scheme indicated by the invite frame. The first AP 102-a and the second AP 102-b may thereafter transmit to their respective wireless STAs 104, during the shared transmission opportunity, one or more coordinated downlink PPDU transmissions.

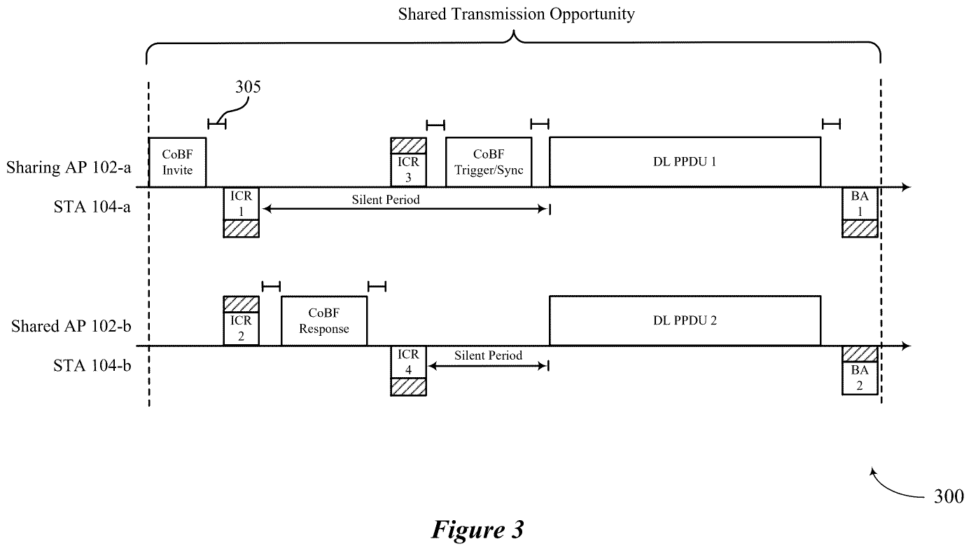

FIG. 3 shows an example of a frame transmission sequence 300 associated with a CoBF scheme. In some examples, the frame transmission sequence 300 may implement or be implemented by aspects of the wireless communication network 100 or the wireless environment 200 described with reference to FIGS. 1 and 2. For example, the frame transmission sequence 300 may include a CoBF invite frame, one or more ICR frames, a CoBF response frame, a CoBF trigger/synchronization frame, one or more BA frames, and one or more downlink PPDUs. The various frames and transmissions may be separated by one or more gaps 305 or silent periods. The frame transmission sequence 300 may be implemented by a sharing AP 102-a, one or more shared APs 102-b, one or more first wireless STAs 104-a, one or more second wireless STAs 104-b, or a combination thereof which may be examples of corresponding devices described herein with reference to FIGS. 1 and 2. The sharing AP 102-a may identify one or more shared transmission opportunities during which the sharing AP 102-a and the shared AP(s) 102-b may simultaneously transmit communications to the wireless STA(s) 104-a and wireless STA(s) 104-b, respectively.

In some implementations, the sharing AP 102-a and the shared AP 102-b may support the CoBF scheme. In such cases, the sharing AP 102-a and the shared AP 102-b may operate in accordance with one or more CoBF operations. The CoBF operations may involve one or more phases. During a transmission phase of the CoBF operation, the sharing AP 102-a and the shared AP 102-b may confirm their preparedness to participate in the shared transmission opportunity. The sharing AP 102-a and the shared AP 102-b may notify each other about which clients, such as which wireless STAs 104 will be scheduled. This may be achieved through the communication of a set of frames between the sharing AP 102-a, the shared AP 102-b, and one or more wireless STAs 104.

For instance, the sharing AP 102-a may transmit a CoBF invite frame during the shared transmission opportunity. The CoBF invite frame may include an invitation that requests participation of the shared AP 102-b in a frame exchange during the shared transmission opportunity. The CoBF invite frame may include an indication of which wireless STAs 104 will be served by the sharing AP 102-a. In some examples, the CoBF invite frame may include a poll message. The poll message may cause a wireless STA 104 associated with the sharing AP 102-a, such as the first wireless STA 104-a, to be polled to provide an indication of the availability of the first wireless STA 104-a. The CoBF invite frame may further provide padding for link activation (such as for eMLSR) or switching to high capability mode (such as DPS). In some examples, this may be achieved by embedding an ICF into the CoBF invite frame, by aggregating the ICF frame with the CoBF invite frame, or by making them one multi-purpose frame. In some examples, the poll message included in the CoBF invite may cause the shared AP 102-b to be polled to provide an indication of the availability of the shared AP 102-b and ensure that the shared AP 102-b is prepared to participate in the frame exchange.

In response to the CoBF invite frame, a CoBF Response may be transmitted by the shared AP 102-b, the wireless STA 104-b, or both. For example, the shared AP 102-b may transmit an ICR frame or a CoBF response frame that confirms the availability of the shared AP 102-b to participate in the frame exchange during the shared transmission opportunity. The ICR frame or the CoBF response frame may further include an indication of which STAs will be served by the AP 102-a. In some examples, the ICR or CoBF response frames may include a poll message that causes a STA 104 associated with the shared AP 102-b, such as the second wireless STA 104-b, to be polled to provide an indication of an availability of the second wireless STA 104-b to participate in the frame exchange. In some examples, the ICR or CoBF frame may further provide padding for link activation (such as for eMLSR) or switching to high capability mode (such as DPS). In some examples, this may be achieved by embedding an ICF into the CoBF invite frame, by aggregating the ICF frame with the CoBF invite frame, or by making them one multi-purpose frame. In some examples, the poll message included in the CoBF invite may cause the shared AP 102-b to be polled to provide an indication of an availability of the shared AP 102-b and to ensure that the shared AP 102-b is prepared to participate in the frame exchange.

The sharing AP 102-a may transmit a CoBF trigger/synchronization frame. The CoBF trigger/synchronization frame may be a frequency and time synchronization reference signal for the shared AP 102-b to use to coordinate a downlink PPDU transmission. In some examples, the CoBF trigger/synchronization frame may include information for generating a common preamble.

The sharing AP 102-a and the shared AP 102-b may transmit, during the shared transmission opportunity of the sharing AP 102-a, one or more coordinated downlink PPDU transmissions to the first wireless STA 104-a and the second wireless STA 104-b, respectively.

In response to receiving the one or more coordinated downlink PPDU transmissions, the first wireless STA 104-a or the second wireless STA 104-b or both may transmit, during the shared transmission opportunity, a first BA frame or a second BA frame or both acknowledging receipt of the one or more coordinated downlink PPDU transmissions.

FIG. 4 shows an example of a frame transmission sequence 400 associated with a CSR scheme. In some examples, the frame transmission sequence 400 may implement or be implemented by aspects of the wireless communication network 100 or the wireless environment 200 described with reference to FIGS. 1 and 2. For example, the frame transmission sequence 400 may include a CSR trigger frame, one or more BA frames, and one or more downlink PPDUs. The various frames and transmissions may be separated by one or more gaps 405. The frame transmission sequence 400 may be implemented by a sharing AP 102-a, a shared AP 102-b, a first wireless STA 104-a, a second wireless STA 104-b, or a combination thereof which may be examples of corresponding devices described herein with reference to FIGS. 1 and 2. The sharing AP 102-a may identify one or more shared transmission opportunities during which the sharing AP 102-a and the shared AP 102-b may simultaneously transmit communications to the wireless STA 104-a and wireless STA 104-b, respectively.

In some implementations, the sharing AP 102-a and the shared AP 102-b may support the CSR scheme. In such cases, the sharing AP 102-a and the shared AP 102-b may operate in accordance with one or more CSR operations. In some examples, there may be different variants of frame transmission sequences associated with the CSR scheme. In some examples, the different variants may differ with respect to how the sharing AP 102-a and the shared AP(s) 102-b estimate interference that the shared AP(s) 102-b may cause to the scheduled first wireless STA 104-a of the sharing AP 102-a, and how such interference may be controlled using an adjustment to transmit power at the shared AP(s) 102-b or by other means, such as STAs 104 scheduling where STAs 104 that are known to be more susceptible to interference are not scheduled during shared transmission opportunities.

In the example of a first variant, offline interference estimation 410 may be performed. In this implementation, interference estimation may be performed offline in the background by collecting RSSI reports (such as beacon reports including RSSI information) from associated wireless STAs 104 including RSSI information measured with respect to neighbor APs 102. The sharing AP 102-a may utilize the RSSI reports to estimate interference levels caused by neighbor APs 102 on its associated wireless STA 104. Each of the APs 102 may store an interference estimate value for each of its associated wireless STAs 104 per OBSS. Based on the estimates, the sharing AP 102-a may decide which other APs 102 to poll to share the shared transmission opportunity and how much transmit power backoff apply to minimize interference during the shared transmission opportunity. The sharing AP 102-a may signal, via the CSR trigger frame, the offline interference estimation 410 and the transmit power backoff amount to the shared AP 102-b.

The sharing AP 102-a and the shared AP 102-b may transmit, during the shared transmission opportunity of the first AP, one or more coordinated downlink PPDU transmissions to the first wireless STA 104-a and the second wireless STA 104-b, respectively.

In response to receiving the one or more coordinated downlink PPDU transmissions, the first wireless STA 104-a or the second wireless STA 104-b or both may transmit, during the shared transmission opportunity, a first BA frame or a second BA frame or both acknowledging receipt of the one or more coordinated downlink PPDU transmissions.

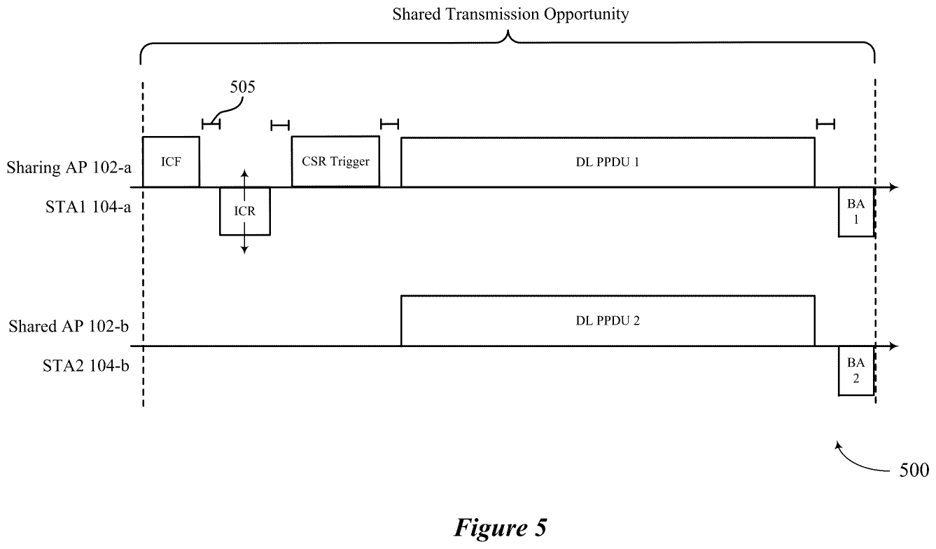

FIG. 5 shows an example of a frame transmission sequence 500 associated with a CSR scheme. In some examples, the frame transmission sequence 500 may implement or be implemented by aspects of the wireless communication network 100 or the wireless environment 200 described with reference to FIGS. 1 and 2. For example, the frame transmission sequence 500 may include an ICF frame, an ICR frame, a CSR trigger frame, one or more BA frames, and one or more downlink PPDUs. The various frames and transmissions may be separated by one or more gaps 505. The frame transmission sequence 500 may be implemented by a sharing AP 102-a, one or more shared APs 102-b, one or more first wireless STAs 104-a, one or more second wireless STAs 104-b, or a combination thereof which may be examples of corresponding devices described herein with reference to FIGS. 1 and 2. The sharing AP 102-a may identify one or more shared transmission opportunities during which the sharing AP 102-a and the shared AP 102-b may simultaneously transmit communications to the wireless STA 104-a and wireless STA 104-b, respectively.

In some implementations, the sharing AP 102-a and the shared AP 102-b may support the CSR scheme. In such cases, the sharing AP 102-a and the shared AP 102-b may operate in accordance with one or more CSR operations. In some examples, there may be different variants of frame transmission sequences associated with the CSR scheme. In some examples, the different variants may differ with respect to how the sharing AP 102-a and the shared AP 102-b estimate interference that the shared AP 102-b may cause to the scheduled first wireless STA 104-a of the sharing AP 102-a, and how such interference may be controlled using an adjustment to transmit power at the shared AP 102-b.

In the example of a second variant, dynamic interference estimation may be performed. In this implementation, interference estimation may be performed, within the shared transmission opportunity, by the sharing AP 102-a and the one or more shared APs 102-b dynamically based on received power measurements associated with an ICR frame sent by a scheduled wireless STA 104, such as the first wireless STA 104-a, of the sharing AP 102-a.

The sharing AP 102-a may measure received power (R₁) associated with the ICR transmitted by the first wireless STA 104-a. The sharing AP 102-a may transmit, to the shared AP 102-b, via the CRS trigger frame, an indication of the measured received power (R₁). The sharing AP 102-a may additionally transmit, to the shared AP 102-b, via the CSR trigger frame, an indication of one or more other CSR operational parameters, such as a threshold (such as a minimum) signal to interference ratio (SIR) accepted at the first wireless STA 104-a, a transmit power (T₁) associated with the sharing AP 102-a and used for transmission of a first DL PPDU 1. In some examples, the CSR trigger frame may include padding.

The shared AP 102-b may receive the CSR trigger frame and may use the measured received power to perform link-budget calculations to estimate the maximum allowable transmit power for the shared AP 102-b to transmit one or more coordinated downlink PPDU transmissions. In some examples, the shared AP 102-b also may monitor for the ICR transmitted by the first wireless STA 104-a and may itself measure the received power (R₂) associated with the ICR. The shared AP 102-b may calculate a threshold (such as maximum) transmit power (T₂) associated with the shared AP 102-b, where T₂=(T₁−IR)+R₁−R₂).

The sharing AP 102-a and the shared AP 102-b may transmit, during the shared transmission opportunity of the first AP, one or more coordinated downlink PPDU transmissions to the first wireless STA 104-a and the second wireless STA 104-b, respectively.

In response to receiving the one or more coordinated downlink PPDU transmissions, the first wireless STA 104-a or the second wireless STA 104-b or both may transmit, during the shared transmission opportunity, a first BA frame or a second BA frame or both acknowledging receipt of the one or more coordinated downlink PPDU transmissions.

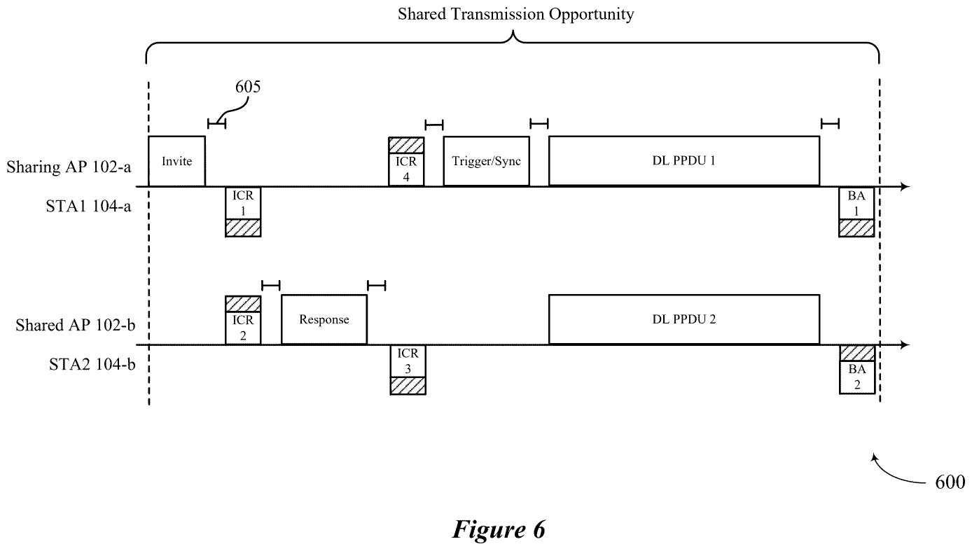

FIG. 6 shows an example of a unified frame transmission sequence 600 that supports techniques for a unified frame transmission sequence for CoBF and CSR. In some examples, the unified frame transmission sequence 600 may implement or be implemented by aspects of the wireless communication network 100, the wireless environment 200, the frame transmission sequences 300, 400, and 500 described with reference to FIGS. 1-5. For example, the unified frame transmission sequence 600 may include an invite frame, one or more ICR frames, a response frame, a trigger/synchronization frame, one or more BA frames, and one or more downlink PPDUs. The various frames and transmissions may be separated by one or more gaps 605. The unified frame transmission sequence 600 may be implemented by a sharing AP 102-a, one or more shared APs 102-b, one or more first wireless STAs 104-a, one or more second wireless STAs 104-b, or a combination thereof which may be examples of corresponding devices described herein with reference to FIGS. 1 through 5. The sharing AP 102-a may identify one or more shared transmission opportunities during which the sharing AP 102-a and the one or more shared APs 102-b may simultaneously transmit communications to the wireless STA 104-a and wireless STA 104-b, respectively.

In accordance with aspects described herein, a frame transmission sequence associated with the CoBF scheme (such as frame transmission sequence 300) and a second variant frame transmission sequence associated with the CSR scheme (such as frame transmission sequence 500) may be unified into a common frame transmission sequence, such as the unified frame transmission sequence 600. In some examples, the second variant frame transmission sequence associated with the CSR scheme may be a subset of the frame transmission sequence associated with a CoBF scheme. In the unified frame transmission sequence 600, the various frames may carry different information depending on which of the coordinated AP schemes the sharing AP 102-a and the sharing AP 102-a operate in accordance with.

For instance, the sharing AP 102-a may transmit an invite frame, and the shared AP 102-b may receive, during a shared transmission opportunity, the invite frame. The invite frame may indicate that the shared AP 102-b (and one or more wireless STAs 104) should operate in accordance with the unified frame transmission sequence 600, where the frame transmission sequence is associated with a first coordinated AP scheme, such as the CoBF AP scheme, or a second coordinated AP scheme, such as the CSR AP scheme. For example, the invite frame may indicate which of the first coordinated AP scheme or the second coordinated AP scheme the sharing AP 102-a and the shared AP 102-b should operate in accordance with.

When the sharing AP 102-a and the shared AP 102-b operate in accordance with the CoBF scheme, the invite frame may include an invitation to the shared AP 102-b to perform a CoBF operation (such as to participate in the frame exchange in accordance with the CoBF scheme) and may additionally include information associated with one or more wireless STAs 104 scheduled by the sharing AP 102-a, such as the first wireless STA 104-a. In some instances, the invite frame may act as an ICF to poll the one or more first wireless STAs 104-a and prepare the one or more first wireless STAs 104-a for further frame exchanges. For example, the invite frame may include a poll message that causes the one or more first wireless STAs 104-a to be polled. In some instances, the poll message included in the invite frame may additionally poll the shared AP 102-b to determine an availability of the shared AP 102-b for a frame exchange in accordance with the CoBF scheme.

When the sharing AP 102-a and the shared AP 102-b operate in accordance with the CSR scheme, the invite frame may include an invitation to one or more shared APs 102-b to perform a CSR operation (such as to participate in the frame exchange in accordance with the CRS scheme) and may additionally act as an ICF to poll the first wireless STA 104-a to respond with an ICR indicating availability of the first wireless STA 104-a for the frame exchange in accordance with the CSR scheme. In some examples, the invite may include padding. In the case of the CSR scheme, the invite frame may not be enabled to poll a response frame from the shared AP 102-b because the shared AP 102-b may be engaged in monitoring for an ICR (such as a first ICR1) transmitted by the first wireless STA 104-a in order to measure its received power.

After sending the invite frame, the sharing AP 102-a and the shared AP 102-b may communicate a plurality of frames within the shared transmission opportunity and in accordance with the frame transmission sequence. For instance, in response to the invitation to participate in the frame exchange, one or more ICR frames or responses may be transmitted by the shared AP 102-b and the first wireless STA 104-a.

For example, in response to the poll message included in the invite frame, the first wireless STA 104-a may transmit, and the sharing AP 102-a may receive, a first ICR1 frame.

When the sharing AP 102-a and the shared AP 102-b operate in accordance with the CoBF scheme, the first ICR1 frame may include an indication confirming an availability of the first wireless STA 104-a to participate in further frame exchanges with the sharing AP 102-a. When operating in accordance with the CoBF scheme, the first ICR1 frame may be transmitted in TB PPDU format in the case that multiple wireless STAs 104 are scheduled by the sharing AP 102-a or in the case that a response frame from the shared AP 102-b is polled by the invite frame. Otherwise, the first ICR1 frame may be transmitted in non-TB PPDU format.

When the sharing AP 102-a and the shared AP 102-b operate in accordance with the CSR scheme, the first ICR1 frame may be monitored by both the sharing AP 102-a and the shared AP 102-b to measure a received power associated with the first ICR1 frame. For instance, the sharing AP 102-a may measure the received power of the first ICR1 frame as R₁ and the shared AP 102-b may measure the received power of the first ICR1 frame as R₂. When operating in accordance with the CSR scheme, the first ICR1 frame may be transmitted in TB PPDU format in the case that multiple wireless STAs 104 are scheduled by the sharing AP 102-a. Otherwise, the first ICR1 frame may be transmitted in non-TB PPDU format.

Further, in response to the invite frame the shared AP 102-b may transmit, and the sharing AP 102-a may receive, a second ICR2 frame.

When the sharing AP 102-a and the shared AP 102-b operate in accordance with the CoBF scheme, the second ICR2 frame may include an indication confirming an availability of the shared AP 102-b to participate in further frame exchanges with the sharing AP 102-a and may prepare the shared AP 102-b for the further frame exchanges. In some examples, if solicited, the second ICR2 frame may provide easier shared transmit opportunity recovery for the sharing AP 102-a in the event the shared AP 102-b is unavailable or unresponsive. Otherwise, the sharing AP 102-a may have to wait for a response frame and then reclaim medium (such as channel) access a Point coordination function (PCF) interframe space (PIFS) after reception of the first ICR1 frame. Transmission of the second ICR2 frame in the unified frame transmission sequence 600 may be optional in the CoBF scheme.

When the sharing AP 102-a and the shared AP 102-b operate in accordance with the CSR scheme, the second ICR2 frame might not be included (such as is not included) in the unified frame transmission sequence 600 because the shared AP 102-b may be engaged in monitoring for the first ICR1 frame transmitted by the first wireless STA 104-a in order to measure its received power.

In some examples, after sending the invite frame, the shared AP 102-b may transmit, and the sharing AP 102-a may receive, a response frame.

When the sharing AP 102-a and the shared AP 102-b operate in accordance with the CoBF scheme, the response frame may include an indication of acceptance of the invitation to participate in the further frame exchange. In some examples, the response frame may additionally include information associated with the second wireless STA 104-b scheduled by the shared AP 102-b. In some examples, the response frame may additionally act as an ICF to poll the second wireless STA 104-b to respond with an ICR indicating availability of the second wireless STA 104-b for the frame exchange in accordance with the CSR scheme and also to prepare the second wireless STA 104-b for the frame exchange in accordance with the CSR scheme. For instance, the response frame may include a poll message that causes the second wireless STA 104-b to be polled.

When the sharing AP 102-a and the shared AP 102-b operate in accordance with the CSR scheme, the response frame may optionally be included in the unified frame transmission sequence 600. In some examples, the response frame may be used by the shared AP 102-b to poll the second wireless STA 104-b to ensure its availability and prepare the second wireless STA 104-b for further frame exchanges, such as for UHR wireless STAs 104 (such as to notify the UHR wireless STAs 104 to follow an extended timeout duration before deactivating a eMLSR link, as in switching from active to listen modes on that link). For instance, the response frame may include a poll message that polls a response frame from the second wireless STA 104-b.

When operating in accordance with the CSR scheme with multiple shared APs 102-b an overlap between the response frames from the multiple shared APs 102-b may occur (as well as overlapping ICRs from the STAs 104-b associated APs 102-b). To resolve this, in one implementation, the sharing AP 102-a may specify only one shared AP 102-b that is allowed to transmit a response frame and from which an ICR frame from its associated wireless STAs 104-b may be received. In another implementation, the sharing AP 102-a may allow up to all shared APs 102-b to transmit response frames and to receive ICR responses from their associated wireless STAs 104-b. In this implementation the overlapping response frames transmitted by all shared APs 102-b might not all be successfully decoded at their respective wireless STAs 104. This may act to manage, reduce, or limit interference among the shared APs 102-b and their associated STAs 104-b. To ensure that the sharing AP 102-a is able to send the trigger/synchronization frame at the correct time, the fourth ICR4 frame transmitted after the response frame sent might not be optional in some cases. By having the fourth ICR4 frame, the trigger/synchronization frame may be received a short interframe space (SIFS) after this ICR frame. The sharing AP 102-a may specify in the invite frame a duration of the response frame so that the sharing AP 102-a may calculate when to send the fourth ICR4 frame without relying on successful reception of the overlapping response frames.

In some implementations, an eMLSR-supporting frame transmission sequence for the CoBF scheme may be used when operating in accordance with the CSR scheme. While in some cases, overhead may result from the response frame and its solicited ICR frame, the response frame and its solicited ICR frames may be useful in the case that the shared AP 102-b wants to schedule eMLSR or DPS wireless STA 104 with the CSR shared transmission opportunity.

In response to the response frame or the poll message included therein, the second wireless STA 104-b may transmit, and the shared AP 102-b may receive, a third ICR3 frame.

When the sharing AP 102-a and the shared AP 102-b operate in accordance with the CoBF scheme, the third ICR3 frame may include an indication confirming an availability of the second wireless STA 104-b to participate in further frame exchanges with the shared AP 102-b.

When the sharing AP 102-a and the shared AP 102-b operate in accordance with the CSR scheme, the third ICR3 frame may optionally be included in the unified frame transmission sequence 600, as the third ICR3 frame might be considered overhead. In some examples, however, the third ICR3 frame may be used by the shared AP 102-b to poll the second wireless STA 104-b to ensure its availability and prepare it for further frame exchanges (such as eMLSR/DPS), such as for UHR wireless STAs 104. For instance, the response frame may include a poll message that causes the second wireless STA 104-b to be polled.

In some examples, in response to the response frame or after receiving the response frame, the sharing AP 102-a may transmit, and the shared AP 102-b may receive, a fourth ICR4 frame.

When the sharing AP 102-a and the shared AP 102-b operate in accordance with the CoBF scheme, the fourth ICR4 frame may include an indication of an unavailability of the first wireless STA 104-a. The shared AP 102-b may use the indication of unavailability to refrain from applying beam nulling or to terminate the shared transmission opportunity. Transmission of the fourth ICR4 frame in the unified frame transmission sequence 600 may be optional in the CoBF scheme.

When the sharing AP 102-a and the shared AP 102-b operate in accordance with the CSR scheme, the fourth ICR4 frame might not be included in the unified frame transmission sequence 600 (unless multiple shared APs 102-b are sending response frames) as the fourth ICR4 frame may be considered overhead.

After receipt of the first response frame, the sharing AP 102-a may transmit, and the shared AP 102-b may receive, a trigger/synchronization frame.

When the sharing AP 102-a and the shared AP 102-b operate in accordance with the CoBF scheme, the trigger/synchronization frame may act as a frequency and time synchronization reference signal. The shared AP 102-b may use the frequency and time synchronization reference signal when transmitting the downlink PPDU transmission. In some examples, the trigger/synchronization frame may include additional information for generation of a common preamble.

When the sharing AP 102-a and the shared AP 102-b operate in accordance with the CSR scheme, the trigger/synchronization frame may include an indication of whether the one or more shared APs 102-b agreed to participate (or not participate) in the further frame exchanges by sending an updated list of shared APs 102-b that have accepted the CSR invitation. The trigger/synchronization frame also may include the received power (R₁) associated with the first ICR1 frame as measured by the sharing AP 102-a, the transmit power (T₁) associated with the sharing AP 102-a, the SIR threshold accepted at the first wireless STA 104-a, (or a difference therebetween, such as T₁−SIR), a start time and end time associated with transmission of a coordinated downlink PPDU transmission, or any combination thereof. In some examples, the trigger/synchronization frame may act as a frequency and time reference frame and may be used by the shared AP 102-b for frequency and time synchronization. In some examples, the trigger/synchronization frame may provide BA RU allocation for each BSS and may provide padding.

Responsive to communication of the various frames, the sharing AP 102-a and the shared AP 102-b may coordinate transmission, within the shared transmission opportunity, of one or more coordinated downlink PPDU transmissions to the first wireless STA 104-a and the second wireless STA 104-b, respectively. In some examples, the one or more coordinated downlink PPDU transmissions are transmitted in accordance with the frequency and time synchronization reference signal included in the trigger/synchronization frame.

In response to receiving the one or more coordinated downlink PPDU transmissions, the first wireless STA 104-a or the second wireless STA 104-b or both may transmit, during the shared transmission opportunity, a first BA frame or a second BA frame or both acknowledging receipt of the one or more coordinated downlink PPDU transmissions.

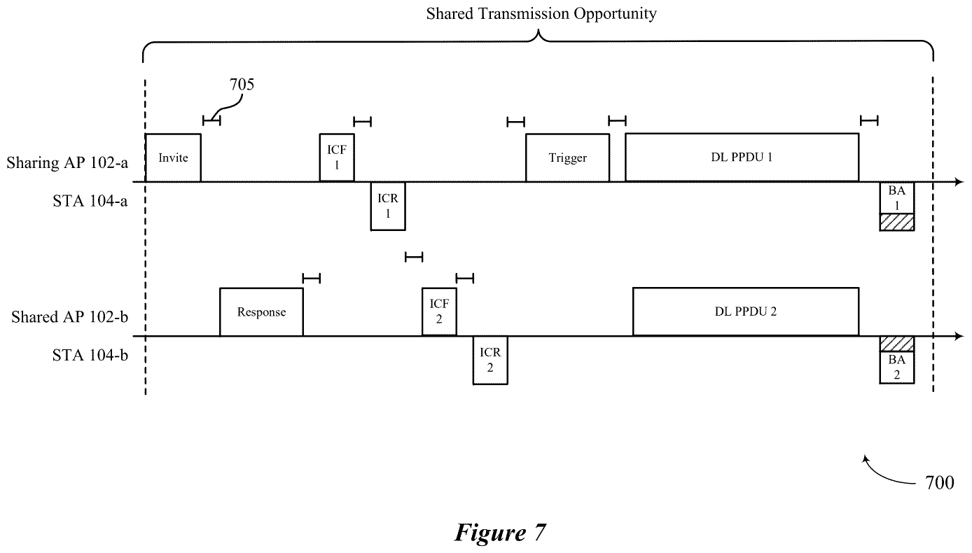

FIG. 7 shows an example of a unified frame transmission sequence 700 that supports techniques for a unified frame transmission sequence for CoBF and CSR. In some examples, the unified frame transmission sequence 700 may implement or be implemented by aspects of the wireless communication network 100, the wireless environment 200, the frame transmission sequences 300, 400, 500, and 700 described with reference to FIGS. 1-6, or any combination thereof. For example, the unified frame transmission sequence 700 may include an invite frame, one or more ICR frames, a response frame, a trigger/synchronization frame, one or more BA frames, and one or more downlink PPDUs. The various frames and transmissions may be separated by one or more gaps 705. The unified frame transmission sequence 700 may be implemented by a sharing AP 102-a, one or more shared APs 102-b, one or more first wireless STAs 104-a, one or more second wireless STAs 104-b, or a combination thereof which may be examples of corresponding devices described herein with reference to FIGS. 1 through 6. The sharing AP 102-a may identify one or more shared transmission opportunities during which the sharing AP 102-a and the one or more shared APs 102-b may simultaneously transmit communications to the wireless STA 104-a and wireless STA 104-b, respectively.

In accordance with aspects described herein, a frame transmission sequence associated with the CoBF scheme (such as frame transmission sequence 300) and a second variant frame transmission sequence associated with the CSR scheme (such as frame transmission sequence 500) may be unified into a common frame transmission sequence, such as the unified frame transmission sequence 700. In some examples, the second variant frame transmission sequence associated with the CSR scheme may be a subset of the frame transmission sequence associated with a CoBF scheme. In the unified frame transmission sequence 700, the various frames may carry different information depending on which of the coordinated AP schemes the sharing AP 102-a and the sharing AP 102-a operate in accordance with.

For instance, the sharing AP 102-a may transmit an invite frame, and the shared AP 102-b may receive, during a shared transmission opportunity, the invite frame. The invite frame may indicate that the shared AP 102-b (and one or more wireless STAs 104) may operate in accordance with the unified frame transmission sequence 700, where the frame transmission sequence is associated with a first coordinated AP scheme, such as the CoBF AP scheme, a second coordinated AP scheme, such as the CSR AP scheme, or other coordinated AP schemes. For example, the invite frame may indicate to operate in accordance with the first coordinated AP scheme and the second coordinated AP scheme.

When the sharing AP 102-a and the shared AP 102-b operate in accordance with the CoBF scheme, the invite frame may include an invitation to the shared AP 102-b to perform a CoBF operation (such as to participate in the frame exchange in accordance with the CoBF scheme) and may additionally include information associated with one or more wireless STAs 104 scheduled by the sharing AP 102-a, such as the first wireless STA 104-a.

When the sharing AP 102-a and the shared AP 102-b operate in accordance with the CSR scheme, the invite frame may be used for the following purposes. For example, invite frame may invite an initial set of candidate shared APs 102-b to participate in a CSR shared transmission opportunity (TXOP), and the invite frame may provide an early indication to candidate shared APs 102-b to be prepared for monitoring the ICR response from the first wireless STAs 104-a of the sharing AP 102-a and measuring a received RSSI of the ICR. As such, the invite frame may include an invitation to one or more shared APs 102-b to perform a CSR operation (such as to participate in the frame exchange in accordance with the CRS scheme). In some examples, the invite may include padding. In the example of the CSR scheme, the invite frame may not be enabled to poll a response frame from the shared AP 102-b because the shared AP 102-b may be engaged in monitoring for an ICR (such as a first ICR1) transmitted by the first wireless STA 104-a in order to measure its received power. The invite frame may additionally provide an indication to the shared AP 102-b to prepare to monitor for one or more ICRs in accordance with the unified frame transmission sequence 700. In such examples, when the CSR scheme is a subset of the CoBF scheme, the CSR scheme may include a single shared AP 102-b (such as when following a CoBF operation includes a single shared AP 102-b). To enable multiple shared APs 102-b to participate in the CSR operation, the invite frame may solicit one or more response frames from the candidate shared APs 102-b, which may be sent simultaneously according to a TB PPDU format. To relatively decrease instances where the shared APs 102-b may become out of sync (such as sending overlapping transmissions) the invite frame may indicate a total quantity of shared APs 102-b to be included in the CSR TXOP and indicate an assigned order for each of the candidate shared APs 102-b (such as within the unified frame transmission sequence 700). In some examples, the order may be used by each of the candidate shared APs 102-b to determine when to transmit one or more respective ICF/ICR frame exchanges with one or more respective scheduled clients (such as the ICF/ICR frame exchanges between each of the sharing APs 102-a and the shared APs 102-b and the respective clients may be staggered in time).

In some examples, after sending the invite frame, the shared AP 102-b may transmit, and the sharing AP 102-a may receive, a response frame.

When the sharing AP 102-a and the shared AP 102-b operate in accordance with the CoBF scheme, the response frame may include an indication of acceptance of the invitation to participate in the further frame exchange. In some examples, the response frame may additionally include information associated with the second wireless STA 104-b scheduled by the shared AP 102-b.

When the sharing AP 102-a and the shared AP 102-b operate in accordance with the CSR scheme, the response frame may optionally be included in the unified frame transmission sequence 700.

In some examples, a RU allocation for each candidate shared AP 102 may be indicated in the invite frame (such as for BA transmission in the CoBF scheme, the CSR scheme, or both).

When operating in accordance with the CSR scheme with multiple shared APs 102-b an overlap between the response frames from the multiple shared APs 102-b may occur. To resolve this, each of the shared APs 102-b may be triggered to send the response frames in an OFDMA mode according to the TB PPDU format.

After receipt of the response frame, the sharing AP 102-a may transmit, and the one or more first wireless STAs 104-a may receive, a first ICF1.

When the sharing AP 102-a and the shared AP 102-b operate in accordance with the CoBF scheme, the first ICF1 may poll the one or more first wireless STAs 104-a and prepare the one or more first wireless STAs 104-a for further frame exchanges. For example, the first ICF1 may include a poll message that causes the one or more first wireless STAs 104-a to be polled.

When the sharing AP 102-a and the shared AP 102-b operate in accordance with the CSR scheme, the first ICF1 may poll the first wireless STA 104-a to respond with an ICR indicating availability of the first wireless STA 104-a for the frame exchange in accordance with the CSR scheme (such as the sharing AP 102-a may transmit the first ICF1 to solicit an ICR from the first wireless STA 104-a). In some examples, the first ICF1 may include padding. In the case of the CSR scheme, the first ICF1 may not be enabled to poll a response frame from the shared AP 102-b because the shared AP 102-b may be engaged in monitoring for an ICR (such as a first ICR1) transmitted by the first wireless STA 104-a in order to measure its received power. That is, the first ICF1 may solicit an ICR response from the first wireless STA 104-a (such as STA1) based on which RSSI measurements are made (such as by the sharing AP 102-a, the shared AP 102-b, or both) which may be utilized for a shared AP 102-b transmission power calculation.

In response to the first ICF1, the first wireless STA 104-a may transmit, and the sharing AP 102-a, the shared AP 102-b, or both may receive, a first ICR1 frame.

When the sharing AP 102-a and the shared AP 102-b operate in accordance with the CoBF scheme, the first ICR1 frame may include an indication confirming an availability of the first wireless STA 104-a to participate in further frame exchanges with the sharing AP 102-a. When operating in accordance with the CoBF scheme, the first ICR1 frame may be transmitted in TB PPDU format in the case that multiple wireless STAs 104 are scheduled by the sharing AP 102-a. Otherwise, the first ICR1 frame may be transmitted in non-TB PPDU format.

When the sharing AP 102-a and the shared AP 102-b operate in accordance with the CSR scheme, the first ICR1 frame may be monitored by both the sharing AP 102-a and the shared AP 102-b to measure a received power associated with the first ICR1 frame. For instance, the sharing AP 102-a may measure the received power of the first ICR1 frame as R₁ and the shared AP 102-b may measure the received power of the first ICR1 frame as R₂. When operating in accordance with the CSR scheme, the first ICR1 frame may be transmitted in TB PPDU format in the case that multiple wireless STAs 104 are scheduled by the sharing AP 102-a. Otherwise, the first ICR1 frame may be transmitted in non-TB PPDU format.

After receipt of the first ICR1, the shared AP 102-b may transmit, and the one or more second wireless STAs 104-b may receive, a second ICF2.

When the sharing AP 102-a and the shared AP 102-b operate in accordance with the CoBF scheme, the second ICF2 may poll the one or more second wireless STAs 104-b and prepare the one or more second wireless STAs 104-b for further frame exchanges. For example, the second ICF2 may include a poll message that causes the one or more second wireless STAs 104-b to be polled.

When the sharing AP 102-a and the shared AP 102-b operate in accordance with the CSR scheme, the second ICF2 may be utilized to poll a client (such as the second wireless STA 104-b, or STA2) to confirm an availability of the second wireless STA 104-b and to prepare the second wireless STA 104-b for further frame exchanges (such as in the cases of eMLSR or DPS clients for UHR clients to notify the UHR wireless STAs 104 to follow an extended timeout duration before deactivating an eMLSR link, as in switching from active to listen modes on that link). The second ICF2 may poll the second wireless STA 104-b to respond with an ICR indicating availability of the second wireless STA 104-b for the frame exchange in accordance with the CSR scheme (such as the shared AP 102-b may transmit the second ICF2 to solicit an ICR from the second wireless STA 104-b). In some examples, the second ICF2 may include padding.

When the sharing AP 102-a and the shared AP 102-b operate in accordance with the CoBF scheme, the second ICR2 frame may include an indication confirming an availability of the shared AP 102-b to participate in further frame exchanges with the sharing AP 102-a and may prepare the shared AP 102-b for the further frame exchanges.

When the sharing AP 102-a and the shared AP 102-b operate in accordance with the CSR scheme, the second ICF2 may be used by the shared AP 102-b to poll the second wireless STA 104-b to confirm its availability and prepare the second wireless STA 104-b for further frame exchanges, such as for UHR wireless STAs 104 (such as to notify the UHR wireless STAs 104 to follow an extended timeout duration before deactivating an eMLSR link, as in switching from active to listen modes on that link). For instance, the second ICF2 may include a poll message that polls a second ICR2 from the second wireless STA 104-b. In such cases, the second ICR2 may confirm the availability of the second wireless STA 104-b (such as STA2) for further frame exchanges. In some examples, the ICR and ICF frames (such as ICF1, ICF2, ICR1, ICR2) may be transmitted in a non-OFDMA mode. In some examples, the ICR frames (such as ICR1, ICR2) may be transmitted in an OFDMA mode when multiple STAs are triggered by an ICF at the same time (such as ICRs are triggered for transmission at a same time but in different RUs and may include different information).

After receipt of the first ICR1 or the second ICR2 (such as where an ICF-ICR frame exchange was performed between the shared AP 102-b and its STA 104-b), the sharing AP 102-a may transmit, and the shared AP 102-b may receive, a trigger/synchronization frame. The shared AP 102-b may indicate in the Response frame whether shared AP 102-b will do an ICF-ICR frame exchange with its associated STA 104-b or not.

When the sharing AP 102-a and the shared AP 102-b operate in accordance with the CoBF scheme, the trigger/synchronization frame may act as a frequency and time synchronization reference signal. The shared AP 102-b may use the frequency and time synchronization reference signal when transmitting the downlink PPDU transmission. In some examples, the trigger/synchronization frame may include additional information for generation of a common preamble.

When the sharing AP 102-a and the shared AP 102-b operate in accordance with the CSR scheme, the trigger/synchronization frame may include an indication of whether the one or more shared APs 102-b agreed to participate (or not participate) in the further frame exchanges by sending an updated list of shared APs 102-b that have accepted the CSR invitation. That is, the trigger/synchronization frame may indicate a decision of the shared AP 102-b (such as a shared AP 102-b choice, or an acceptance or a rejection). The trigger/synchronization frame also may include the received power (R₁) associated with the first ICR1 frame as measured by the sharing AP 102-a, the transmit power (T₁) associated with the sharing AP 102-a, the SIR threshold accepted at the first wireless STA 104-a, (or a difference therebetween, such as T₁−SIR), a start time and end time associated with transmission of a coordinated downlink PPDU transmission, or any combination thereof. In some examples, the trigger/synchronization frame may act as a frequency and time reference frame and may be used by the shared AP 102-b for frequency and time synchronization. In some examples, the trigger/synchronization frame may provide BA RU allocation for each BSS and may provide padding. In some examples, the trigger/synchronization frame may include additional information for generation of a common preamble in the DL PPDUs.

In the example of a first variant of the CSR scheme further described herein with reference to FIG. 4, offline interference estimation may be performed. In this implementation, interference estimation may be performed offline in the background by collecting RSSI reports (such as beacon reports including RSSI information) from associated wireless STAs 104 including RSSI information measured with respect to neighbor APs 102. The sharing AP 102-a may utilize the RSSI reports to estimate interference levels caused by neighbor APs 102 on its associated wireless STA 104. Each of the APs 102 may store an interference estimate value for each of its associated wireless STAs 104 per OBSS. Based on the estimates, the sharing AP 102-a may decide which other APs 102 to poll to share the shared transmission opportunity and how much transmit power backoff may be applied to minimize interference during the shared transmission opportunity. The sharing AP 102-a may signal, via the CSR trigger frame, the offline interference estimation and the transmit power backoff amount to the shared AP 102-b. The first variant of the CSR scheme may be supported by the frame sequence described herein since the first variant of the CSR scheme utilizes a trigger frame, which is present in the frame sequence described herein. The additional frames of the sequence (such as frames other than the trigger frame, such as the first ICF1, the second ICF2, and the like) may incur additional overhead for the first variant of the CSR scheme.

Responsive to communication of the various frames, the sharing AP 102-a and the shared AP 102-b may coordinate transmission, within the shared transmission opportunity, of one or more coordinated downlink PPDU transmissions to the first wireless STA 104-a and the second wireless STA 104-b, respectively. In some examples, the one or more coordinated downlink PPDU transmissions are transmitted in accordance with the frequency and time synchronization reference signal included in the trigger/synchronization frame.

In response to receiving the one or more coordinated downlink PPDU transmissions, the first wireless STA 104-a or the second wireless STA 104-b or both may transmit, during the shared transmission opportunity, a first BA frame or a second BA frame or both acknowledging receipt of the one or more coordinated downlink PPDU transmissions.

In some examples, eMLSR (such as legacy eMLSR) clients may be unsupported by this CSR sequence because the sequence may include silent periods after the ICF/ICR exchanges between the sharing APs 102-a and shared APs 102-b and their associated clients (such as the unified frame transmission sequence 700 may support UHR clients to notify the clients to follow the extended timeout duration before deactivating the eMLSR link). In some examples, eMLSR clients may be supported. For example, an alternative eMLSR-supporting transmission sequence for CoBF may be used for CSR (such as with some overhead). The overhead may be incurred from the invite and response frames, and ICF/ICR frame exchanges performed between the sharing AP 102-a and shared APs 102-b, and the respective clients, respectively.

FIG. 8 shows an example of a sounding sequence scheme 800 that supports operating state transitions in overlapping basic service sets. In some examples, the sounding sequence scheme 800 may implement aspects of the wireless communications system 100 and the wireless environment 200. For example, the sounding sequence scheme 800 includes a first AP 102-a, a second AP 102-b, a first STA 104-a, a second STA 104-b, which may be examples of the corresponding devices described with reference to FIG. 1. One or more frames of the sounding sequence scheme 800 may be separated by one or more gaps 805. In some examples, operations in the sounding sequence scheme 800 may include additional features not mentioned below, or further steps may be added. Additionally, or alternatively, while two APs 102 and two STAs 104 are shown in the sounding sequence scheme 800, more devices may be possible and the examples shown should not be construed as limiting.

The first AP 102-a and the second AP 102-b may be associated with a first BSS and a second BSS, respectively, where each BSS includes one or more STAs 104. For example, the first BSS may include one or more devices within a first coverage area 108 (such as the first AP 102-a, the STA 104-a, the STA 104-b, and one or more other STAs 104). Similarly, the second BSS may include one or more devices within a second coverage area 108 (such as the second AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b. In some examples, the first AP 102-a may be a sharing AP and the second AP 102-b may be a shared AP, as discussed with reference to FIG. 1.

The devices in the sounding sequence scheme 800 may support a sequential channel sounding sequence. The techniques described herein also may extend to joint channel sounding, as described in more detail with reference to FIG. 9. In some implementations, the first AP 102-a and the second AP 102-b may collect CSI from each BSS in the OBSS. For example, the first AP 102-a may collect CSI associated with a first channel (which may be referred to as a channel link) between the first STA 104-a and the first AP 102-a, and/or collect CSI associated with a second channel between the first STA 104-a and the second AP 102-b. Similarly, the second AP 102-b may collect CSI associated with a third channel between the second STA 104-b and the second AP 102-b, and/or collect CSI associated with a fourth channel between the second STA 104-b and the first AP 102-a.

In some examples, the first AP 102-a may perform a channel sounding sequence. For example, the first AP 102-a may transmit a NDPA to announce to the client (such as the first STA 104-a) that the first AP 102-a will send an NDP that the client is to use to estimate the channel response. The first AP 102-a may subsequently transmit the NDP and a BFRP to pull the CSI from the client. The CSI may describe a first channel between the first STA 104-a and the first AP 102-a. After the first CSI transmission by the first STA 104-a, the first AP 102-a may transmit a second NDPA to the first STA 104-a on behalf of the second AP 102-b (such as the channel sounding sequence may be transparent to the client, such that the first STA 104-a does not know that a second CSI will be with respect to an AP 102 that is not the AP 102 associated with the first STA 104-a). For example, the second NDPA frame may indicate, to the first STA 104-a, that the second AP 102-b is to transmit an NDP frame that the first STA 104-a is to use to estimate a second channel between the first STA 104-a and the second AP 102-b. After a second BFRP frame from the first AP 102-a, the first STA 104-a may transmit the second CSI.

The second half of the measurement phase may mirror the first half of the measurement phase, but performed by the second AP 102-b (such as an OBSS AP) and the second STA 104-b associated with the second BSS. For example, the second AP 102-b may transmit a third NDPA, followed by transmission of a third NDP. After receiving a third BFRP, the second STA 104-b may transmit, to the second AP 102-b, third CSI associated with a third channel between the second AP 102-b and the second STA 104-b. The second AP 102-b may transmit a fourth NDPA to the second STA 104-b. The first AP 102-a may transmit, to the second STA 104-b, a fourth NDP that the second STA 104-b is to use to estimate a fourth channel between the first AP 102-a and the second STA 104-b. After receiving a fourth BFRP from the second AP 102-b, the second STA 104-b may transmit fourth CSI associated with the fourth channel between the first AP 102-a and the second STA 104-b.

Each frame in the sounding sequence scheme 800 (and in other signaling diagrams described herein) may be separated in time from neighboring frames by a short interframe space (SIFS) (such as a delay in microseconds) such as the one or more gaps 805. However, the sounding sequence for the first BSS and the second BSS can be separated in two different TXOPs or more without any constraints on time separation between the CSI frame and the ICF frame.

As a result of the measurement phase illustrated by the sounding sequence scheme 800, the first AP 102-a may have the CSI associated with the first channel between the first AP 102-a and the first STA 104-a and the CSI associated with the second channel between the second AP 102-b and the first STA 104-a. Similarly, the second AP 102-b may have the CSI (such as associated with the third channel between the second AP 102-b and the second STA 104-b) and the CSI (such as associated with the fourth channel between the first AP 102-a and the second STA 104-b). Thus, the devices in the sounding sequence scheme 800 may perform CBF channel sounding in an OBSS.

As a reminder, the AP 102-a may transmit, to a set of one or more STAs 104 associated with the first AP 102-a, one or more frames during the first channel sounding procedure (such as the NDPA, the NDP, and the BFRP). The AP 102-a may trigger the second AP 102-b to transmit, to the set of one or more STAs 104 associated with the first AP 102-a (such as including the STA 104-a), one or more frames during the first channel sounding procedure (such as the NDP). The AP 102-a may receive, from the set of one or more STAs associated with the first AP 102-a, a CSI frame (such as the CSI, the CSI, or both).

FIG. 9 shows an example of a frame transmission sequence 900 that supports operating state transitions in overlapping basic service sets. In some examples, the frame transmission sequence 900 may implement aspects of the wireless communications system 100 and the wireless environment 200. For example, the frame transmission sequence 900 includes a first AP 102-a, a second AP 102-b, a first STA 104-a, a second STA 104-b, which may be examples of the corresponding devices described with reference to FIG. 1. One or more frames of the frame transmission sequence 900 may be separated by one or more gaps 905. In some examples, steps in the frame transmission sequence 900 may include additional features not mentioned below, or further steps may be added. Additionally, or alternatively, while two APs 102 and two STAs 104 are shown in the frame transmission sequence 900, more devices may be possible and the examples shown should not be construed as limiting.

The first AP 102-a and the second AP 102-b may be associated with a first BSS and a second BSS, respectively, where each BSS includes one or more STAs 104. For example, the first BSS may include one or more devices within a first coverage area 108 (such as the first AP 102-a, the STA 104-a, the STA 104-b, and one or more other STAs 104). Similarly, the second BSS may include one or more devices within a second coverage area 108 (such as the second AP 102-b, the STA 104-a, the STA 104-b, and one or more other STAs 104). The STAs 104 may be connected to the first AP 102-a, the second AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the first AP 102-a and the second AP 102-b. In some examples, the first AP 102-a may be a sharing AP and the second AP 102-b may be a shared AP, as discussed with reference to FIG. 1.

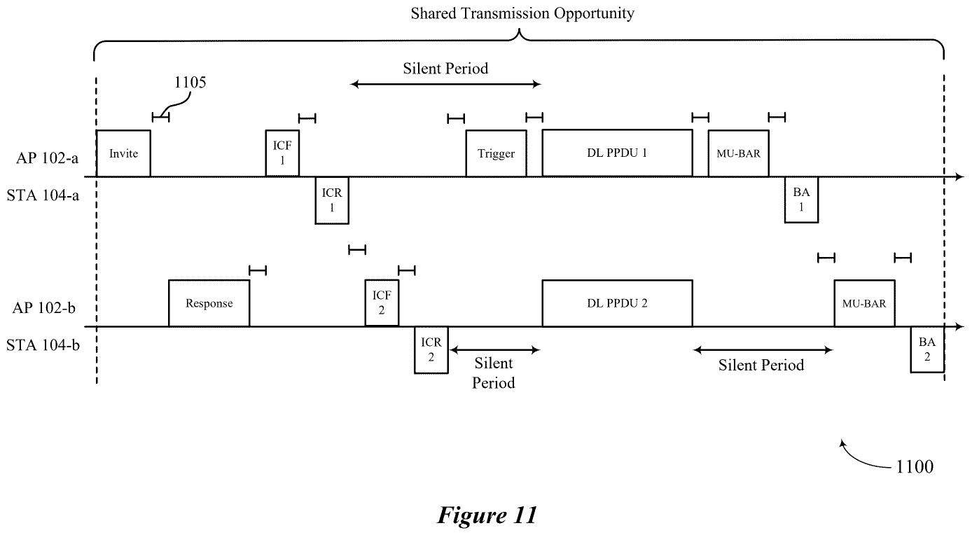

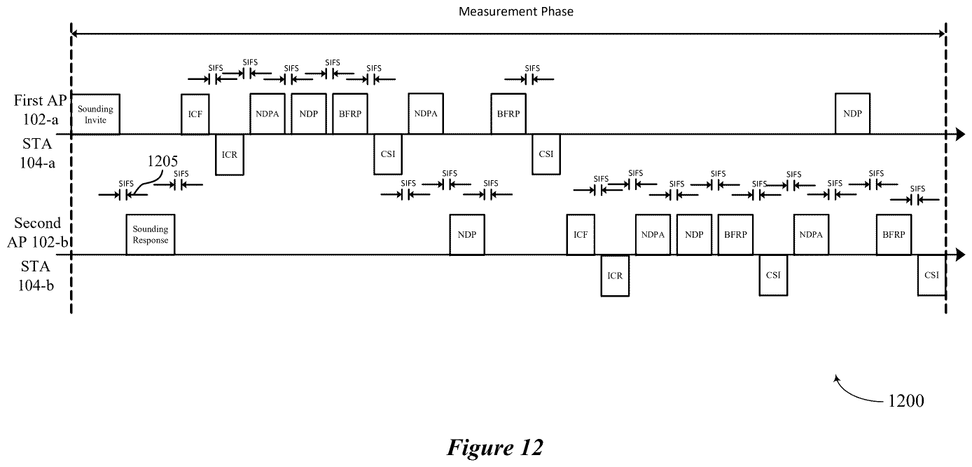

The frame transmission sequence 900 may include the agreement establishment phase, the sounding phase (such as a measurement phase), and the transmission phase. In some examples, the sounding phase may be one of the sounding phases (such as measurement phases) further described herein with reference to one or more of FIG. 8, FIG. 9, FIG. 12, FIG. 14 or FIG. 15, and the transmission phase may be one of the transmission phases further described herein with reference to FIGS. 3-7, FIG. 10, or FIG. 11.

In some examples, during the agreement establishment phase, the first AP 102-a and the second AP 102-b may exchange one or more messages indicating or including a first set of parameters and a second set of parameters, which are further defined herein with reference to FIG. 2. In some examples, the first AP 102-a and the second AP 102-b may perform the sounding phase, the transmission phase, or both in accordance with the first set of parameters and the second set of parameters (such as performing the sounding phase, the transmission phase, or both in accordance with the one or more messages exchanged during the agreement establishment phase).

While the sounding sequence scheme 800 illustrates an example of sequential CBF channel sounding, the frame transmission sequence 900 illustrates an example of joint CBF channel sounding. For example, devices in the frame transmission sequence 900 may perform the CBF sounding process in a more efficient way than illustrated in the sounding sequence scheme 800 by performing the CSI estimation to the associated AP 102-a as well as the OBSS AP 102-b simultaneously. The joint CBF channel sounding sequence of the frame transmission sequence 900 may be similar to the sequential CBF channel sounding sequence of the sounding sequence scheme 800, except that one or more NDP frames may be sent jointly (such as in parallel, simultaneously) by both the first AP 102-a and the second AP 102-b at the same time (such as where CSI estimation to the two APs 102 can be done using a separate set of LTFs). The joint channel sounding sequence of the frame transmission sequence 900 may save up to three frame exchanges per AP 102 compared to the sequential channel sounding sequence of the sounding sequence scheme 800, which may reduce the overhead of the sounding sequence.

In some examples, the first AP 102-a may transmit, to the STA 104-a, a NDPA that prepares the STA 104-a to receive both a first NDP from the first AP 102-a and a second NDP from the second AP 102-b simultaneously (such as in parallel, concurrently, in separate sets of LTFs). The STA 104-a may receive the first NDP and the second NDP (such as and a BFRP from the first AP 102-a), and may use the NDPs to collect and transmit, to the first AP 102-a, the CSI including CSI associated with a first channel between the first AP 102-a and the first STA 104-a and a second channel between the second AP 102-b and the first STA 104-a.

In a second joint channel sounding sequence (such as or a second portion of the joint channel sounding sequence) associated with the second STA 104-b, the second AP 102-b may transmit, to the STA 104-b, a NDPA that prepares the STA 104-b to receive both a third NDP from the second AP 102-b and a fourth NDP from the first AP 102-a simultaneously (such as in parallel, in separate sets of LTFs). The STA 104-b may receive the third NDP, the fourth NDP, and a BFRP from the second AP 102-b), and may use the NDPs to collect and transmit, to the second AP 102-b, the CSI including CSI associated with a third channel between the first AP 102-a and the second STA 104-b and a fourth channel between the second AP 102-b and the second STA 104-b.

Each frame in the frame transmission sequence 900 (such as and in other signaling diagrams described herein) may be separated in time from neighboring frames by a short interframe space (SIFS) (such as a delay in microseconds) such as the one or more gaps 905. However, the sounding sequence for the first BSS and the second BSS can be separated in two different TXOPs without any constraints on time separation between the CSI frame and the ICF frame. The CoBF agreement establishment phase, the sounding phase (such as the measurement phase), and the transmission phase may be performed by the APs 102 without one or more SIFSs separating the phases (such as the first AP 102-a and the second AP 102-b may refrain from including a SIFS between any two of the CoBF agreement establishment phase, the sounding phase, or the transmission phase).

As a result of the measurement phase illustrated by the frame transmission sequence 900, the first AP 102-a may have the CSI (such as including CSI associated with the first channel between the first AP 102-a and the first STA 104-a and including CSI associated with the second channel between the second AP 102-b and the first STA 104-a) as a result of the first joint channel sounding sequence (such as or the first portion of the joint channel sounding sequence) associated with the first BSS. Similarly, the second AP 102-b may have the CSI (such as including CSI associated with the third channel between the first AP 102-a and the second STA 104-b and including CSI associated with the fourth channel between the second AP 102-b and the second STA 104-b) as a result of the second joint channel sounding sequence (such as or the second portion of the joint channel sounding sequence) associated with the second BSS. Thus, the devices in the frame transmission sequence 900 may perform joint CBF channel sounding in an OBSS.

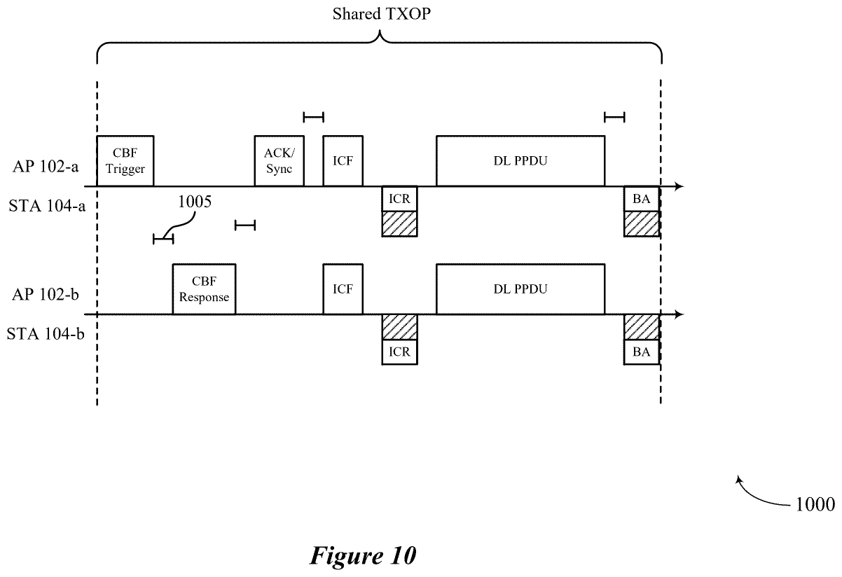

FIG. 10 shows an example of a frame transmission sequence 1000 that supports operating state transitions in overlapping basic service sets. In some examples, the frame transmission sequence 1000 may implement aspects of the wireless communications system 100 and the wireless environment 200. For example, the frame transmission sequence 1000 includes a sharing AP 102-a, a shared AP 102-b, a first STA 104-a, a second STA 104-b, which may be examples of the corresponding devices described with reference to FIG. 1. One or more frames of the frame transmission sequence may be separated by one or more gaps 1005. In some examples, steps in the frame transmission sequence 1000 may include additional features not mentioned below, or further steps may be added. Additionally, or alternatively, while two APs 102 and two STAs 104 are shown in the frame transmission sequence 1000, more devices may be possible and the examples shown should not be construed as limiting.

The sharing AP 102-a and the shared AP 102-b may be associated with a first BSS and a second BSS, respectively, where each BSS includes one or more STAs 104. For example, the first BSS may include one or more devices within a first coverage area 108 (such as the sharing AP 102-a, the STA 104-a, the STA 104-b, and one or more other STAs 104). Similarly, the second BSS may include one or more devices within a second coverage area 108 (such as the shared AP 102-b, the STA 104-a, the STA 104-b, and one or more other STAs 104). The STAs 104 may be connected to the sharing AP 102-a, the shared AP 102-b, or both via a communication link 106. In some examples, the first BSS and the second BSS may be overlapping to form an OBSS. For example, the STA 104-a and the STA 104-b may be included in both the first BSS and the second BSS, and may therefore be part of an OBSS associated with the sharing AP 102-a and the shared AP 102-b. In some examples, the sharing AP 102-a may be a sharing AP and the shared AP 102-b may be a shared AP, as discussed with reference to FIG. 2.

The frame transmission sequence 1000 may illustrate how an ICF/ICR frame exchange may occur between each AP 102 and one or more respective scheduled clients (such as between the sharing AP 102-a and the first STA 104-a, between the shared AP 102-b and the second STA 104-b) during the ICF/ICR preparation period to prepare the one or more clients for reception of one or more CBF downlink PPDUs. For example, after CBF communications initiation via a three-way handshake (such as including a CBF trigger frame, a CBF response frame, and one or more ACK/Sync frames, as described in more detail with reference to FIG. 1), the sharing AP 102-a may transmit, to the first STA 104-a, an ICF, and the first STA 104-a may transmit, to the sharing AP 102-a, an ICR. Similarly, the shared AP 102-b may transmit, to the second STA 104-b, an ICF, and the second STA 104-b may transmit, to the shared AP 102-b, an ICR.

In some examples, if the STA 104-a is an eMLSR STA 104, the ICF may instruct the STA 104-a to activate an eMLSR link between the sharing AP 102-a and the first STA 104-a (such as the first operating state includes an eMLSR link in listen mode, and the second operating state include an active eMLSR link, as described in more detail with reference to FIG. 3). If the STA 104-a is a CoEx STA 104, the ICF may instruct the STA 104-a to provide unavailability information (such as discussed with reference to FIG. 4). If the STA 104-a is a DPS STA 104, the ICF may instruct the STA 104-a to upgrade to full capability operation (such as the first operating state includes low capability, reduced capability, or low power operation, and the second operating state includes high capability, full capability, or high power operation, as described in more detail with reference to FIG. 5) before one or more active transmissions. The contents of the ICF may be different depending on whether the STA 104-a is an eMLSR STA 104, a CoEx STA 104, a DPS STA 104, or another type of STA 104. The ICR may indicate to the sharing AP 102-a that the first STA 104-a has transitioned from the first operating state to the second operating state and is prepared to receive a scheduled downlink PPDU. Similarly, the ICR may indicate to the shared AP 102-b that the second STA 104-b has transitioned from the first operating state to the second operating state and is prepared to receive a scheduled downlink PPDU. If either STA 104 is a CoEx STA 104, the associated ICR may include unavailability information that the respective AP 102 may use to schedule the downlink PPDU.

One challenge with the frame transmission sequence 1000 is to avoid interference between the first ICF and the second ICF and between the first ICR and the second ICR sent in the two BSSs (such as the OBSS) to ensure successful reception and decoding of all frames (such as at each wireless device). To ensure successful decoding, in a transmission scheme such as the frame transmission sequence 1000, wireless devices may employ parallel and identical ICF transmission, and one or more STAs 104 may respond with an OFDMA ICR. One or more parameters for identical ICF generation in both BSSs may be exchanged during the coordination agreement establishment phase. Additionally, the RU assignment for ICR separation may be agreed during the coordination agreement establishment phase.

In some examples, the ICF, the ICR, or both may be transmitted concurrently or staggered in time by the sharing AP 102-a and the shared AP 102-b, respectively. In some examples, the sharing AP 102-a may transmit a first data message (such as downlink PPDU) to the one or more STAs 104 (such as the STA 104-a) concurrently with a second data message by the shared AP 102-b (such as to the second STA 104-b).

In some examples, the first wireless STA 104-a may transmit a BA Frame according to an OFDMA transmission scheme concurrently with a second BA frame by the second wireless STA 104-b according to an OFDMA transmission scheme based on the first data message, the second data message, or both.

FIG. 11 shows an example of a frame transmission sequence 1100 that supports techniques for a unified frame transmission sequence for CoBF and CSR. In some examples, the frame transmission sequence 1100 may implement or be implemented by aspects of the wireless communication network 100, the wireless environment 200, the frame transmission sequences 300, 400, 500, 600, and 700 described with reference to FIGS. 1-7, or any combination thereof. For example, the frame transmission sequence 1100 may include an invite frame, one or more ICR frames, a response frame, a trigger/synchronization frame, one or more multi-user BA request (MU-BAR) frames (such as MU-BAR trigger frames), one or more BA frames, and one or more downlink PPDUs. The various frames and transmissions may be separated by one or more gaps 1105. The frame transmission sequence 1100 may be implemented by a sharing AP 102-a, one or more shared APs 102-b, one or more first wireless STAs 104-a, one or more second wireless STAs 104-b, or a combination thereof which may be examples of corresponding devices described herein with reference to FIGS. 1 through 6. The sharing AP 102-a may identify one or more shared transmission opportunities during which the sharing AP 102-a and the one or more shared APs 102-b may simultaneously transmit communications to the wireless STA 104-a and wireless STA 104-b, respectively.

In accordance with aspects described herein, a frame transmission sequence associated with the CoBF scheme (such as frame transmission sequence 300) and a second variant frame transmission sequence associated with the CSR scheme (such as frame transmission sequence 500) may be unified into a common frame transmission sequence, such as the frame transmission sequence 1100. In some examples, the second variant frame transmission sequence associated with the CSR scheme may be a subset of the frame transmission sequence associated with a CoBF scheme. In the frame transmission sequence 1100, the various frames may carry different information depending on which of the coordinated AP schemes the sharing AP 102-a and the sharing AP 102-a operate in accordance with.

In some examples, the sharing AP 102-a and the shared AP 102-b may exchange, as part of the CoBF agreement establishment phase, signaling indicating one or more signal padding values associated with the transmission phase. For example, the APs 102 may exchange signaling indicating padding delay values for each frame of the CoBF transmission sequence, where the respective padding delay values correspond to a duration of bits (such as dummy bits) inserted into each frame to provide time for one or more of the APs 102 to process the respective frame. The padding delay values associated with the frames of the CoBF transmission sequence may include: a padding duration in the CoBF invite frame such as a padding delay associated with the shared AP 102-b, a padding duration in the CoBF response frame such as a padding delay associated with the sharing AP 102-a, a padding duration in the CoBF trigger frame (such as the trigger/sync frame) such as a padding delay associated with the shared AP 102-b, or other padding delay values. Additionally, or alternatively, the signaling may indicate a duration of ICF padding (such as ICF padding for eMLSR/DPS operations), which may be exchanged in the Invite-Response frame exchange (such as of the transmission sequence) or earlier during the coordination agreement establishment phase. FIG. 12 shows an example of a sounding sequence scheme 1200 that supports techniques for a unified frame transmission sequence for CoBF and CSR. In some examples, the sounding sequence scheme 1200 may implement or be implemented by aspects of the wireless communication network 100, the wireless environment 200, the frame transmission sequences 300, 400, 500, 600, 700, 800, 900, 1000, and 1100 described with reference to FIGS. 1-11, or any combination thereof. The various frames and transmissions may be separated by one or more gaps 1205. The sounding sequence scheme 1200 may be implemented by a first AP 102-a, one or more shared APs 102-b, one or more first wireless STAs 104-a, one or more second wireless STAs 104-b, or a combination thereof which may be examples of corresponding devices described herein with reference to FIGS. 1 through 11.

In some examples, the first AP 102-a and the second AP 102-b may perform channel sounding (such as a collaborative process done by two (or more) APs to collect CSI info between each AP and the OBSS clients). CoBF channel sounding may include a sequence including an ICF frame, an ICR frame, a NDPA frame, a NDP frame, a BFRP frame, a sounding invite frame, a sounding response frame, and a CSI report frame. A NDPA frame may announce the NDP frame, the BFRP frame may trigger the CSI report frame based on measurements taken on the NDP frame.

In some examples, the first AP 102-a and the second AP 102-b may perform sequential sounding. In-BSS CSI collection may include sounding done for an associated AP (such as the first AP 102-a) by transmitting the NDP and receiving the CSI report in response to the BFRP frame. Cross-BSS CSI collection may include sounding done for OBSS APs (such as the shared APs 102-b). The associated AP may send a NDPA frame on behalf of the OBSS AP. The OBSS AP may send the NDP followed by the BFRP frame sent by the associated AP on behalf of the OBSS AP. Finally, the client (such as the second wireless STA 104-b) reports back its measured CSI. The whole process is then repeated for all APs participating in the channel sounding procedure.

To perform the cross-BSS CSI collection, the first AP 102-a may perform a handshake procedure with the second AP 102-b. The handshake between APs may include a sounding invite frame and a sounding response frame exchange to ensure the availability (such as and willingness) of the other AP to participate in the sounding sequence. To perform cross-BSS sounding and in-BSS sounding, an AP may perform a handshake procedure with the STA served by the AP (such as an ICF frame and ICR frame exchange) to ensure the availability of the STA to participate in the sounding sequence.

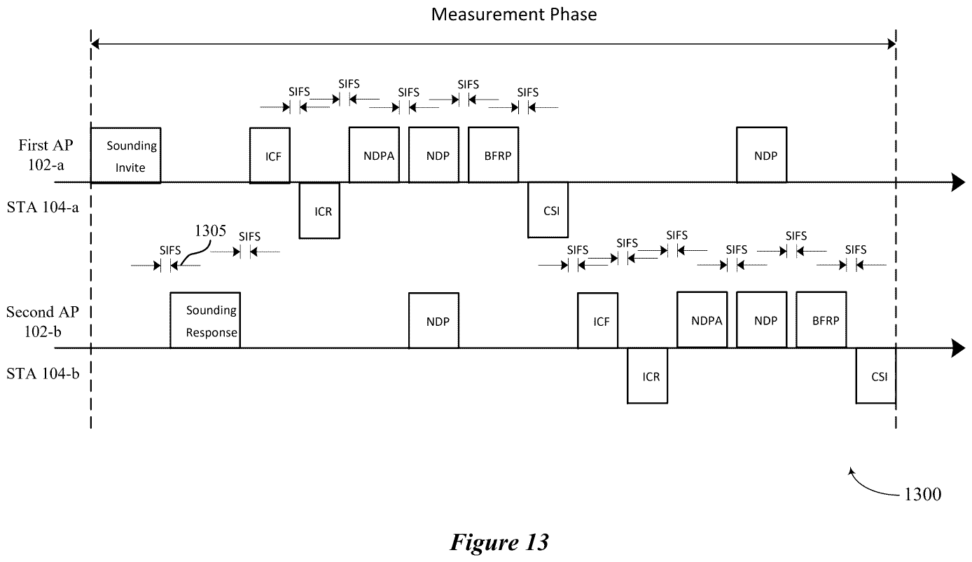

Techniques described with reference to FIGS. 14 and 15 (such as sounding sequences across multiple TXOPs) may implement sequential channel sounding as described with reference to FIG. 12, or may implement joint channel sounding as described with reference to FIG. 13.

FIG. 13 shows an example of a sounding sequence scheme 1300 that supports techniques for a unified frame transmission sequence for CoBF and CSR. In some examples, the sounding sequence scheme 1300 may implement or be implemented by aspects of the wireless communication network 100, the wireless environment 200, the frame transmission sequences 300, 400, 500, 600, 700, 800, 900, 1000, 1200, and 1300 described with reference to FIGS. 1-12, or any combination thereof. The various frames and transmissions may be separated by one or more gaps 1305. The sounding sequence scheme 1300 may be implemented by a first AP 102-a, one or more shared APs 102-b, one or more first wireless STAs 104-a, one or more second wireless STAs 104-b, or a combination thereof which may be examples of corresponding devices described herein with reference to FIGS. 1 through 12.

In some examples, the first AP 102-a and the second AP 102-b may perform channel sounding (such as a collaborative process done by two (or more) APs to collect CSI info between each AP and the OBSS clients). CoBF channel sounding may include a sequence including a NDPA frame, a NDP frame, a BFRP, and a CSI report frame. A NDPA frame may announce the NDP frame, the BFRP frame may trigger the CSI report frame based on measurements taken on the NDP frame.

In some examples, the first AP 102-a and the second AP 102-b may perform joint sounding during a channel sounding phase of a CoBF operation. Joint sounding may support the sounding process efficiently by doing CSI estimation to the associated APs (such as in-BSS CSI for the sharing APs 102-a) as well as the OBSS AP (such as Cross-BSS CSI for the shared APs 102-b) simultaneously. The sounding sequence may be similar to the sequential sounding sequence. However, the NDP frames may be sent jointly by both APs (such as the first AP 102-a and the second AP 102-b) at the same time. For instance, CSI estimation for the two APs may be done using a set of separate LTFs. Joint sounding may be shorter than sequential sounding (such as saving up to three frame exchanges per AP), which may help to reduce signaling overhead of sounding sequences.

To perform the cross-BSS CSI collection, the first AP 102-a may perform a handshake procedure with the second AP 102-b. The handshake between APs may include a sounding invite frame and a sounding response frame exchange to ensure the availability (such as and willingness) of the other AP to participate in the sounding sequence. To perform cross-BSS sounding and in-BSS sounding, an AP may perform a handshake procedure with the STA served by the AP (such as an ICF frame and ICR frame exchange) to ensure the availability of the STA to participate in the sounding sequence.

Techniques described with reference to FIGS. 14 and 15 (such as sounding sequences across multiple TXOPs) may implement sequential channel sounding as described with reference to FIG. 12, or may implement joint channel sounding as described with reference to FIG. 13.

FIG. 14 shows an example of a sounding sequence scheme 1400 that supports techniques for a unified frame transmission sequence for CoBF and CSR. In some examples, the sounding sequence scheme 1400 may implement or be implemented by aspects of the wireless communication network 100, the wireless environment 200, the frame transmission sequences 300, 400, 500, 600, 700, 800, 900, 1000, 1200, 1300, and 1400 described with reference to FIGS. 1-13, or any combination thereof. The various frames and transmissions may be separated by one or more gaps 1405. The sounding sequence scheme 1400 may be implemented by a first AP 102-a, one or more shared APs 102-b, one or more first wireless STAs 104-a, one or more second wireless STAs 104-b, or a combination thereof which may be examples of corresponding devices described herein with reference to FIGS. 1 through 13.

In some examples, the first AP 102-a and the second AP 102-b may perform channel sounding (such as a collaborative process done by two (or more) APs to collect CSI info between each AP and the OBSS clients). CoBF channel sounding may include a sequence including a NDPA frame, a NDP frame, a BFRP frame, and a CSI report frame. A NDPA frame may announce the NDP frame, the BFRP frame may trigger the CSI report frame based on measurements taken on the NDP frame.

As described herein, the length of sounding sequences in FIG. 5 and FIG. 6 (such as within a single TXOP) is relatively long which may make them more prone to error. Additionally, in some error scenarios, the sequence may be retransmitted from scratch, wasting time on recollecting some CSI that could have possibly been successfully collected in the first attempt. In addition to error scenarios, the STAs of one AP might not be available at the time the other AP starts the sounding sequence. This increases the probability of sounding failure.

The sounding sequence may be divided (such as split) into two TXOPs as shown in FIG. 14 (such as one for each BSS). In each TXOP, the in-BSS and cross-BSS CSI may be collected with respect to clients of a specific BSS. In such examples, for an AP to initiate a sounding sequence, the AP may only be concerned by the availability of its own clients (such as CSI with respect to STAs of the other AP may be collected in another TXOP owned and initiated by other APs), hence decreasing the possibility of them being unavailable. Additionally, by splitting the sequence into two TXOPs, some overhead may be saved in error cases where only the half of the sequence that failed is to be repeated.

For each BSS, the cross-BSS CSI may be collected first so that if the in-BSS CSI collection fails, only the in-BSS CSI collection is repeated using a sounding sequence that does not involve the other AP (such as without another handshake procedure with the other AP). The repeated in-BSS CSI collection sounding sequence may not rely on the sounding invite and sounding response frame exchange. Thus, according to techniques described herein, the in-BSS CSI collection and cross-BSS CSI collection for the first BSS (such as the STAs served by first AP 102-a) may be performed during a first TXOP, and the in-BSS CSI collection and the cross-BSS CSI collection for the second BSS (such as the STAs served by the second AP 102-b) may be performed during a second TXOP. Additional APs involved in the sounding sequence may occur in subsequent TXOPs. Such techniques may be performed in accordance with sequential sounding or joint sounding.

FIG. 15 shows an example of a sounding sequence scheme 1500 that supports techniques for a unified frame transmission sequence for CoBF and CSR. In some examples, the sounding sequence scheme 1300 may implement or be implemented by aspects of the wireless communication network 100, the wireless environment 200, the frame transmission sequences 300, 400, 500, 600, 700, 800, 900, 1000, 1200, 1300, and 1400 described with reference to FIGS. 1-14, or any combination thereof. The various frames and transmissions may be separated by one or more gaps 1505. The sounding sequence scheme 1500 may be implemented by a first AP 102-a, one or more shared APs 102-b, one or more first wireless STAs 104-a, one or more second wireless STAs 104-b, or a combination thereof which may be examples of corresponding devices described herein with reference to FIGS. 1 through 14.

In some examples, the first AP 102-a and the second AP 102-b may perform channel sounding (such as a collaborative process done by two (or more) APs to collect CSI info between each AP and the OBSS clients). CoBF channel sounding may include a sequence including a NDPA frame, a NDP frame, a BFRP frame, and a CSI report frame. A NDPA frame may announce the NDP frame, the BFRP frame may trigger the CSI report frame based on measurements taken on the NDP frame.

In some examples sounding sequences may be divided into multiple (such as three) TXOPs. During a first TXOP, the cross-BSS CSI may be collected by both APs from both BSSs. During a second and third TXOP, each respective AP may collect in-BSS CSI from each BSS (such as without any cross-BSS CSI collection). Such techniques may be simple and may save power or processing resources, and also may be shorter than other sequences. For example, the two APs supporting the CoBF operation may coordinate for a single TXOP (such as the first TXOP), but not other TXOPs. Such a scenario exploits other sounding sequences used to collect in-BSS CSI independently from the CoBF sounding sequence, so each AP may perform in-BSS CSI on its own, without any involvement with (such as coordination with, handshake procedures with) other APs (such as legacy or default sounding sequences).

In some examples, sounding sequences such as the sounding sequence scheme 1500 may incur an increased likelihood (such as compared to one or more different sounding sequences) of an unavailability of the second wireless STAs 104-b (such as the second AP 102-b STAs) during the first TXOP. The sounding sequence scheme 1500 may utilize elements of one or more different sounding sequences (such as the legacy sounding sequences) to collect in-BSS CSI independently from the CoBF sounding sequence such that each AP may collect in-BSS CSI without any involvement of the other AP.

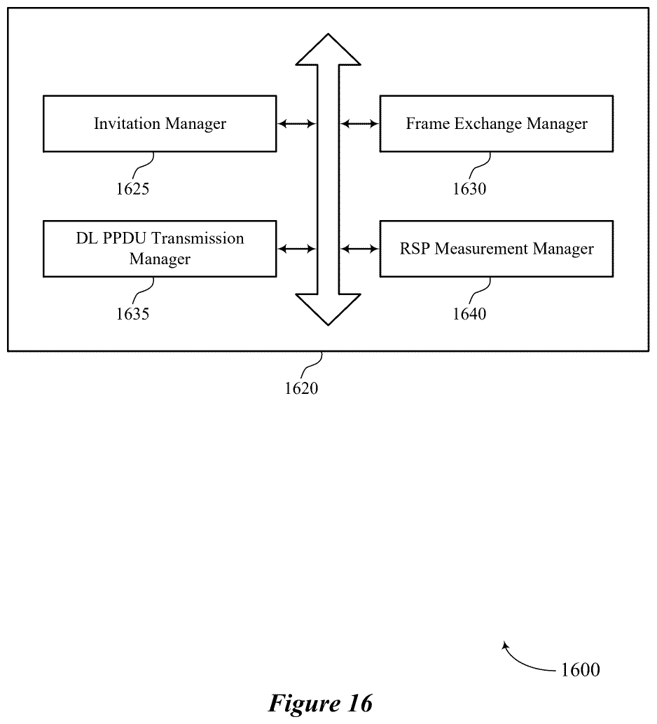

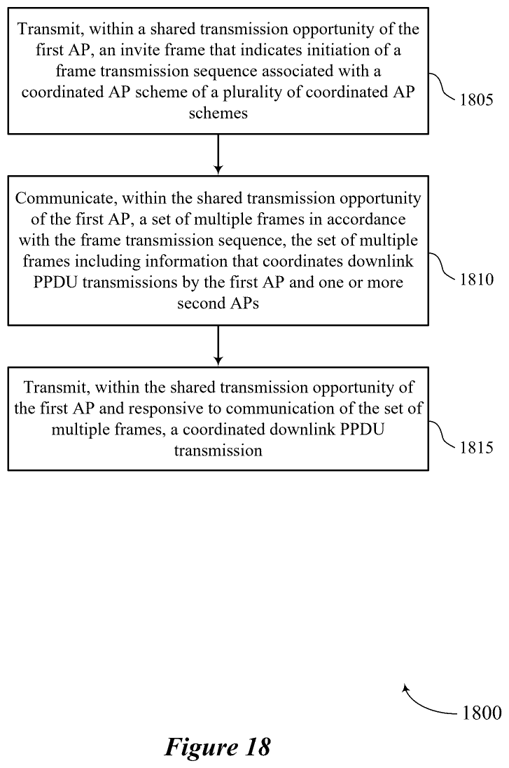

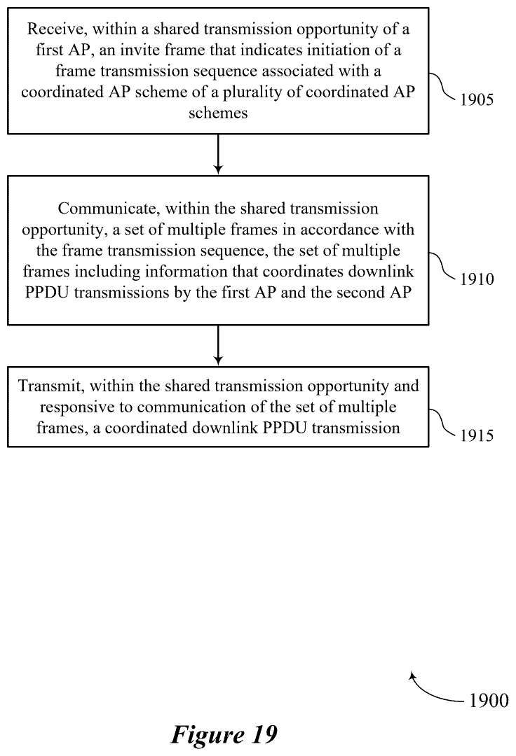

FIG. 16 shows a block diagram of an example wireless communication device 1600 that supports unified frame transmission sequence for coordinated beamforming and coordinated spatial reuse. In some examples, the wireless communication device 1600 is configured to perform the processes 1800 and 1900 described with reference to FIGS. 18 and 19, respectively. The wireless communication device 1600 may include one or more chips, SoCs, chipsets, packages, components or devices that individually or collectively constitute or include a processing system. The processing system may interface with other components of the wireless communication device 1600, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1600 may transmit the information output from the chip. In such an example, the second interface may refer to an interface between the processing system of the chip and a reception component, such that the wireless communication device 1600 may receive information that is then passed to the processing system. In some such examples, the first interface also may obtain information, such as from the transmission component, and the second interface also may output information, such as to the reception component.

The processing system of the wireless communication device 1600 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1600 can be configurable or configured for use in an AP, such as the AP 102 described with reference to FIG. 1. In some other examples, the wireless communication device 1600 can be an AP that includes such a processing system and other components including multiple antennas. The wireless communication device 1600 is capable of transmitting and receiving wireless communications in the form of, for example, wireless packets. For example, the wireless communication device 1600 can be configurable or configured to transmit and receive packets in the form of physical layer PPDUs and MPDUs conforming to one or more of the IEEE 802.11 family of wireless communication protocol standards. In some other examples, the wireless communication device 1600 can be configurable or configured to transmit and receive signals and communications conforming to one or more 3GPP specifications including those for 5G NR or 6G. In some examples, the wireless communication device 1600 also includes or can be coupled with one or more application processors which may be further coupled with one or more other memories. In some examples, the wireless communication device 1600 further includes at least one external network interface coupled with the processing system that enables communication with a core network or backhaul network that enables the wireless communication device 1600 to gain access to external networks including the Internet.

The wireless communication device 1600 includes an invitation manager 1625, a frame exchange manager 1630, a DL PPDU transmission manager 1635, and an RSP measurement manager 1640. Portions of one or more of the invitation manager 1625, the frame exchange manager 1630, the DL PPDU transmission manager 1635, and the RSP measurement manager 1640 may be implemented at least in part in hardware or firmware. For example, one or more of the invitation manager 1625, the frame exchange manager 1630, the DL PPDU transmission manager 1635, and the RSP measurement manager 1640 may be implemented at least in part by at least a processor or a modem. In some examples, portions of one or more of the invitation manager 1625, the frame exchange manager 1630, the DL PPDU transmission manager 1635, and the RSP measurement manager 1640 may be implemented at least in part by a processor and software in the form of processor-executable code stored in memory.

The wireless communication device 1600 may support wireless communication in accordance with examples as disclosed herein. The invitation manager 1625 is configurable or configured to transmit, within a shared transmission opportunity of the first AP, an invite frame that indicates initiation of a frame transmission sequence associated with a coordinated AP scheme of a plurality of coordinated AP schemes, where the plurality of coordinated AP schemes includes a first coordinated AP scheme and a second coordinated AP scheme. The frame exchange manager 1630 is configurable or configured to communicate, within the shared transmission opportunity of the first AP, a set of multiple frames in accordance with the frame transmission sequence, the set of multiple frames including information that coordinates downlink PPDU transmissions by the first AP and one or more second APs. The DL PPDU transmission manager 1635 is configurable or configured to transmit, within the shared transmission opportunity of the first AP and responsive to communication of the set of multiple frames, a coordinated downlink PPDU transmission.

In some examples, the set of multiple frames includes one or more initial control response frames, a response frame, a trigger frame, or any combination thereof.

In some examples, the invite frame includes an invitation to perform a CoBF operation between the first AP and a second AP of the one or more second APs.

In some examples, the first coordinated AP scheme includes a CoBF scheme.

In some examples, the invite frame includes a poll message of the CoBF scheme and requests a wireless station to perform frame exchange associated with the CoBF scheme.

In some examples, to support communicating the set of multiple frames in accordance with the frame transmission sequence, the frame exchange manager 1630 is configurable or configured to receive, from the wireless station and based on the poll message, a first initial control response frame that indicates availability of the wireless station to participate in frame exchange associated with the CoBF scheme.

In some examples, the frame exchange manager 1630 is configurable or configured to prepare, based on the first initial control response frame, to participate in the frame exchange with the wireless station.

In some examples, to support communicating the set of multiple frames in accordance with the frame transmission sequence, the frame exchange manager 1630 is configurable or configured to receive, from the second AP and based on the invitation, a second initial control response frame, a response frame, or both, where the second initial control response frame and the response frame indicate availability of the second AP to participate in frame exchange associated with the CoBF scheme.

In some examples, the frame exchange manager 1630 is configurable or configured to prepare, based on the second initial control response frame, to participate in the frame exchange with the second AP.

In some examples, to support communicating the set of multiple frames in accordance with the frame transmission sequence, the frame exchange manager 1630 is configurable or configured to transmit, to the second AP, a trigger frame, where the trigger frame is a frequency and time synchronization reference frame, and where the coordinated downlink PPDU transmission is communicated in accordance with the frequency and time synchronization reference frame.

In some examples, the invite frame includes an invitation to perform a CSR operation between the first AP and a second AP of the one or more second APs.

In some examples, the second coordinated AP scheme includes a CSR scheme.

In some examples, the invite frame includes a poll message of the CSR scheme and requests a wireless station to perform frame exchange associated with the CSR scheme and to transmit an initial coordinated response frame.

In some examples, to support communicating the set of multiple frames in accordance with the frame transmission sequence, the frame exchange manager 1630 is configurable or configured to receive, from the wireless station and based on the poll message, a first initial control response frame that indicates availability of the wireless station to participate in frame exchange associated with the CSR scheme.

In some examples, the RSP measurement manager 1640 is configurable or configured to measure, based on the first initial control response frame, a received signal power associated with the wireless station.

In some examples, to support communicating the set of multiple frames in accordance with the frame transmission sequence, the frame exchange manager 1630 is configurable or configured to transmit, to the second AP, a trigger frame that includes an indication of one or more of: a received signal power associated with a wireless station, a transmit power associated with transmission of the coordinated downlink PPDU transmission, a signal to interference ratio (SIR) threshold, a start time associated with transmission of the coordinated downlink PPDU transmission, an end time associated with transmission of the coordinated downlink PPDU transmission, or any combination thereof.

In some examples, to support communicating the set of multiple frames in accordance with the frame transmission sequence, the frame exchange manager 1630 is configurable or configured to receive, from the second AP and based on the invitation, a response frame that indicates availability of the second AP to participate in frame exchange associated with the CSR scheme.

Additionally, or alternatively, the wireless communication device 1600 may support wireless communication in accordance with examples as disclosed herein. In some examples, the invitation manager 1625 is configurable or configured to receive, within a shared transmission opportunity of a first AP, an invite frame that indicates initiation of a frame transmission sequence associated with a coordinated AP scheme of a plurality of coordinated AP schemes, wherein the plurality of coordinated AP schemes includes a first coordinated AP scheme and a second coordinated AP scheme. In some examples, the frame exchange manager 1630 is configurable or configured to communicate, within the shared transmission opportunity, a set of multiple frames in accordance with the frame transmission sequence, the set of multiple frames including information that coordinates downlink PPDU transmissions by the first AP and the second AP. In some examples, the DL PPDU transmission manager 1635 is configurable or configured to transmit, within the shared transmission opportunity and responsive to communication of the set of multiple frames, a coordinated downlink PPDU transmission.

In some examples, the set of multiple frames includes an initial control response frame, a response frame, a trigger frame, or any combination thereof.

In some examples, the invite frame includes an invitation to perform a CoBF operation between the first AP and the second AP.

In some examples, the first coordinated AP scheme includes a CoBF scheme.

In some examples, to support communicating the set of multiple frames in accordance with the frame transmission sequence, the frame exchange manager 1630 is configurable or configured to transmit, to the first AP and based on the invitation, a first initial control response frame, a response frame, or both, where the first initial control response frame and the response frame indicate availability of the second AP to participate in frame exchange associated with the CoBF scheme.

In some examples, to support communicating the set of multiple frames in accordance with the frame transmission sequence, the frame exchange manager 1630 is configurable or configured to receive, from a wireless station and based on the invitation, a second initial control response frame that indicates availability of the wireless station to participate in frame exchange associated with the CoBF scheme.

In some examples, the frame exchange manager 1630 is configurable or configured to prepare, based on the second initial control response frame, to participate in the frame exchange with the wireless station.

In some examples, to support communicating the set of multiple frames in accordance with the frame transmission sequence, the frame exchange manager 1630 is configurable or configured to receive, from the first AP, a trigger frame, where the trigger frame is a frequency and time synchronization reference frame, and where the coordinated downlink PPDU transmission is communicated in accordance with the frequency and time synchronization reference frame.

In some examples, the invite frame includes an invitation to perform a CSR operation between the first AP and the second AP.

In some examples, the second coordinated AP scheme includes a CSR scheme.

In some examples, to support communicating the set of multiple frames in accordance with the frame transmission sequence, the frame exchange manager 1630 is configurable or configured to transmit, to the first AP and based on the invitation, a response frame that indicates availability of the second AP to participate in frame exchange associated with the CSR scheme.

In some examples, the RSP measurement manager 1640 is configurable or configured to monitor for an initial control response frame transmitted by a wireless station associated with the first AP. In some examples, the RSP measurement manager 1640 is configurable or configured to measure, based on the initial control response frame, a received signal power associated with the wireless station.

In some examples, to support communicating the set of multiple frames in accordance with the frame transmission sequence, the frame exchange manager 1630 is configurable or configured to receive, from the first AP, a trigger frame that includes an indication of one or more of: a received signal power associated with a wireless station, a transmit power associated with transmission of the coordinated downlink PPDU transmission, a signal to interference ratio (SIR) threshold, a start time associated with transmission of the coordinated downlink PPDU transmission, an end time associated with transmission of the coordinated downlink PPDU transmission, or any combination thereof.

In some examples, the DL PPDU transmission manager 1635 is configurable or configured to adjusting, base at least in part on the trigger frame, a transmit power, where the coordinated downlink PPDU transmission is transmitted based on the adjusted transmit power.

Additionally, or alternatively, the wireless communication device 1600 may support wireless communication in accordance with examples as disclosed herein. In some examples, the invitation manager 1625 is configurable or configured to communicate, with a second AP during a CoBF agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with coordinated beamformed transmission by the first AP and the second AP to the first set of stations of the first AP and the second set of stations of the second AP. In some examples, the frame exchange manager 1630 is configurable or configured to communicate, during the channel sounding phase, one or more sounding messages in accordance with the one or more first parameters for the channel sounding phase, the one or more first parameters indicating a sounding sequence variant from a plurality of different sounding sequence variants to apply for communication of the one or more sounding messages during the channel sounding phase. In some examples, the DL PPDU transmission manager 1635 is configurable or configured to transmit, during the transmission phase, a coordinated beamformed transmission in accordance with the one or more second parameters for the transmission phase and based at least in part on the one or more sounding messages.

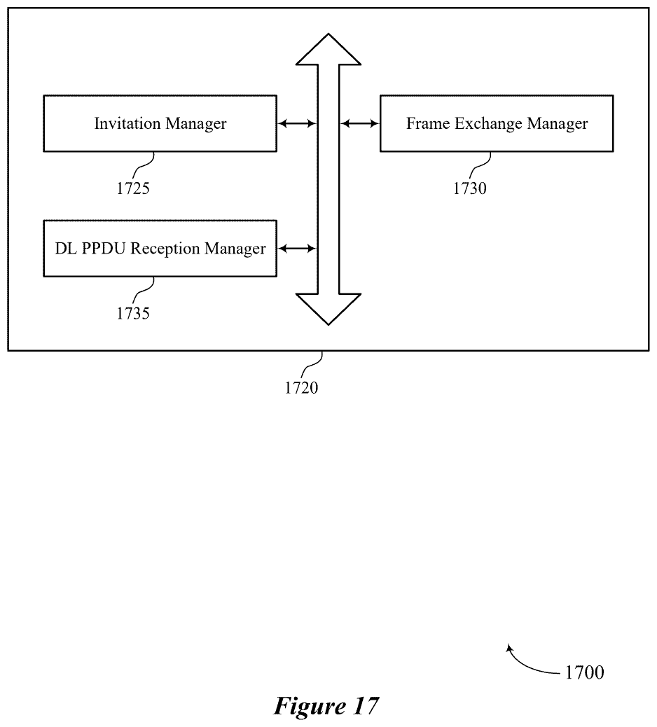

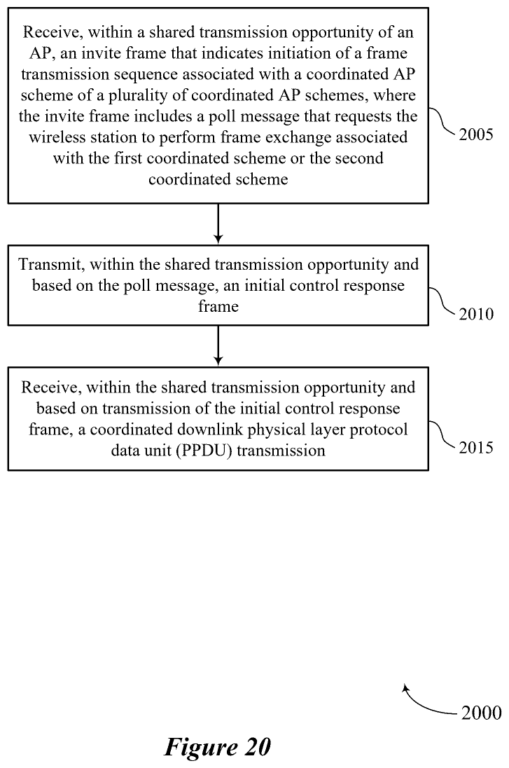

FIG. 17 shows a block diagram of an example wireless communication device 1700 that supports unified frame transmission sequence for coordinated beamforming and coordinated spatial reuse. In some examples, the wireless communication device 1700 is configured to perform the process 2000 described with reference to FIG. 20. The wireless communication device 1700 may include one or more chips, SoCs, chipsets, packages, components or devices that individually or collectively constitute or include a processing system. The processing system may interface with other components of the wireless communication device 1700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1700 may transmit the information output from the chip. In such an example, the second interface may refer to an interface between the processing system of the chip and a reception component, such that the wireless communication device 1700 may receive information that is then passed to the processing system. In some such examples, the first interface also may obtain information, such as from the transmission component, and the second interface also may output information, such as to the reception component.

The processing system of the wireless communication device 1700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1700 can be configurable or configured for use in a STA, such as the STA 104 described with reference to FIG. 1. In some other examples, the wireless communication device 1700 can be a STA that includes such a processing system and other components including multiple antennas. The wireless communication device 1700 is capable of transmitting and receiving wireless communications in the form of, for example, wireless packets. For example, the wireless communication device 1700 can be configurable or configured to transmit and receive packets in the form of physical layer PPDUs and MPDUs conforming to one or more of the IEEE 802.11 family of wireless communication protocol standards. In some other examples, the wireless communication device 1700 can be configurable or configured to transmit and receive signals and communications conforming to one or more 3GPP specifications including those for 5G NR or 6G. In some examples, the wireless communication device 1700 also includes or can be coupled with one or more application processors which may be further coupled with one or more other memories. In some examples, the wireless communication device 1700 further includes a user interface (UI) (such as a touchscreen or keypad) and a display, which may be integrated with the UI to form a touchscreen display that is coupled with the processing system. In some examples, the wireless communication device 1700 may further include one or more sensors such as, for example, one or more inertial sensors, accelerometers, temperature sensors, pressure sensors, or altitude sensors, that are coupled with the processing system.

The wireless communication device 1700 includes an invitation manager 1725, a frame exchange manager 1730, and a DL PPDU reception manager 1735. Portions of one or more of the invitation manager 1725, the frame exchange manager 1730, and the DL PPDU reception manager 1735 may be implemented at least in part in hardware or firmware. For example, one or more of the invitation manager 1725, the frame exchange manager 1730, and the DL PPDU reception manager 1735 may be implemented at least in part by at least a processor or a modem. In some examples, portions of one or more of the invitation manager 1725, the frame exchange manager 1730, and the DL PPDU reception manager 1735 may be implemented at least in part by a processor and software in the form of processor-executable code stored in memory.

The wireless communication device 1700 may support wireless communications in accordance with examples as disclosed herein. The invitation manager 1725 is configurable or configured to receive, within a shared transmission opportunity of an access point (AP), an invite frame that indicates initiation of a frame transmission sequence associated with a coordinated transmission scheme of a plurality of coordinated AP schemes, where the plurality of coordinated AP schemes includes a first coordinated AP scheme and a second coordinated AP scheme, where the invite frame includes a poll message that requests the wireless station to perform frame exchange associated with the first coordinated AP scheme or the second coordinated AP scheme. The frame exchange manager 1730 is configurable or configured to transmit, within the shared transmission opportunity and based on the poll message, an initial control response frame. The DL PPDU reception manager 1735 is configurable or configured to receive, within the shared transmission opportunity and based on transmission of the initial control response frame, a coordinated downlink PPDU transmission.

Additionally, or alternatively, the wireless communication device 1700 may support wireless communication in accordance with examples as disclosed herein. In some examples, the invitation manager 1725 is configurable or configured to communicate, with a second AP during a CoBF agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with coordinated beamformed transmission by the first AP and the second AP to the first set of stations of the first AP and the second set of stations of the second AP. In some examples, the frame exchange manager 1730 is configurable or configured to communicate, during the channel sounding phase, one or more sounding messages in accordance with the one or more first parameters for the channel sounding phase, the one or more first parameters indicating a sounding sequence variant from a plurality of different sounding sequence variants to apply for communication of the one or more sounding messages during the channel sounding phase. In some examples, the DL PPDU transmission manager 1735 is configurable or configured to transmit, during the transmission phase, a coordinated beamformed transmission in accordance with the one or more second parameters for the transmission phase and based at least in part on the one or more sounding messages.

In some examples, the frame exchange manager 1730 is configurable or configured to communicate, during the coordinated beamforming agreement establishment phase, the one or more messages indicating one or more capabilities associated with the first AP, the second AP, or both, where transmission of the coordinated beamformed transmission is in accordance with the one or more capabilities, where the one or more capabilities include a quantity of transmission antennas, a quantity of supported spatial dimensions, or both.

In some examples, the frame exchange manager 1730 is configurable or configured to communicate, during the coordinated beamforming agreement establishment phase, the one or more messages indicating a preferred sounding interval or a supported sounding interval for execution of a sounding sequence associated with the channel sounding phase, where communication of the one or more sounding messages during the channel sounding phase is in accordance with the preferred sounding interval or the supported sounding interval, and where the preferred sounding interval or the supported sounding interval is a minimum sounding interval or a maximum sounding interval.

In some examples, the frame exchange manager 1730 is configurable or configured to communicate, during the coordinated beamforming agreement establishment phase, the one or more messages indicating a first quantity of stations requested by the first AP to include for the channel sounding phase and a second quantity of stations the second AP is permitted to include for the channel sounding phase, where communication of the one or more sounding messages during the channel sounding phase is based at least in part on the first quantity of stations, the second quantity of stations, or both.

In some examples, the frame exchange manager 1730 is configurable or configured to communicate, during the coordinated beamforming agreement establishment phase, the one or more messages negotiating the quantity of the first set of stations served by the first AP and the second set of stations served by the second AP that are candidates for coordinated beamformed transmission by the first AP and the second AP, where communication of the one or more sounding messages during the channel sounding phase is based at least in part on the first set of stations, the second set of stations, or both, where a duration associated with the channel sounding phase is based at least in part on a quantity of stations included in the first set of stations, a quantity of stations included in the second set of stations, or both.

In some examples, the frame exchange manager 1730 is configurable or configured to communicate, during the coordinated beamforming agreement establishment phase, the one or more messages indicating which one of the first AP or the second AP is a frequency synchronization reference AP and a different one of the first AP or the second AP is a frequency synchronization follower AP, where communication of the one or more sounding messages during the channel sounding phase, communication of the coordinated beamformed transmission of the transmission phase, or both are based at least in part on a frequency synchronization reference signal output by the frequency synchronization reference AP.

In some examples, the frame exchange manager 1730 is configurable or configured to communicate, during the coordinated beamforming agreement establishment phase, the one or more messages indicating one or more wireless communication schemes, operation modes, or both of a plurality of different wireless communication schemes, operation modes, or both, the one or more messages indicating whether the one or more wireless communication schemes, operation modes, or both are allowed or disallowed for communications between the second AP and the second set of stations during the transmission phase.

In some examples, the frame exchange manager 1730 is configurable or configured to communicate, during the coordinated beamforming agreement establishment phase, the one or more messages indicating a supported sounding sequence variant or a preferred sounding sequence variant of the plurality of different sounding sequence variants, where communication of the one or more sounding messages is in accordance with the supported sounding sequence variant or the preferred sounding sequence variant.

In some examples, the frame exchange manager 1730 is configurable or configured to communicate, during the coordinated beamforming agreement establishment phase, the one or more messages indicating a supported acknowledgement information polling scheme or a preferred acknowledgement information polling scheme, and transmit an acknowledgement information polling message in accordance with the supported acknowledgement information polling scheme or the preferred acknowledgement information polling scheme.

In some examples, the frame exchange manager 1730 is configurable or configured to communicate, during the coordinated beamforming agreement establishment phase, the one or more messages indicating a padding duration, and communicate one or more frames associated with the coordinated beamformed transmission in accordance with the padding duration, the padding duration being included for each of the one or more frames.

In some examples, the frame exchange manager 1730 is configurable or configured to communicate, during the coordinated beamforming agreement establishment phase, the one or more messages including an indication of whether to perform In-BSS sounding during the channel sounding phase, where communication of the one or more sounding messages is in accordance with the indication.

In some examples, the frame exchange manager 1730 is configurable or configured to communicate, during the CoBF agreement establishment phase, the one or more messages including an indication of one or more timeout durations, the one or more timeout durations corresponding to a silent period between frames of the sounding phase, the transmission phase, or both, where the one or more timeout durations are in accordance with an initial control frame duration, a block acknowledgement request rate, a block acknowledgement polling scheme, or any combination thereof.

FIG. 18 shows a flowchart illustrating an example process 1800 performable by or at a first AP that supports unified frame transmission sequence for coordinated beamforming and coordinated spatial reuse. The operations of the process 1800 may be implemented by a first AP or its components as described herein. For example, the process 1800 may be performed by a wireless communication device, such as the wireless communication device 1600 described with reference to FIG. 16, operating as or within a wireless AP. In some examples, the process 1800 may be performed by a wireless AP, such as one of the APs 102 described with reference to FIG. 1.

In some examples, in 1805, the first AP may transmit, within a shared transmission opportunity of the first AP, an invite frame that indicates a frame transmission sequence, where the frame transmission sequence is associated with a first coordinated AP scheme and a second coordinated AP scheme. The operations of 1805 may be performed in accordance with examples as disclosed herein. In some implementations, aspects of the operations of 1805 may be performed by an invitation manager 1625 as described with reference to FIG. 16.

In some examples, in 1810, the first AP may communicate, within the shared transmission opportunity of the first AP, a set of multiple frames in accordance with the frame transmission sequence, the set of multiple frames including information that coordinates downlink PPDU transmissions by the first AP and one or more second APs. The operations of 1810 may be performed in accordance with examples as disclosed herein. In some implementations, aspects of the operations of 1810 may be performed by a frame exchange manager 1630 as described with reference to FIG. 16.

In some examples, in 1815, the first AP may transmit, within the shared transmission opportunity of the first AP and responsive to communication of the set of multiple frames, a coordinated downlink PPDU transmission. The operations of 1815 may be performed in accordance with examples as disclosed herein. In some implementations, aspects of the operations of 1815 may be performed by a DL PPDU transmission manager 1635 as described with reference to FIG. 16.

FIG. 19 shows a flowchart illustrating an example process 1900 performable by or at a second AP that supports unified frame transmission sequence for coordinated beamforming and coordinated spatial reuse. The operations of the process 1900 may be implemented by a second AP or its components as described herein. For example, the process 1900 may be performed by a wireless communication device, such as the wireless communication device 1600 described with reference to FIG. 16, operating as or within a wireless AP. In some examples, the process 1900 may be performed by a wireless AP, such as one of the APs 102 described with reference to FIG. 1.

In some examples, in 1905, the second AP may receive, within a shared transmission opportunity of a first AP, an invite frame that indicates initiation of a frame transmission sequence associated with a coordinated AP scheme of a plurality of coordinated AP schemes, where the plurality of coordinated AP schemes includes a first coordinated AP scheme and a second coordinated AP scheme. The operations of 1905 may be performed in accordance with examples as disclosed herein. In some implementations, aspects of the operations of 1905 may be performed by an invitation manager 1625 as described with reference to FIG. 16.

In some examples, in 1910, the second AP may communicate, within the shared transmission opportunity, a set of multiple frames in accordance with the frame transmission sequence, the set of multiple frames including information that coordinates downlink PPDU transmissions by the first AP and the second AP. The operations of 1910 may be performed in accordance with examples as disclosed herein. In some implementations, aspects of the operations of 1910 may be performed by a frame exchange manager 1630 as described with reference to FIG. 16.

In some examples, in 1915, the second AP may transmit, within the shared transmission opportunity and responsive to communication of the set of multiple frames, a coordinated downlink PPDU transmission. The operations of 1915 may be performed in accordance with examples as disclosed herein. In some implementations, aspects of the operations of 1915 may be performed by a DL PPDU transmission manager 1635 as described with reference to FIG. 16.

FIG. 20 shows a flowchart illustrating an example process 2000 performable by or at a wireless station that supports unified frame transmission sequence for coordinated beamforming and coordinated spatial reuse. The operations of the process 2000 may be implemented by a wireless station or its components as described herein. For example, the process 2000 may be performed by a wireless communication device, such as the wireless communication device 1700 described with reference to FIG. 17, operating as or within a wireless STA. In some examples, the process 2000 may be performed by a wireless STA, such as one of the STAs 104 described with reference to FIG. 1.

In some examples, in 2005, the wireless station may receive, within a shared transmission opportunity of an AP, an invite frame that indicates initiation of a frame transmission sequence associated with a coordinated AP scheme associated with a plurality of coordinated AP schemes, where the plurality of coordinated AP schemes includes a first coordinated AP scheme and a second coordinated AP scheme, where the invite frame includes a poll message that requests the wireless station to perform frame exchange associated with the first coordinated AP scheme or the second coordinated AP scheme. The operations of 2005 may be performed in accordance with examples as disclosed herein. In some implementations, aspects of the operations of 2005 may be performed by an invitation manager 1725 as described with reference to FIG. 17.

In some examples, in 2010, the wireless station may transmit, within the shared transmission opportunity and based on the poll message, an initial control response frame. The operations of 2010 may be performed in accordance with examples as disclosed herein. In some implementations, aspects of the operations of 2010 may be performed by a frame exchange manager 1730 as described with reference to FIG. 17.

In some examples, in 2015, the wireless station may receive, within the shared transmission opportunity and based on transmission of the initial control response frame, a coordinated downlink PPDU transmission. The operations of 2015 may be performed in accordance with examples as disclosed herein. In some implementations, aspects of the operations of 2015 may be performed by a DL PPDU reception manager 1735 as described with reference to FIG. 17.

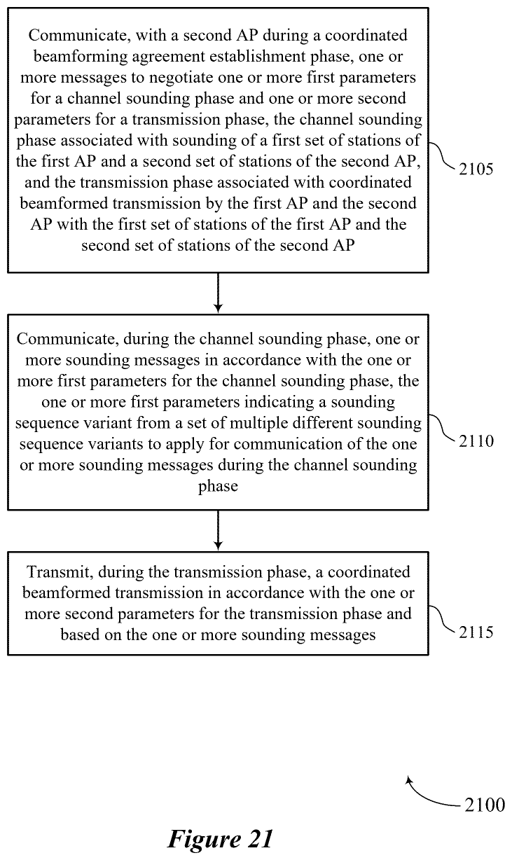

FIG. 21 shows a flowchart illustrating an example process 2100 performable by or at a wireless station that supports unified frame transmission sequence for coordinated beamforming and coordinated spatial reuse. The operations of the process 2100 may be implemented by a wireless station or its components as described herein. For example, the process 2100 may be performed by a wireless communication device, such as the wireless communication device 1700 described with reference to FIG. 17, operating as or within a wireless STA. In some examples, the process 2100 may be performed by a wireless STA, such as one of the STAs 104 described with reference to FIG. 1.

In some examples, in 2105, the wireless station may communicate, with a second AP during a coordinated beamforming agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with coordinated beamformed transmission by the first AP and the second AP to the first set of stations of the first AP and the second set of stations of the second AP. The operations of 2105 may be performed in accordance with examples as disclosed herein. In some implementations, aspects of the operations of 2105 may be performed by an invitation manager 1725 as described with reference to FIG. 17.

In some examples, in 2110, the wireless station may communicate, during the channel sounding phase, one or more sounding messages in accordance with the one or more first parameters for the channel sounding phase, the one or more first parameters indicating a sounding sequence variant from a set of multiple different sounding sequence variants to apply for communication of the one or more sounding messages during the channel sounding phase. The operations of 2110 may be performed in accordance with examples as disclosed herein. In some implementations, aspects of the operations of 2110 may be performed by a frame exchange manager 1730 as described with reference to FIG. 17.

In some examples, in 2115, the wireless station may transmit, during the transmission phase, a coordinated beamformed transmission in accordance with the one or more second parameters for the transmission phase and based on the one or more sounding messages. In some implementations, aspects of the operations of 2115 may be performed by a DL PPDU reception manager 1735 as described with reference to FIG. 17.

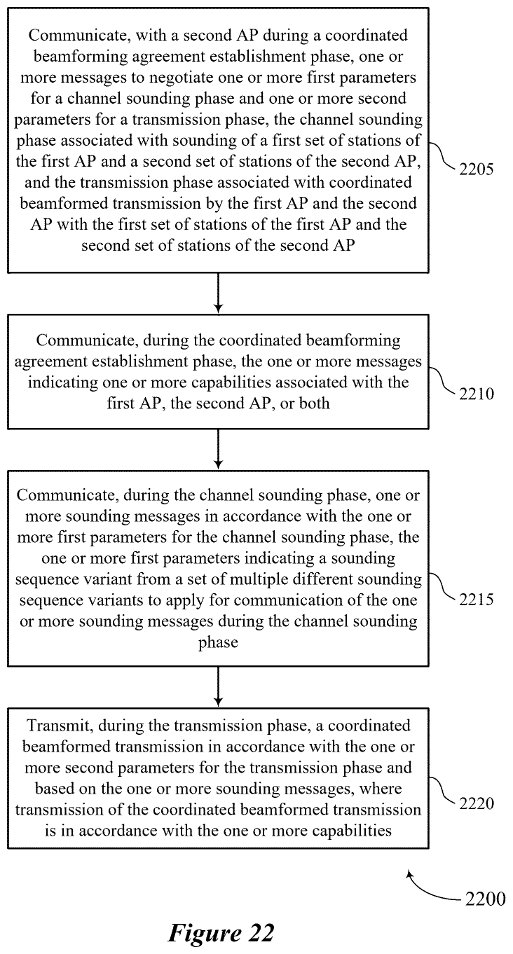

FIG. 22 shows a flowchart illustrating an example process 2200 performable by or at a wireless station that supports unified frame transmission sequence for coordinated beamforming and coordinated spatial reuse. The operations of the process 2200 may be implemented by a wireless station or its components as described herein. For example, the process 2200 may be performed by a wireless communication device, such as the wireless communication device 1700 described with reference to FIG. 17, operating as or within a wireless STA. In some examples, the process 2200 may be performed by a wireless STA, such as one of the STAs 104 described with reference to FIG. 1.

In some examples, in 2205, the wireless station may communicate, with a second AP during a coordinated beamforming agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with coordinated beamformed transmission by the first AP and the second AP to the first set of stations of the first AP and the second set of stations of the second AP. The operations of 2205 may be performed in accordance with examples as disclosed herein. In some implementations, aspects of the operations of 2105 may be performed by an invitation manager 1725 as described with reference to FIG. 17.

In some examples, in 2210, the wireless station may communicate, during the coordinated beamforming agreement establishment phase, the one or more messages indicating one or more capabilities associated with the first AP, the second AP, or both. The operations of 2210 may be performed in accordance with examples as disclosed herein. In some implementations, aspects of the operations of 2210 may be performed by an invitation manager 1725 as described with reference to FIG. 17.

In some examples, in 2215, the wireless station may communicate, during the channel sounding phase, one or more sounding messages in accordance with the one or more first parameters for the channel sounding phase, the one or more first parameters indicating a sounding sequence variant from a set of multiple different sounding sequence variants to apply for communication of the one or more sounding messages during the channel sounding phase, where transmission of the coordinated beamformed transmission is in accordance with the one or more capabilities. The operations of 2115 may be performed in accordance with examples as disclosed herein. In some implementations, aspects of the operations of 2110 may be performed by a frame exchange manager 1730 as described with reference to FIG. 17.

In some examples, in 2220, the wireless station may transmit, during the transmission phase, a coordinated beamformed transmission in accordance with the one or more second parameters for the transmission phase and based on the one or more sounding messages. In some implementations, aspects of the operations of 2220 may be performed by a DL PPDU reception manager 1735 as described with reference to FIG. 17.

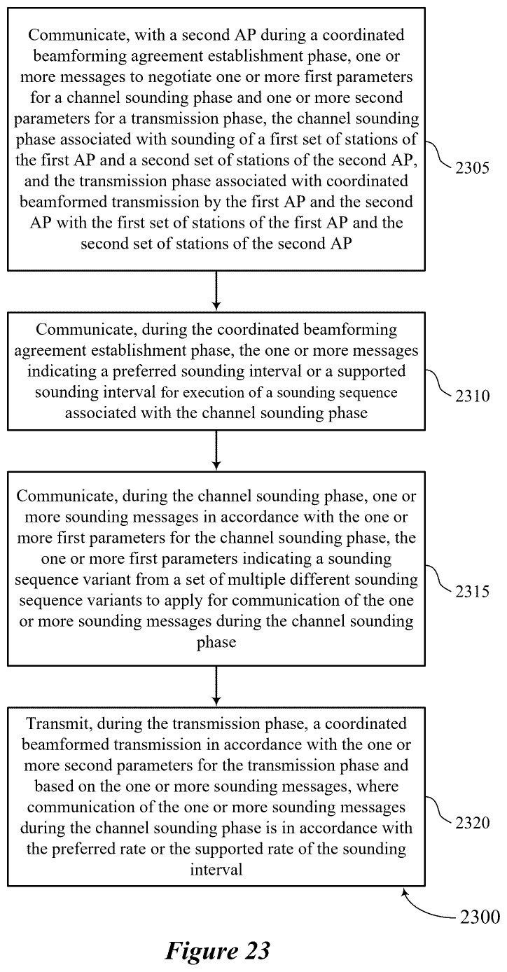

FIG. 23 shows a flowchart illustrating an example process 2300 performable by or at a wireless station that supports unified frame transmission sequence for coordinated beamforming and coordinated spatial reuse. The operations of the process 2300 may be implemented by a wireless station or its components as described herein. For example, the process 2300 may be performed by a wireless communication device, such as the wireless communication device 1700 described with reference to FIG. 17, operating as or within a wireless STA. In some examples, the process 2300 may be performed by a wireless STA, such as one of the STAs 104 described with reference to FIG. 1.

In some examples, in 2305, the wireless station may communicate, with a second AP during a coordinated beamforming agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with coordinated beamformed transmission by the first AP and the second AP to the first set of stations of the first AP and the second set of stations of the second AP. The operations of 2305 may be performed in accordance with examples as disclosed herein. In some implementations, aspects of the operations of 2305 may be performed by an invitation manager 1725 as described with reference to FIG. 17.

In some examples, in 2310, the wireless station may communicate, during the coordinated beamforming agreement establishment phase, the one or more messages indicating a preferred sounding interval or a supported sounding interval for execution of a sounding sequence associated with the channel sounding phase. The operations of 2310 may be performed in accordance with examples as disclosed herein. In some implementations, aspects of the operations of 2310 may be performed by an invitation manager 1725 as described with reference to FIG. 17.

In some examples, in 2315, the wireless station may communicate, during the channel sounding phase, one or more sounding messages in accordance with the one or more first parameters for the channel sounding phase, the one or more first parameters indicating a sounding sequence variant from a set of multiple different sounding sequence variants to apply for communication of the one or more sounding messages during the channel sounding phase. The operations of 2315 may be performed in accordance with examples as disclosed herein. In some implementations, aspects of the operations of 2315 may be performed by a frame exchange manager 1730 as described with reference to FIG. 17.

In some examples, in 2320, the wireless station may transmit, during the transmission phase, a coordinated beamformed transmission in accordance with the one or more second parameters for the transmission phase and based on the one or more sounding messages, where communication of the one or more sounding messages during the channel sounding phase is in accordance with the preferred sounding interval or the supported sounding interval. In some implementations, aspects of the operations of 2320 may be performed by a DL PPDU reception manager 1735 as described with reference to FIG. 17.

The following provides an overview of aspects of the present disclosure:

### Aspect 1

A method for wireless communication by a first AP, comprising: transmitting, within a shared transmission opportunity of the first AP, an invite frame that indicates initiation of a joint frame transmission sequence associated with a coordinated AP scheme of a plurality of coordinated AP schemes; communicating, within the shared transmission opportunity of the first AP, a plurality of frames in accordance with the frame transmission sequence, the plurality of frames including information that coordinates downlink physical layer protocol data unit (PPDU) transmissions by the first AP and one or more second APs; and transmitting, within the shared transmission opportunity of the first AP and responsive to communication of the plurality of frames, a coordinated downlink PPDU transmission.

### Aspect 2

The method of aspect 1, wherein the plurality of frames comprises one or more initial control response frames, a response frame, a trigger frame, or any combination thereof.

### Aspect 3

The method of any of aspects 1 through 2, wherein the invite frame includes an invitation to perform a CoBF operation between the first AP and a second AP of the one or more second APs.

### Aspect 4

The method of aspect 3, wherein a first coordinated AP scheme of the plurality of coordinated AP schemes comprises a CoBF scheme, and the invite frame includes an invitation to perform a CoBF operation between the first AP and a second AP of the one or more second APs, an indication of one or more wireless STAs associated with the first AP, or both.

### Aspect 5

The method of aspect 4, wherein communicating the plurality of frames in accordance with the joint frame transmission sequence comprises: receiving, from the second AP and based at least in part on the invitation, a response frame, wherein the response frame indicates availability of the second AP to participate in a frame exchange associated with the CoBF scheme, indicates one or more wireless STAs associated with the second AP, or both.

### Aspect 6

The method of aspect 4, wherein the invite frame comprises a poll message of the CoBF scheme and requests a wireless station to perform frame exchange associated with the CoBF scheme.

### Aspect 7

The method of any of aspects 4 through 6, wherein communicating the plurality of frames in accordance with the joint frame transmission sequence comprises: transmitting an initial control frame comprising a poll message and a request to perform a frame exchange associated with the CoBF scheme.

### Aspect 8

The method of aspect 6, wherein communicating the plurality of frames in accordance with the joint frame transmission sequence comprises: receiving, from a wireless STA and based at least in part on the initial control frame, an initial control response frame that indicates an availability of the wireless STA to participate in the frame exchange associated with the CoBF scheme.

### Aspect 9

The method of aspect 6, wherein communicating the plurality of frames in accordance with the frame transmission sequence comprises: receiving, from the wireless station and based at least in part on the poll message, a first initial control response frame that indicates availability of the wireless station to participate in frame exchange associated with the CoBF scheme.

### Aspect 10

The method of any of aspects 4 through 9, wherein communicating the plurality of frames in accordance with the joint frame transmission sequence comprises: receiving, from the second AP and based at least in part on the invitation, a second initial control response frame, a response frame, or both, wherein the second initial control response frame or the response frame indicate availability of the second AP to participate in frame exchange associated with the CoBF scheme.

### Aspect 11

The method of aspect 9, further comprising: preparing, based at least in part on the first initial control response frame, to participate in the frame exchange with the wireless station.

### Aspect 12

The method of any of aspects 4 through 11, wherein communicating the plurality of frames in accordance with the frame transmission sequence comprises: receiving, from the second AP and based at least in part on the invitation, a second initial control response frame, a response frame, or both, wherein the second initial control response frame and the response frame indicate availability of the second AP to participate in frame exchange associated with the CoBF scheme.

### Aspect 13

The method of aspect 12, further comprising: preparing, based at least in part on the second initial control response frame, to participate in the frame exchange with the second AP.

### Aspect 14

The method of any of aspects 3 through 13, wherein communicating the plurality of frames in accordance with the frame transmission sequence comprises: transmitting, to the second AP, a trigger frame, wherein the trigger frame is a frequency and time synchronization reference frame, and wherein the coordinated downlink PPDU transmission is communicated in accordance with the frequency and time synchronization reference frame.

### Aspect 15

The method of any of aspects 1 through 14, wherein the invite frame includes an invitation to perform a CSR operation between the first AP and a second AP of the one or more second APs.

### Aspect 16

The method of aspect 15, wherein a second coordinated AP scheme of the plurality of coordinated AP schemes comprises a CSR scheme, and the invite frame includes an invitation to perform a CSR operation between the first AP and a second AP of the one or more second APs.

### Aspect 17

The method of aspect 16, wherein the invite frame comprises a poll message of the CSR scheme and requests a wireless station to perform frame exchange associated with the CSR scheme and to transmit an initial coordinated response frame.

### Aspect 18

The method of aspect 16, wherein communicating the plurality of frames in accordance with the joint frame transmission sequence comprises: receiving, from the second AP and based at least in part on the invitation, a response frame that indicates availability of the second AP to participate in a frame exchange associated with the CSR scheme.

### Aspect 19

The method of any of aspects 16-18, wherein communicating the plurality of frames in accordance with the joint frame transmission sequence comprises: transmitting an initial control frame comprising a poll message of the CSR scheme, and a request for a wireless STA to perform a frame exchange associated with the CSR scheme and to transmit an initial coordinated response frame.

### Aspect 20

The method of aspect 17, wherein communicating the plurality of frames in accordance with the frame transmission sequence comprises: receiving, from the wireless station and based at least in part on the poll message, a first initial control response frame that indicates availability of the wireless station to participate in frame exchange associated with the CSR scheme.

### Aspect 21

The method of any of aspects 19 and 20, further comprising: measuring, based at least in part on the first initial control response frame, a received signal power associated with the wireless station.

### Aspect 22

The method of any of aspects 16 through 21, wherein communicating the plurality of frames in accordance with the frame transmission sequence comprises: transmitting, to the second AP, a trigger frame that includes an indication of one or more of: a received signal power associated with a wireless station, a transmit power associated with transmission of the coordinated downlink PPDU transmission, a SIR threshold, a start time associated with transmission of the coordinated downlink PPDU transmission, an end time associated with transmission of the coordinated downlink PPDU transmission, or any combination thereof.

### Aspect 23

The method of any of aspects 16 through 22, wherein communicating the plurality of frames in accordance with the frame transmission sequence comprises: receiving, from the second AP and based at least in part on the invitation, a second initial control response frame, a response frame, or both, wherein the second initial control response frame or the response frame indicate availability of the second AP to participate in frame exchange associated with the CSR scheme.

### Aspect 24

A method for wireless communication by a second AP, comprising: receiving, within a shared transmission opportunity of a first AP, an invite frame that indicates initiation of a joint frame transmission sequence associated with a coordinated AP scheme of a plurality of coordinated AP schemes; communicating, within the shared transmission opportunity, a plurality of frames in accordance with the frame transmission sequence, the plurality of frames including information that coordinates downlink physical layer protocol data unit (PPDU) transmissions by the first AP and the second AP; and transmitting, within the shared transmission opportunity and responsive to communication of the plurality of frames, a coordinated downlink PPDU transmission.

### Aspect 25

The method of aspect 24, wherein the plurality of frames comprises an initial control response frame, a response frame, a trigger frame, or any combination thereof.

### Aspect 26

The method of any of aspects 24 through 25, wherein the invite frame includes an invitation to perform a CoBF operation between the first AP and the second AP.

### Aspect 27

The method of aspect 26, wherein a first coordinated AP scheme of the plurality of coordinated AP schemes comprises a CoBF scheme, and the invite frame includes an invitation to perform a CoBF operation between the first AP and the second AP.

### Aspect 28

The method of aspect 27, wherein communicating the plurality of frames in accordance with the frame transmission sequence comprises: transmitting, to the first AP and based at least in part on the invitation, a first initial control response frame, a response frame, or both, wherein the first initial control response frame and the response frame indicate availability of the second AP to participate in frame exchange associated with the CoBF scheme.

### Aspect 29

The method of any of aspects 27 through 25, wherein communicating the plurality of frames in accordance with the joint frame transmission sequence comprises: transmitting an initial control frame comprising a poll message and requesting a wireless STA to perform a frame exchange associated with the CoBF scheme.

### Aspect 30

The method of aspect 26, wherein communicating the plurality of frames in accordance with the joint frame transmission sequence comprises: receiving, from a wireless STA and based at least in part on the initial control frame, an initial control response frame that indicates availability of the wireless STA to participate in the frame exchange associated with the CoBF scheme.

### Aspect 31

The method of any of aspects 27 through 28, wherein communicating the plurality of frames in accordance with the frame transmission sequence comprises: receiving, from a wireless station and based at least in part on the invitation, a second initial control response frame that indicates availability of the wireless station to participate in frame exchange associated with the CoBF scheme.

### Aspect 32

The method of aspect 31, further comprising: preparing, based at least in part on the second initial control response frame, to participate in the frame exchange with the wireless station.

### Aspect 33

The method of any of aspects 27 through 32, wherein communicating the plurality of frames in accordance with the frame transmission sequence comprises: receiving, from the first AP, a trigger frame, wherein the trigger frame is a frequency and time synchronization reference frame, and wherein the coordinated downlink PPDU transmission is communicated in accordance with the frequency and time synchronization reference frame.

### Aspect 34

The method of any of aspects 24 through 33, wherein the invite frame includes an invitation to perform a CSR operation between the first AP and the second AP.

### Aspect 35

The method of aspect 34, wherein a second coordinated AP scheme of the plurality of coordinated AP schemes comprises a CSR scheme, and the invite frame includes an invitation to perform a CSR operation between the first AP and the second AP.

### Aspect 36

The method of aspect 35, wherein communicating the plurality of frames in accordance with the frame transmission sequence comprises: transmitting, to the first AP and based at least in part on the invitation, a response frame that indicates availability of the second AP to participate in frame exchange associated with the CSR scheme.

### Aspect 37

The method of any of aspects 35-36, wherein communicating the plurality of frames in accordance with the joint frame transmission sequence comprises: transmitting an initial control frame comprising a poll message and requesting first a wireless STA associated with the second AP to perform a frame exchange associated with the CSR scheme.

### Aspect 38

The method of aspect 37, further comprising: monitoring for an initial control response frame transmitted by a second wireless STA associated with the first AP; receiving, from the second wireless STA and based at least in part on the poll message, the initial control response frame that indicates availability of the wireless STA to participate in a frame exchange associated with the CSR scheme; and measuring, based at least in part on the initial control response frame, a received signal power associated with the second wireless STA.

### Aspect 39

The method of any of aspects 34 through 36, further comprising: monitoring for an initial control response frame transmitted by a wireless station associated with the first AP; and measuring, based at least in part on the initial control response frame, a received signal power associated with the wireless station.

### Aspect 40

The method of any of aspects 34 through 39, wherein communicating the plurality of frames in accordance with the frame transmission sequence comprises: receiving, from the first AP, a trigger frame that includes an indication of one or more of: a received signal power associated with a wireless station, a transmit power associated with transmission of the coordinated downlink PPDU transmission, a SIR threshold, a start time associated with transmission of the coordinated downlink PPDU transmission, an end time associated with transmission of the coordinated downlink PPDU transmission, or any combination thereof.

### Aspect 41

The method of aspect 40, further comprising: adjusting, based at least in part on the trigger frame, a transmit power, wherein the coordinated downlink PPDU transmission is transmitted based at least in part on the adjusted transmit power.

### Aspect 42

A method for wireless communications by a wireless station, comprising: receiving, within a shared transmission opportunity of an AP, an invite frame that indicates initiation of a joint frame transmission sequence associated with a coordinated AP scheme of a plurality of coordinated AP schemes, wherein the invite frame comprises a poll message that requests the wireless station to perform frame exchange associated with the coordinated AP scheme; transmitting, within the shared transmission opportunity and based at least in part on the poll message, an initial control response frame; and receiving, within the shared transmission opportunity and based at least in part on transmission of the initial control response frame, a coordinated downlink physical layer protocol data unit (PPDU) transmission.

### Aspect 43

A first AP for wireless communication, comprising one or more memories storing processor-executable code, and one or more processors coupled with the one or more memories and individually or collectively operable to execute the code to cause the first AP to perform a method of any of aspects 1 through 23.

### Aspect 44

A first AP for wireless communication, comprising at least one means for performing a method of any of aspects 1 through 23.

### Aspect 45

A non-transitory computer-readable medium storing code for wireless communication, the code comprising instructions executable by one or more processors to perform a method of any of aspects 1 through 23.

### Aspect 46

A second AP for wireless communication, comprising one or more memories storing processor-executable code, and one or more processors coupled with the one or more memories and individually or collectively operable to execute the code to cause the second AP to perform a method of any of aspects 24 through 41.

### Aspect 47

A second AP for wireless communication, comprising at least one means for performing a method of any of aspects 24 through 41.

### Aspect 48

A non-transitory computer-readable medium storing code for wireless communication, the code comprising instructions executable by one or more processors to perform a method of any of aspects 24 through 41.

### Aspect 49

A wireless station for wireless communications, comprising one or more memories storing processor-executable code, and one or more processors coupled with the one or more memories and individually or collectively operable to execute the code to cause the wireless station to perform a method of any of aspects 42through 42.

### Aspect 50

A wireless station for wireless communications, comprising at least one means for performing a method of any of aspects 42 through 42.

### Aspect 51

A non-transitory computer-readable medium storing code for wireless communications, the code comprising instructions executable by one or more processors to perform a method of any of aspects 42 through 42.

### Aspect 52

A method for wireless communications at a first AP, comprising: communicating, with a second AP during a CoBF agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with coordinated beamformed transmission by the first AP and the second AP to the first set of stations of the first AP and the second set of stations of the second AP; communicating, during the channel sounding phase, one or more sounding messages in accordance with the one or more first parameters for the channel sounding phase, the one or more first parameters indicating a sounding sequence variant from a plurality of different sounding sequence variants to apply for communication of the one or more sounding messages during the channel sounding phase; and transmitting, during the transmission phase, a coordinated beamformed transmission in accordance with the one or more second parameters for the transmission phase and based at least in part on the one or more sounding messages.

### Aspect 53

The method of aspect 52, wherein communicating the one or more messages further comprises: communicating, during the CoBF agreement establishment phase, the one or more messages indicating one or more capabilities associated with the first AP, the second AP, or both, wherein transmission of the coordinated beamformed transmission is in accordance with the one or more capabilities.

### Aspect 54

The method of aspect 53, wherein the one or more capabilities include a quantity of transmission antennas, a quantity of supported spatial dimensions, or both.

### Aspect 55

The method of any of aspects 52-54, wherein communicating the one or more messages further comprises: communicating, during the CoBF agreement establishment phase, the one or more messages indicating a preferred sounding interval or a supported sounding interval for execution of a sounding sequence associated with the channel sounding phase, wherein communication of the one or more sounding messages during the channel sounding phase is in accordance with the preferred sounding interval or the supported sounding interval.

### Aspect 56

The method of aspect 55, wherein the preferred sounding interval or the supported sounding interval is a minimum sounding interval or a maximum sounding interval.

### Aspect 57

The method of any of aspects 52-56, wherein communicating the one or more messages further comprises: communicating, during the CoBF agreement establishment phase, the one or more messages indicating a first quantity of stations requested by the first AP to include for the channel sounding phase and a second quantity of stations the second AP is permitted to include for the channel sounding phase, wherein communication of the one or more sounding messages during the channel sounding phase is based at least in part on the first quantity of stations, the second quantity of stations, or both.

### Aspect 58

The method of any of aspects 52-57, wherein communicating the one or more messages further comprises: communicating, during the CoBF agreement establishment phase, the one or more messages negotiating the quantity of the first set of stations served by the first AP and the second set of stations served by the second AP that are candidates for coordinated beamformed transmission by the first AP and the second AP, wherein communication of the one or more sounding messages during the channel sounding phase is based at least in part on the first set of stations, the second set of stations, or both.

### Aspect 59

The method of aspect 58, wherein a duration associated with the channel sounding phase is based at least in part on a quantity of stations included in the first set of stations, a quantity of stations included in the second set of stations, or both.

### Aspect 60

The method of any of aspects 52-59, wherein communicating the one or more messages further comprises: communicating, during the CoBF agreement establishment phase, the one or more messages indicating which one of the first AP or the second AP is a frequency synchronization reference AP and a different one of the first AP or the second AP is a frequency synchronization follower AP, wherein communication of the one or more sounding messages during the channel sounding phase, communication of the coordinated beamformed transmission of the transmission phase, or both are based at least in part on a frequency synchronization reference signal output by the frequency synchronization reference AP.

### Aspect 61

The method of any of aspects 52-60, wherein communicating the one or more messages further comprises: communicating, during the CoBF agreement establishment phase, the one or more messages indicating one or more wireless communication schemes, operation modes, or both of a plurality of different wireless communication schemes, operation modes, or both, the one or more messages indicating whether the one or more wireless communication schemes, operation modes, or both are allowed or disallowed for communications between the second AP and the second set of stations during the transmission phase.

### Aspect 62

The method of any of aspects 52-61, wherein communicating the one or more messages further comprises: communicating, during the CoBF agreement establishment phase, the one or more messages indicating a supported sounding sequence variant or a preferred sounding sequence variant of the plurality of different sounding sequence variants, wherein communication of the one or more sounding messages is in accordance with the supported sounding sequence variant or the preferred sounding sequence variant.

### Aspect 63

The method of any of aspects 52-62, wherein communicating the one or more messages further comprises: communicating, during the CoBF agreement establishment phase, the one or more messages indicating a supported acknowledgement information polling scheme or a preferred acknowledgement information polling scheme, the method further comprising: transmitting an acknowledgement information polling message in accordance with the supported acknowledgement information polling scheme or the preferred acknowledgement information polling scheme.

### Aspect 64

The method of any of aspects 52-63, wherein communicating the one or more messages further comprises: communicating, during the CoBF agreement establishment phase, the one or more messages indicating a padding duration, the method further comprising: communicating one or more frames associated with the coordinated beamformed transmission in accordance with the padding duration, the padding duration being included for each of the one or more frames.

### Aspect 65

The method of any of aspects 52-64, wherein communicating the one or more messages further comprises: communicating, during the CoBF agreement establishment phase, the one or more messages comprising an indication of whether to perform In-BSS sounding during the channel sounding phase, wherein communication of the one or more sounding messages is in accordance with the indication.

### Aspect 66

The method of any of aspects 52-65, wherein communicating the one or more messages further comprises: communicating, during the coordinated beamforming agreement establishment phase, the one or more messages including an indication of one or more timeout durations, the one or more timeout durations corresponding to a silent period between frames of the sounding phase, the transmission phase, or both, wherein the one or more timeout durations are in accordance with an initial control frame duration, a block acknowledgement request rate, a block acknowledgement polling scheme, or any combination thereof.

### Aspect 67

A first AP for wireless communications, comprising a processing system that includes processor circuitry and memory circuitry that stores code, the processing system configured to cause the first AP to perform a method of any of aspects 52 through 66.

### Aspect 68

A first AP for wireless communications, comprising at least one means for performing a method of any of aspects 52-66.

### Aspect 69

A non-transitory computer-readable medium storing code for wireless communications, the code comprising instructions executable by one or more processors to perform a method of any of aspects 52-66.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first access point (AP), comprising:
a processing system that includes processor circuitry and memory circuitry that stores code, the processing system configured to cause the first AP to:
communicate, with a second AP during a coordinated beamforming agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with coordinated beamformed transmission by the first AP and the second AP to the first set of stations of the first AP and the second set of stations of the second AP;
communicate, during the channel sounding phase, one or more sounding messages in accordance with the one or more first parameters for the channel sounding phase, the one or more first parameters indicating a sounding sequence variant from a plurality of different sounding sequence variants to apply for communication of the one or more sounding messages during the channel sounding phase; and
transmit, during the transmission phase, a coordinated beamformed transmission in accordance with the one or more second parameters for the transmission phase and based at least in part on the one or more sounding messages.

2. The first AP of claim 1, wherein, to communicate the one or more messages, the processing system is further configured to cause the first AP to:
communicate, during the coordinated beamforming agreement establishment phase, the one or more messages indicating one or more capabilities associated with the first AP, the second AP, or both, wherein transmission of the coordinated beamformed transmission is in accordance with the one or more capabilities.

3. The first AP of claim 2, wherein the one or more capabilities include a quantity of transmission antennas, a quantity of supported spatial dimensions, or both.

4. The first AP of claim 1, wherein, to communicate the one or more messages, the processing system is further configured to cause the first AP to:
communicate, during the coordinated beamforming agreement establishment phase, the one or more messages indicating a preferred sounding interval or a supported sounding interval for execution of a sounding sequence associated with the channel sounding phase, wherein communication of the one or more sounding messages during the channel sounding phase is in accordance with the preferred sounding interval or the supported sounding interval.

5. The first AP of claim 4, wherein the preferred sounding interval or the supported sounding interval is a minimum sounding interval or a maximum sounding interval.

6. The first AP of claim 1, wherein, to communicate the one or more messages, the processing system is further configured to cause the first AP to:
communicate, during the coordinated beamforming agreement establishment phase, the one or more messages indicating a first quantity of stations requested by the first AP to include for the channel sounding phase and a second quantity of stations the second AP is permitted to include for the channel sounding phase, wherein communication of the one or more sounding messages during the channel sounding phase is based at least in part on the first quantity of stations, the second quantity of stations, or both.

7. The first AP of claim 1, wherein, to communicate the one or more messages, the processing system is further configured to cause the first AP to:
communicate, during the coordinated beamforming agreement establishment phase, the one or more messages negotiating a quantity of the first set of stations served by the first AP and the second set of stations served by the second AP that are candidates for coordinated beamformed transmission by the first AP and the second AP, wherein communication of the one or more sounding messages during the channel sounding phase is based at least in part on the first set of stations, the second set of stations, or both.

8. The first AP of claim 7, wherein a duration associated with the channel sounding phase is based at least in part on a quantity of stations included in the first set of stations, a quantity of stations included in the second set of stations, or both.

9. The first AP of claim 1, wherein, to communicate the one or more messages, the processing system is further configured to cause the first AP to:
communicate, during the coordinated beamforming agreement establishment phase, the one or more messages indicating which one of the first AP or the second AP is a frequency synchronization reference AP and a different one of the first AP or the second AP is a frequency synchronization follower AP, wherein communication of the one or more sounding messages during the channel sounding phase, communication of the coordinated beamformed transmission of the transmission phase, or both are based at least in part on a frequency synchronization reference signal output by the frequency synchronization reference AP.

10. The first AP of claim 1, wherein, to communicate the one or more messages, the processing system is further configured to cause the first AP to:
communicate, during the coordinated beamforming agreement establishment phase, the one or more messages indicating one or more wireless communication schemes, operation modes, or both of a plurality of different wireless communication schemes, operation modes, or both, the one or more messages indicating whether the one or more wireless communication schemes, operation modes, or both are allowed or disallowed for communications between the second AP and the second set of stations during the transmission phase.

11. The first AP of claim 1, wherein, to communicate the one or more messages, the processing system is further configured to cause the first AP to:
communicate, during the coordinated beamforming agreement establishment phase, the one or more messages indicating a supported sounding sequence variant or a preferred sounding sequence variant of the plurality of different sounding sequence variants, wherein communication of the one or more sounding messages is in accordance with the supported sounding sequence variant or the preferred sounding sequence variant.

12. The first AP of claim 1, wherein, to communicate the one or more messages, the processing system is further configured to cause the first AP to:
communicate, during the coordinated beamforming agreement establishment phase, the one or more messages indicating a supported acknowledgement information polling scheme or a preferred acknowledgement information polling scheme, wherein the processing system is further configured to cause the first AP to:
transmit an acknowledgement information polling message in accordance with the supported acknowledgement information polling scheme or the preferred acknowledgement information polling scheme.

13. The first AP of claim 1, wherein, to communicate the one or more messages, the processing system is further configured to cause the first AP to:
communicate, during the coordinated beamforming agreement establishment phase, the one or more messages indicating a padding duration, wherein the processing system is further configured to cause the first AP to:
communicate one or more frames associated with the coordinated beamformed transmission in accordance with the padding duration, the padding duration being included for each of the one or more frames.

14. The first AP of claim 1, wherein, to communicate the one or more messages, the processing system is further configured to cause the first AP to:
communicate, during the coordinated beamforming agreement establishment phase, the one or more messages comprising an indication of whether to perform in basic service set (In-BSS) sounding during the channel sounding phase, wherein communication of the one or more sounding messages is in accordance with the indication.

15. The first AP of claim 1, wherein communicating the one or more messages further comprises:
communicating, during the coordinated beamforming agreement establishment phase, the one or more messages comprising an indication of one or more timeout durations, the one or more timeout durations corresponding to a silent period between frames of the channel sounding phase, the transmission phase, or both, wherein the one or more timeout durations are in accordance with an initial control frame duration, a block acknowledgement request rate, a block acknowledgement polling scheme, or any combination thereof.

16. A method for wireless communications at a first access point (AP), comprising:
communicating, with a second AP during a coordinated beamforming agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with coordinated beamformed transmission by the first AP and the second AP to the first set of stations of the first AP and the second set of stations of the second AP;
communicating, during the channel sounding phase, one or more sounding messages in accordance with the one or more first parameters for the channel sounding phase, the one or more first parameters indicating a sounding sequence variant from a plurality of different sounding sequence variants to apply for communication of the one or more sounding messages during the channel sounding phase; and
transmitting, during the transmission phase, a coordinated beamformed transmission in accordance with the one or more second parameters for the transmission phase and based at least in part on the one or more sounding messages.

17. The method of claim 16, wherein communicating the one or more messages further comprises:
communicating, during the coordinated beamforming agreement establishment phase, the one or more messages indicating one or more capabilities associated with the first AP, the second AP, or both, wherein transmission of the coordinated beamformed transmission is in accordance with the one or more capabilities.

18. The method of claim 17, wherein the one or more capabilities include a quantity of transmission antennas, a quantity of supported spatial dimensions, or both.

19. The method of claim 16, wherein communicating the one or more messages further comprises:
communicating, during the coordinated beamforming agreement establishment phase, the one or more messages indicating a preferred sounding interval or a supported sounding interval for execution of a sounding sequence associated with the channel sounding phase, wherein communication of the one or more sounding messages during the channel sounding phase is in accordance with the preferred sounding interval or the supported sounding interval.

20. A non-transitory computer-readable medium storing code for wireless communications, the code comprising instructions executable by one or more processors to:
communicate, with a second AP during a coordinated beamforming agreement establishment phase, one or more messages to negotiate one or more first parameters for a channel sounding phase and one or more second parameters for a transmission phase, the channel sounding phase associated with sounding of a first set of stations of the first AP and a second set of stations of the second AP, and the transmission phase associated with coordinated beamformed transmission by the first AP and the second AP to the first set of stations of the first AP and the second set of stations of the second AP;
communicate, during the channel sounding phase, one or more sounding messages in accordance with the one or more first parameters for the channel sounding phase, the one or more first parameters indicating a sounding sequence variant from a plurality of different sounding sequence variants to apply for communication of the one or more sounding messages during the channel sounding phase; and
transmit, during the transmission phase, a coordinated beamformed transmission in accordance with the one or more second parameters for the transmission phase and based at least in part on the one or more sounding messages.
